(19) United States
(12) Patent Application Publication
(10) Pub. No.: US 2018/0135285 A1
(43) Pub. Date: May 17, 2018

(54) TOILET MONITORING AND INTELLIGENT CONTROL

(71) Applicant: nth Solutions, LLC, Exton, PA (US)

(72) Inventors: Eric L. CANFIELD, Exton, PA (US); Scott J. SOMA, Exton, PA (US)

(21) Appl. No.: 15/814,097

(22) Filed: Nov. 15, 2017

Related U.S. Application Data
(60) Provisional application No. 62/423,502, filed on Nov. 17, 2016.

(51) Int. Cl. E03D 5/10; E03D 11/18; G01F 23/00

(52) U.S. Cl. CPC E03D 5/10; G01F 23/0069; G01F 23/0023; E03D 11/18

(57) ABSTRACT

A toilet monitor uses a toilet tank water level sensor producing a toilet tank water level measurement signal. A processor detects rate of change of the measurement signal and conditionally produce a responsive actuation signal in response to the detected rate of change. A transducer connected to receive the actuation signal and transmit information, provide a humanly-perceptible indication, generate a data log and/or control an electronic water supply valve.

### CROSS-REFERENCE TO RELATED APPLICATIONS

This application claims benefit of U.S. Provisional Patent Application No. 62/423,502 filed Nov. 17, 2016, incorporated herein by reference.

### FIELD

The technology herein relates to automatically monitoring the operation of a flush toilet, and in some embodiments, to automatic control of water supplied to a flush toilet.

### BACKGROUND AND SUMMARY

Substantial work has been done in the past concerning automatic monitoring and control of conventional flush toilets. See for example commonly-assigned U.S. Pat. No. 8,704,671 (“Self-stick resonant enclosure that responds to flush toilet fill valve water inflow vibration”); U.S. Pat. No. 8,362,907 (“Self-stick resonant enclosure that responds to flush toilet fill valve water inflow vibration”); U.S. Pat. No. 8,310,369 (“Detecting unintended flush toilet water flow”); U.S. Pat. No. 8,166,996 (“Toilet bowl overflow prevention and water conservation system and method”); U.S. Pat. No. 7,757,708 (“Toilet bowl overflow prevention and water conservation system and method”), all incorporated herein by reference.

Further improvements are possible.

In one example non-limiting embodiment herein, a toilet monitor comprises a toilet tank water level sensor producing a toilet tank water level measurement signal. A processor is connected to receive the measurement signal. The processor detects the rate of change of the measurement signal and conditionally produces a responsive actuation signal in response to the detected rate of change. A transducer is connected to receive the actuation signal.

Further example non-limiting features include:
The processor may evaluate a sequence of rates of change to detect toilet operation abnormalities.
The processor detects predetermined sequences of rates of change. The processor detects rate of change using a rolling block interval analysis.
The processor uses a linear equation to analyze the rate of change measurement signal.
The processor determines an anomaly in water flow within the toilet bowl based on the rate of change of the toilet tank water level measurement signal.
The processor determines the toilet is leaking in response to the rate of change.
The processor determines the toilet is leaking by tracking the direction and/or the cycles of the rate of change.
The processor determines the toilet fill valve is defective in response to the rate of change.
The processor determines the toilet fill valve is defective by tracking the direction of the rate of change followed by the absence of rate change.
The processor determines the toilet flush valve is open in response to the rate of change.
The processor determines the toilet flush valve is open by tracking the absence of the rate of change.
The processor determines current and/or imminent toilet overflow in response to the rate of change.
The processor determines toilet overflow based on magnitude of rate of change.
The processor detects fluid volume usage based on rate of change.
The processor detects the prolonged absence of double flushes.
The sensor is configured for placement within a toilet tank, the water level sensor producing a measurement signal indicating the level of fluid within the toilet tank.
The transducer comprises at least one of (a) a valve, (b) an optical indicator, (c) an audible sound generator, and (d) a transmitter.
The water level sensor comprises a capacitive sensor but could be any type of water level sensor. The disclosed processes thus could work with a different type of sensor.
The capacitive sensor comprises first and second conductors, the first conductor being covered by an insulator.
The processor logs the rate of change for later retrieval and water usage tracking.
The sensor is configured to be disposed inside the tank and has a length that is less than the extent of the water level change within the tank, and the processor uses the measurement signal to extrapolate the measurements based on the extent of the water level change within the tank.
The processor is configured to sleep and to wake up at time intervals to sample the rate of change.
The toilet tank monitor is battery powered and has no on/off switch.

In another non-limiting embodiment, a toilet monitor comprises a toilet tank water level sensor producing a toilet tank water level measurement signal. A processor is connected to receive the measurement signal. The processor detecting the presence or absence of plural successive flushes within a predetermined time period based on the measurement signal and generating an actuation signal to affect toilet tank flush volume. A valve is connected to receive the actuation signal. The valve increasing or decreasing toilet tank flush volume.

In another non-limiting embodiment, a toilet monitor comprises a toilet tank water level sensor producing a toilet tank water level measurement signal. An electronic circuit is connected to receive the measurement signal. The electronic circuit determines an anomaly in water flow within the toilet bowl based on the toilet tank water level measurement signal.

### BRIEF DESCRIPTION OF THE DRAWINGS

Prior Art Diagrams:

FIG. 1 is a cutaway view of an example non-limiting exemplary conventional prior art toilet tank;

FIG. 2 shows the FIG. 1 conventional prior art toilet tank and conventional toilet bowl prior to being flushed;

FIG. 2A shows conventional prior art toilet bowl internal plumbing details;

FIG. 3 shows the FIG. 2 toilet after the flapper has been opened and water is flowing from the tank into the bowl to evacuate the bowl;

FIG. 3A shows the conventional prior art FIG. 1 tank during a flushing operation into a clogged bowl;

FIG. 4 shows overflow of a conventional toilet;

FIG. 5 is an elevated perspective view of an exemplary illustrative non-limiting conventional prior art water fill valve;

FIG. 5A shows an elevated perspective detail of the FIG. 5 conventional prior art water fill valve with protective cap removed;

FIG. 5B shows an elevated perspective detail of the inside of the FIG. 5 prior art fill valve protective cap;

FIG. 5C shows a more detailed partially disassembled view of the FIG. 5 prior art conventional fill valve;

FIG. 6 shows an example of a mechanized water termination or interruption assembly that snaps onto the cap of conventional fill valve;

FIG. 6A shows a mechanized water termination or interruption assembly in view of a conventional fill valve to which it is to be attached;

Example Non-Limiting Embodiment Diagrams:

Figure YA and YB show example non-limiting block diagrams of toilet monitoring systems;

Figure Z shows an example non-limiting state diagram;

Figure Z1 shows an example non-limiting functional analysis diagram;

Example Non-Limiting Diagrams Showing Sensor Configurations

FIG. 7 shows an in-tank toilet monitoring and control system including a monitoring device, a solenoid valve, and various water heights representing several different possible tank refill termination levels which correlate directly to flush volumes.

FIG. 8 illustrates a conventional toilet tank in cutaway side-view showing water levels which correspond to different normal modes of operation and failure modes of operation;

Example Non-Limiting Toilet Operation Abnormalities that can be Detected

FIG. 9 illustrates a conventional toilet tank in cutaway side-view showing water levels which correspond to different normal modes and failure modes of operation, with the in-tank version of the toilet monitoring and control system mounted to, and extending into, the toilet tank;

FIG. 10 shows the conventional toilet as the bowl is being evacuated by water flowing from the tank into the bowl;

FIG. 11 is a cutaway front-facing view of an example toilet after an intentional flush operation, with the tank refilling through the fill valve after the flapper has returned to its down and sealed position;

FIG. 12 is a close-up internal view of a toilet tank leaking due to a defective flapper;

FIG. 13A is a cutaway view of an example toilet tank representing the abnormal increasing water height due to a faulty fill valve which fails to terminate water flow in response to the maximum height of the float;

FIG. 13B is a cutaway view of an example toilet tank refilling through the fill valve after sufficient water has leaked out through the defective flapper to cause a tank refill to begin;

Example Additional Non-Limiting Sensor Configurations

FIG. 14 shows the circuit diagram for a common resistive fixed point fluid level sensor;

FIG. 15 shows the operational circuit diagram of a commercially available type of capacitive fluid level sensor;

FIG. 15A shows the operational circuit diagram for a type of capacitive sensor that uses the fluid container vertical housing as the dielectric and the fluid as one plate of the capacitor;

FIG. 16 shows a typical Hartley oscillator whose frequency changes in response to the capacitor value, and a corresponding square wave that is produced in response to the change in capacitance;

FIG. 16A shows a typical unijunction transistor-type relaxation oscillator whose frequency changes in response to the capacitor value, and the corresponding output waveform;

FIG. 16B shows a simple resistor-capacitor (RC) type pulse measurement circuit connected to a microcontroller, and a corresponding pulse that is produced by the microcontroller input port in response to the discharge time of the capacitor;

FIG. 17 shows the exemplary integrated circuit (IC) type oscillator-divider using a precision resistor-capacitor (RC) type oscillator with a binary divider circuit, and a corresponding square wave that is produced in response to the change in capacitance, and an example microcontroller connected to the oscillator-divider;

FIG. 18A shows a capacitive water height sensor containing a single uninsulated wire and a single vertical insulated wire;

FIG. 18B shows the exemplary capacitive water height sensor containing a single uninsulated wire and a U-shaped single insulated wire;

FIG. 18C shows the FIG. 18A capacitive water height sensor submerged in liquid;

Example Non-Limiting Toilet Monitor Embodiment

FIG. 19 shows an exemplary toilet monitoring and intelligent control system with the exemplary capacitive water height sensor and the electronic control and annunciation module located inside the toilet tank;

Example Non-Limiting Characteristic Toilet Operation Signals

FIG. 20 graphically represents an example complete flush cycle of a typical tank-based toilet that is functioning properly with no blockages or obstructions, by tank water height and time;

FIG. 20A graphically represents an example tank evacuation of FIG. 20 by tank water height and time;

FIG. 20B graphically represents an example tank evacuation of FIG. 20 by tank water height and interval;

FIG. 20C graphically represents an example tank refill of FIG. 20 by tank water height and time;

FIG. 20D graphically represents an example tank refill of FIG. 20 by tank water height and interval;

FIG. 20E is a data listing by tank water height and time of the FIG. 20 graph;

FIG. 21 graphically represents an example complete flush cycle of a typical tank-based toilet with a blocked siphon jet, by tank water height and time;

FIG. 21A graphically represents an example tank evacuation of FIG. 21 by tank water height and time;

FIG. 21B graphically represents an example tank evacuation of FIG. 21 by tank water height and interval;

FIG. 21C graphically represents an example tank refill of FIG. 21 by tank water height and time;

FIG. 21D graphically represents an example tank refill of FIG. 21 by tank water height and interval;

FIG. 21E is an example data listing by tank water height and time of the FIG. 21 graph;

FIG. 22 graphically represents example back-to-back flushes of a typical tank-based toilet with a 95% blocked drain pipe, by tank water height and time;

FIG. 22A graphically represents an example first flush tank evacuation of FIG. 22 by tank water height and time;

FIG. 22B graphically represents an example first flush tank evacuation of FIG. 22 by tank water height and interval;

FIG. 22C graphically represents an example second flush tank evacuation of FIG. 22 by tank water height and time;

FIG. 22D graphically represents an example second flush tank evacuation of FIG. 22 by tank water height and interval;

FIG. 23 graphically shows an example sequence of 4 phantom flushes, followed by a period of time in which the fill valve is in equilibrium, and then a final phantom flush, by tank water height and time;

FIG. 24 graphically shows an example tank water height response to a fill valve termination failure with respect to time;

FIG. 25 graphically shows an example normal tank evacuation of an average tank-based toilet, followed by an example wide-open flush valve that prevents the refill of the tank, by tank water height and time;

FIG. 26 shows the FIG. 20 graph of an example normal unimpeded flush cycle of a typical tank-based toilet compared with the FIG. 21 flush cycle graph of the same toilet when the siphon jet is blocked and thereby preventing bowl evacuation, by tank water height and time.

Example Toilet Tank Dimensions and Volume

FIG. 27 shows an example 2-dimensional cross-section of a typical tank-based toilet as viewed from overhead;

FIG. 28A-C show an exemplary non-limiting toilet monitoring and intelligent control system with the exemplary capacitive water height sensor located inside the toilet tank and the electronic control and annunciation module located outside the toilet tank;

Example Non-Limiting Toilet Monitoring and Control Operation

FIG. 29 shows an example power-up sequence and main loop flowchart of a microcontroller-based operating system of the exemplary toilet monitoring and intelligent control system;

FIG. 30 shows an example flush detection flowchart of a microcontroller-based operating system of the exemplary toilet monitoring and intelligent control system;

FIG. 31 shows an example user pushbutton flowchart of a microcontroller-based operating system of the exemplary toilet monitoring and intelligent control system;

FIG. 32 shows an example user alerts flowchart of a microcontroller-based operating system of the exemplary toilet monitoring and intelligent control system;

FIG. 33 shows an example datalogging flowchart of a microcontroller-based operating system of the exemplary toilet monitoring and intelligent control system; and

Example Toilet Suction Port Operation:

FIGS. 34A & 34B show example non-limiting toilet suction port operation.

### DETAILED DESCRIPTION OF EXAMPLE NON-LIMITING EMBODIMENTS

(General Toilet & Actual Water Costs Due to Leaks & Wide-Open Flush Valves/Flappers) Chris Oxlade identified the toilet as one of the top innovations of all time in his 2009 book, “The Top Ten Inventions That Changed the World”. What his book might have overlooked was the millions of home and business owners who have fallen prey to leaks, problems, and damage associated with or caused by toilets. Many water utilities and agencies cite toilets as being the #1 cause of high water bills. Many larger utilities field thousands of customer service calls each month regarding a spike or increase in their water-in/water-out invoices, which often results in angry customers with unresolved water problems in their home. Most utility customers refuse to believe that a toilet could be the culprit for their high water bill. Widely published statistics state that a silent and leaking flapper can easily account for 200 gallons of water wasted per day, and yet still go unnoticed by the occupants. Wide-open flush valves—which can occur for many reasons, but most frequently happen when the flush handle linkage chain gets hung up—can easily waste more than 4 gallons per minute, or more than 5,000 gallons per day. In places like Atlanta or Seattle where the water-in/water-out cost exceeds $15 per thousand gallons, it's easy to see how an overlooked toilet problem can lead to a “Water Bill Nightmare!”

(Overview of Damage & Costs Due to Overflows) Worse still is the billions of dollars in property damage that occur every year due to overflowing toilets. While conservationists and environmentalists applauded the mandates for low-volume-flush toilets beginning in the 1990's, the poop volcanoes that were once easily dealt with by high gallon-per-flush commodes began to result in “double-flushes”, which often led to disastrous overflows. The specific reason “why” double-flushes often lead to toilet overflows will be explained in detail later in this specification, as it is often attributed to toilet malfunctions, when in fact that is not the case. Black mold remediation due to overflows has become big business in the United States and frequently costs more than $35,000.00 when the damage is extensive.

(Inferior Quality of Some Fill Valves Has Led to More Problems) While leaks, wide-open flush valves, and overflows, are the better-known toilet problems, there are several additional problems that can also lead to wasted water and high bills. 20 years ago Fluidmaster practically ruled the fill valve market in the United States, and rightly so. Their Model #400 fill valve is, in this inventor's opinion, the most reliable and dependable fill valve ever put into production. Over the last 10 years, other manufacturers have begun to crowd the space that Fluidmaster once owned, both in retail and industrial sales volume. Some fill valves are now even Model #400 knock-offs: they look similar, but they are less reliable. Market competition has resulted in more diverse fill valve product choices from multiple manufacturers, but it has also resulted in cheaply made inferior products that, in many instances, exhibit extraordinarily high failure rates. In fact, many of the fill valves now on the market commonly exhibit several types of failures that home owners are often unable to diagnose, and frequently even plumbers are unaware of these types of anomalies.

(Equilibrium Failure) The first failure exhibited by a high percentage of fill valves tested—even when new right out of the box—is what we will term herein as an “Equilibrium Failure”. Equilibrium failures occur when the toilet is leaking, the water level in the tank is dropping, but the fill valve fails to refill the tank. Instead, the fill valve only partially opens and begins to allow water into the tank at the same volumetric rate as that of the leak, hence reaching a “state of equilibrium”, specifically meaning that the water-in (entering from the water supply line) to the fill valve is exactly equal to the water-out (that which is draining into the tank and ultimately into the toilet bowl). This failure occurs for several reasons and is often never discovered because there is virtually no noise of any kind, and the water that is entering the toilet bowl—particularly a clean toilet bowl—is virtually invisible. Further compounding the likelihood of a leak not being detected is the absence of a “phantom flush”, which a fill valve in equilibrium failure will not produce. A phantom flush is generally recognized as the periodic audible “whooosh” sound made by a properly working fill valve when the water level in the tank has dropped due to a leak, with the float on the fill valve responding by allowing water to refill the tank, producing tank turbulence and thereby causing the audible sound. Adding insult to injury for thousands of customers who experience high water bills and are then advised by the water agency or a well-meaning plumber or DIY professional to replace the flapper, is that despite correcting the initial cause of the leak, a faulty fill valve which exhibits equilibrium failure will likely exhibit another type of failure that can be even worse when it comes to water loss.

(Water Termination “Bleed” or “Valve Closure” Failure) The second type of fill valve failure is more nefarious, harder to detect, does not appear in water utility websites or customer literature handouts as an actual cause for water loss, and has frustrated more homeowners than “Sand on the Beach” (that's going to be the title of my second movie). At the end of the flush cycle the water level rises, raising the float, which should cause the fill valve to close and terminate the water flow into the tank. But when a valve closure failure occurs and the fill valve does not completely close, water continues to bleed into the tank despite the position of the float. This continued bleeding causes the water level to rise until it reaches the top of the overflow tube, where it then drains continuously into the toilet bowl. Extensive research has shown that not only does the fill valve continue to bleed, but in many instances, the volume of water will increase steadily over time. Because this type of failure is virtually unknown by the population at-large and by water utility customer service representatives seeking to help those callers complaining of a high water bill due to a suspected toilet malfunction or leak, a diagnostic approach may, in fact, prove that a leak exists, while the generally recommended “flapper replacement” fails to solve the problem.

(Various Failures Nearly Impossible to Detect, Let Alone Identify) Given the fact that only a small fraction of adults understand the purpose and function of a toilet flapper, it is not surprising that the more complex failures are often overlooked. Therefore, for general information purposes, an overview of the typical operation for a tank-based flush toilet follows.

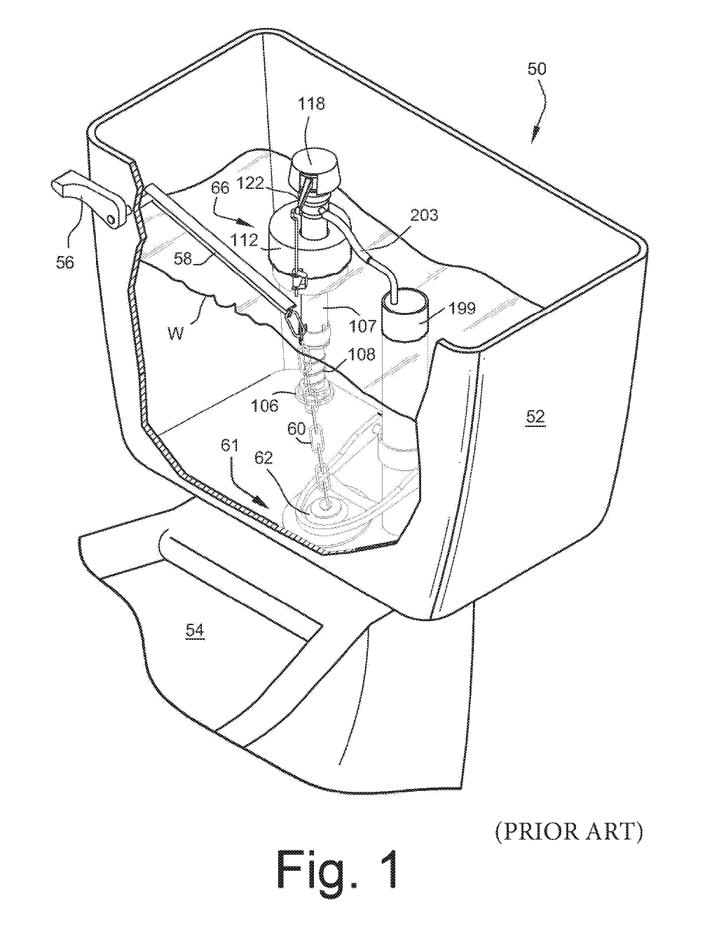

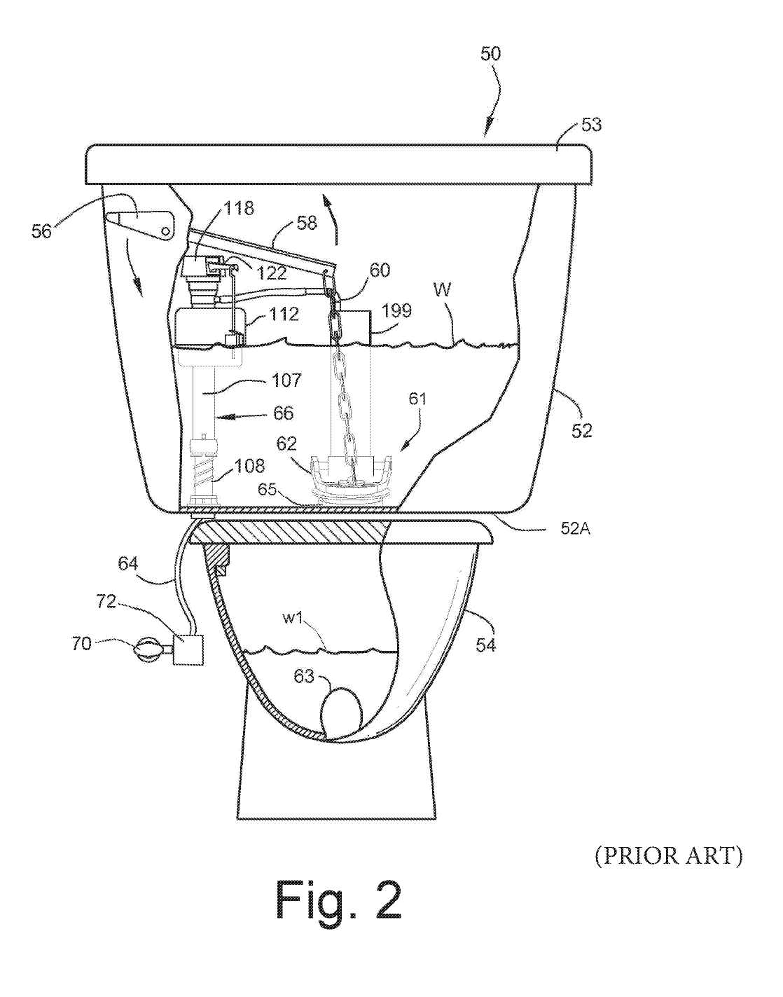

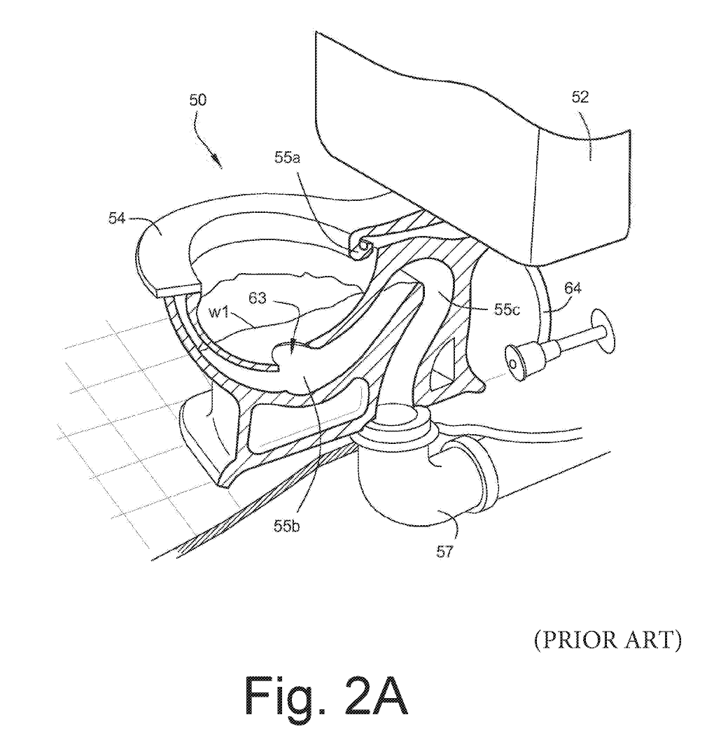

(A General Overview of Tank-Based Toilet Operation) FIGS. 1, 2 & 2A show an exemplary illustrative non-limiting modern (prior art) toilet 50 comprising a tank 52 and a bowl 54. The tank 52 holds a quantity of water W. Pulling on the flush handle 56 causes a lever 58 to lift a chain 60, which in turn raises a “flapper” 62 at the bottom of the tank 52. Flapper 62 is a kind of valve that flaps open and closed. When chain 60 raises flapper 62 off of flush valve seat 65, water W from the tank 52 rushes downward through an opening into the bowl 54. This inrush of water flows through rim holes 55a and siphon jet 55b (see FIG. 2A). This water inrush increases the water pressure within the bowl, forcing water through exhaust port 63 and past vapor trap 55c beneath the bowl and down into waste pipe 57. This flow of water and waste into the waste pipe 57 creates a strong siphon that evacuates the bowl through exhaust port 63, producing the characteristic flushing sound familiar to most people. In most toilets, the bowl 54 is molded so that the water enters the rim, and some of it drains out through holes in the rim. A good portion of the water flows through a passageway down to a larger hole at the bottom of the bowl as shown in FIG. 2A. This passageway and hole is known as the siphon jet 55b. It releases most of the water directly into siphon jet 55b. Because all of the water in tank 52 enters bowl 54 in a very short time (e.g., three seconds), it is enough to produce the siphon effect, and all of the water and waste in the bowl is sucked out.

When nearly all of the water has escaped from the tank 52, the flapper 62 descends back down to its original position as shown in FIG. 2, once again sealing the water passage between the tank and the bowl 54. Fresh tap water flowing into the tank 52 through a fill valve 66 from an inlet pipe 64 begins to fill the tank. A float 112 rises with the rising water level. When the float 112 reaches a preset level, it closes the fill valve 66 and water ceases to flow into the tank 52. The toilet 50 is now ready for another flush.

While toilets are generally reliable, they can malfunction from time to time, as previously noted. Perhaps the most common malfunction is when the flapper 62 remains partially open, leaks, or is misaligned, causing the toilet to “run.” A stuck-open flapper 62 can waste a lot of water. This can be a serious problem, especially in cases of water shortages or droughts. Sometimes the fix is as simple as jiggling the flush handle 56. Other times, it is necessary to replace the flapper 62. It is occasionally possible to detect the flapper 62's failure to close by listening for water running continuously into the tank 52, although the sound of trickling water can be barely audible. But suppose the trickling water is at least somewhat audible. Often, people are not home to hear the water running. Folks who are hearing impaired may not be able to hear water running. In many bathrooms, when the light is turned on, an exhaust fan also turns on, further decreasing the likelihood of a slightly audible toilet trickle being detected. Hundreds of gallons of water can be wasted in this way in a relatively short time. Some readily available water agency surveys estimate that of the approximately 300,000,000+ toilets in the United States, as many as one in five may be leaking at any point in time.

A running toilet can waste a lot of water but usually does not present health hazards. An overflowing toilet, on the other hand, can be a serious household hygiene disaster—as anyone who has ever had to clean up the consequences knows very well. Watching water rise to the top edge of a toilet bowl is a fearful experience. Overflowing toilet bowls can spread germs and disease, cause structural damage to homes and businesses, contribute to toxic mold, and cause other bad effects.

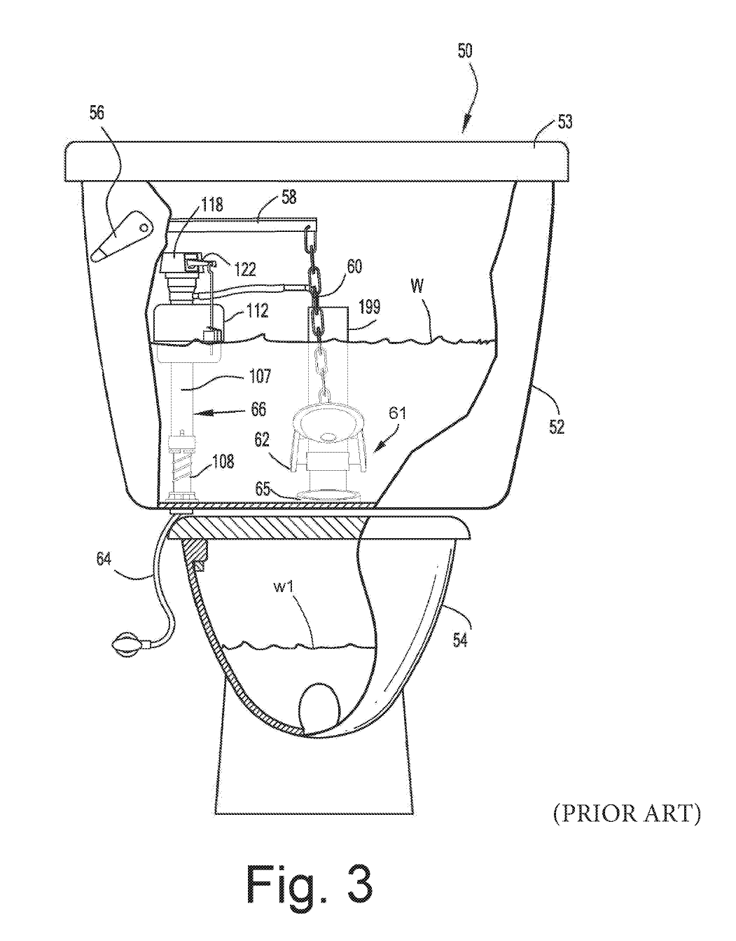

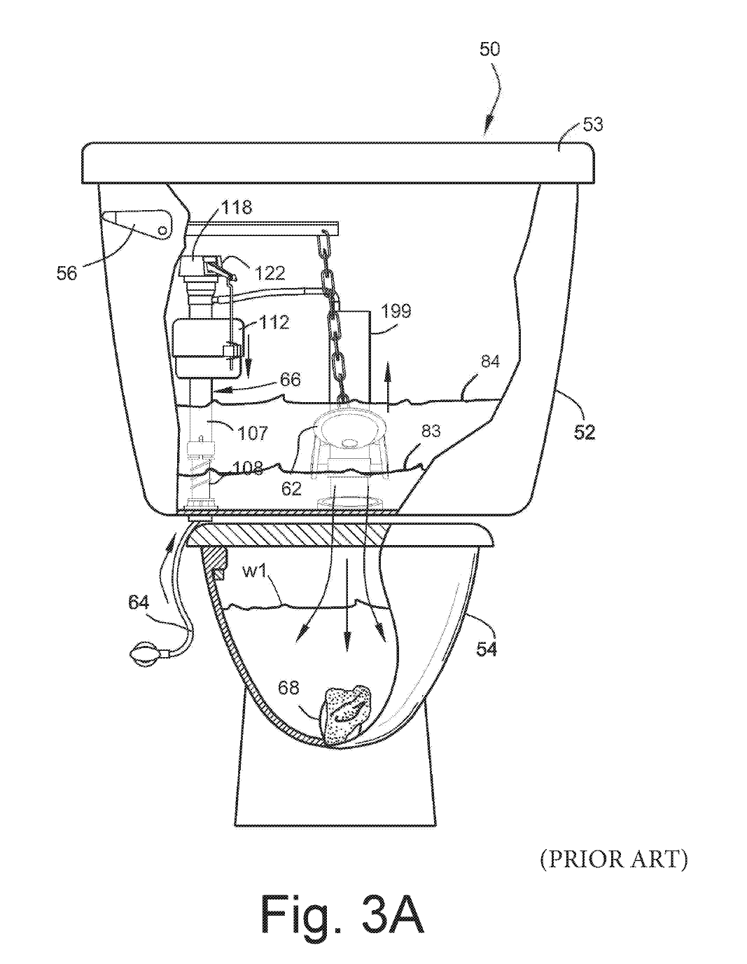

FIG. 3 shows an example normal evacuation situation and FIG. 3A shows an example clogged toilet situation. When debris (e.g., a child's toy, excess quantities of toilet paper, a massive poop volcano, etc.) blocks the toilet exhaust port 63 or further down waste pipe 57 as shown in FIG. 3A, flushing the toilet does not cause the bowl 54 to evacuate. Instead, the water level within bowl 54 continues to rise as water from the tank 52 rushes downward into the bowl. In many instances, the water will stop rising before the toilet overflows. This is because most toilet bowls 54 are designed to hold the entire contents of the tank 52 without overflowing—but only if the water in the tank falls low enough to allow the flapper 62 to seat so as to prevent further water from flowing into the bowl 54. Overflows can occur with just a single flush when blocked siphon 55b port (see FIG. 2A) prevents the rapid evacuation of the water in the tank 52 while the fill valve 66 is open.

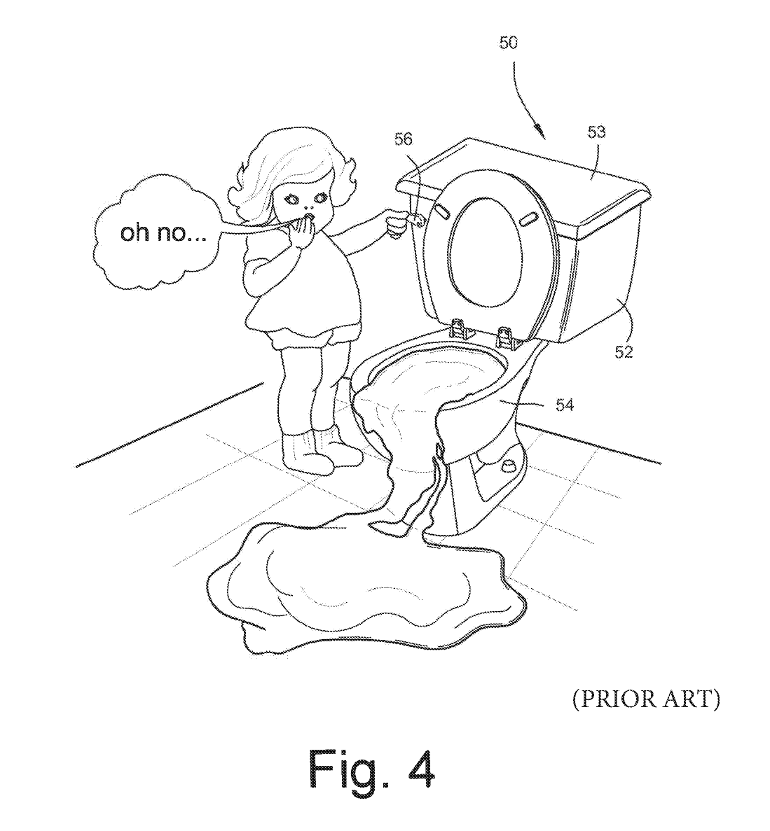

Toilets can also overflow if the water level in the bowl 54 starts out higher than normal when the toilet is flushed. As FIG. 4 shows, when a toilet bowl 54 is clogged so that a single flush doesn't flush the bowl's contents away, some people will flush the toilet a second time in the hope that the additional water will push the bowl contents down through the outlet pipe 63. Additional flushing rarely clears the clog, but can easily cause a toilet bowl to overflow, as will be described in detail later in the specification.

The second flush often overflows the bowl because when the bowl water height is substantially higher—or not—due to a previous flush AND the drain is partially or fully clogged, a further flush will fill the bowl, preventing the flapper from seating because the tank will not drain sufficiently to allow the positive buoyancy of the flapper to seat; and when the water-in from the fill valve exceeds the water-out of the obstructed drain, the overflow will occur at the delta differential rate, which can be several gallons per minute of contaminated water going over the edge of the bowl and onto the floor)

Parents should warn their children that when the water level in a toilet bowl is higher than normal, the toilet should not be flushed again. Unfortunately, it is common for children and others who do not know better to flush a toilet repeatedly in the hope that additional consecutive flushes will eliminate the blockage. Adding insult to injury, a lot of children love to experiment and play with toilets, tossing in toys and other objects, and smacking the flush handle. Often times when the water begins to rise precipitously in the bowl and the child (or adult!) does not know what to do and does not wish to call attention to the impending nightmare that is about to occur, the individual will discreetly sneak away, perhaps hoping that the problem will “fix itself”, or minimally that they won't be identified as the culprit!

The reduction in the amount of water used to flush or evacuate toilets has also consumed the time and attention of water utilities, landlords, home and business owners, and manufacturers. Great strides have been made in the design of toilets which are capable of removing substantial amounts of waste from the bowl while using far less water than past toilet designs. Changes in flush valve and fill valve designs have made it possible to better control the volume-per-flush of many toilets, while dual-flush toilets have allowed users and property managers to control flush volumes on the basis of the need to evacuate solid or liquid waste. To-date, however, flush volumes are still primarily a function of preset fill valves and flush valves, or a user-based decision on dual-flush capable toilets. Property management, hospitality, and water utilities rightly desire better water conservation and less water waste, and recognize that when left solely to the discretion and control of customers, guests, residents, etc., that water savings is more of a politically correct manner of speech than it is actual reality . . . unless there is an imposed financial penalty.

Yet while the toilet is a much-used and needed product in civilized nations around the globe, its actual operation and the nature of its various failures remain a mystery to all but a few. With less than one percent (1%) of the planet's water being potable, an ever increasing global population, wide-spread and long-lasting regional and hemispherical droughts becoming more and more frequent, it is becoming more and more important to not just detect the various types of toilet problems and failures that lead to water being wasted (and the damage that wasted water often produces), but do so quickly, cost-effectively, and whenever possible, terminate excessive unintentionally wasted water.

(Prior Art Water Conservation Approaches in View of Tank Volume, Timing, etc.) Many different approaches have been used to conserve water when it comes to toilets. From dual-flush methodologies and increasingly efficient toilet designs to placing water-displacement bricks in the tank, a great deal of progress has been made when it comes to focusing specifically and only upon the toilet design and features. A new and novel water conservation approach will be described herein which uses the water height data analysis of each flush to determine user waste characteristics to automatically optimize flush volumes.

(Many Different Approaches Yet No Still No Cost-Effective Technology/Product for Various Markets; Reasons Why—Primary Reason is the Number of Permutations of Toilets, Flush Volumes, Fill Valves, Flush Valves, etc., have heretofore precluded the deployment of a single product solution) Many in the past have tried to use technology to detect toilet leaks, prevent overflows, reduce or control toilet flush volumes, and mitigate or stop the wasting of water. Most of the solutions that exist to-date have been ineffective, cost-prohibitive, too complicated to implement or install, or just too poorly conceived to be of practical use. Several existing solutions for terminating water flow to a “problem toilet” involve placing an electronic valve in the fluid fill line 64, often with a plethora of unsightly and poorly conceived tank and bowl sensors which, for many users and property managers, is aesthetically unacceptable. Such installations also require plumbing knowledge, if not an actual plumber, in order to implement, which increases the overall installation cost. Other known solutions involve special toilet designs that provide overflow plumbing. Convoluted fill valve and flush valve designs and assemblies—impractical to manufacture and too expensive to implement—have frequently hit the market. Yet none of these approaches have ever been widely adopted, so the troublesome problems of toilet overflow and water waste still exist. Further, addressing the issue of leaks and fill valve failures has led to the development of products that have also never received wide acceptance. When it comes to the marketplace, the general public, property management, hospitality, and water utilities, need something that is ultimately as simple to install and use as the toilet itself. It is a significant challenge to solve these technical and market-based problems for the large number of toilets already installed in millions of homes and businesses.

The main reason that most mass market solutions have been unsuccessful comes down to simple mathematics: the number of different permutations of tank-based toilets installed around the globe is in the tens of millions. As a result, the combination of fill valve and flush valve types, toilet tank and bowl designs, flush volumes, water pressure, etc., makes designing a universal, easy to install and use simple apparatus, very difficult.

(Generic description/overview) What is needed is a simple, yet effective, reliable, relatively inexpensive “toilet problem detection” method and apparatus that can be universally used with all types of new and already existing toilets, which can be easily installed, readily understood, and installed in seconds without tools.

The exemplary illustrative non-limiting technology described herein provides a new and useful apparatus, located within or on the toilet tank, which can detect different types of toilet and toilet component failures that lead to water loss and/or damage and, in several embodiments, terminate the actual water flow in order to prevent the same.

Exemplary illustrative non-limiting technology is for use with tank-based flush toilets comprising float-based or pressure-based fill valves, flush valves, and wherein the tank water evacuates into a toilet bowl for the purpose of waste removal. The method and system includes a water height and water rate-of-change responsive detection method, and may or may not include a user alert and/or correspondingly responsive water termination method.

Exemplary illustrative non-limiting technology is further described for use with tank-based flush toilets, said non-limiting technology using toilet tank-located sensors in conjunction with unique linear and non-linear algorithms for detecting imminent toilet bowl overflows without the use of toilet bowl sensors. The method and system includes a real-time water height and water rate responsive detection method, and may or may not include a user alert and/or correspondingly responsive water termination method.

Exemplary illustrative non-limiting steps include removing the toilet tank lid, inserting the assembly on, over, or around the tank wall or fill valve, and automatically determining toilet or toilet component failures that result in unintentional water loss or water damage, alerting the user or property manager and, when connected, attached, or integrated into a fill valve, conditionally interferes with said fill valve to terminate or override the normal operation of said fill valve. (Reflects commonly-owned issued U.S. Pat. Nos. 7,757,708 and 8,166,996, which describe fill valve interruption for terminating water flow)

Further exemplary illustrative non-limiting unique features and/or advantages include:

Low power inexpensive circuitry that is optimized for extended battery life;

A circuit and method using a novel type of capacitive water height sensor capable of real-time tracking of water height, linear and non-linear water slope data analysis indicating intentional and unintentional water flow, and identifying the toilet components responsible for water loss and/or water damage;

A novel type of relative capacitive water height sensor, circuitry, and method, which does not require calibration or user set-up, which is exclusively deployed in the toilet tank while able to detect anomalies that occur within the toilet bowl;

A novel type of capacitive water height sensor, circuitry, and method, the operation and accuracy of which is not negatively impaired or affected by changes in water pressure, temperature, salinity, contamination, or electrode electrolysis;

An operational algorithm that accurately tracks and monitors the intentional and unintentional water use for survey, data recordation, and analysis purposes;

An operational algorithm which automatically optimizes flush volumes as a function or toilet use over time;

An operating system specific to property management and hospitality environments where guest and resident convenience is first and foremost, such that the visible and audible alerts are disabled, wherein remote telemetry and/or local access advises and/or alerts non-resident personnel to toilet problems and/or damage due to water;

An operating system that the user or property manager can customize to determine the type of toilet problems to be detected and the corresponding desired alerts and actions that result from the problems detected;

A tamper-proof feature for property management and hospitality whereby the novel capacitive water height sensor and operating system activate a self-contained or remote alarm in the event the device is removed from the water in the event of theft, damage, or tampering;

A water height monitoring algorithm capable of detecting and providing alerts for leaks, wide-open flush valves, toilet overflows, faulty flush valves, faulty fill valves, and various toilet failures generally not noticed and/or corrected by users and property managers;

Audible and visible user alerts in the event of leaks or toilet problems;

Remote telemetry and remote control capability which alerts non-resident or property management personnel to problems and/or allows non-resident personnel to selectively gain access to the toilet monitoring and intelligent control system in order to facilitate a response or repair;

Digital and/or analog output capabilities for facilitating remote control, telemetry, or selectively controlling actuators and/or valves connected to the toilet water feed line, fill valve, or flush valve, in order to terminate or mitigate water flow;

In order to satisfactorily and completely describe the toilet monitoring and intelligent control system herein, a description of the various types of toilet components and their operation, specific operational failures due to those same components, and the resulting water loss and damage due to component and toilet failures, may first be explained. The system and method described herein is capable of determining both the proper and improper operation of most tank-based toilets, advising the user or property manager accordingly and, as will be described in various embodiments, terminating water flow in order to prevent water loss and/or damage. A further capability of the system and method allows for the automatic adjustment of flush volumes in order to minimize water use as a function of the actual toilet users over time. For the sake of clarity, “intentional” operation of the toilet is that which the user initiates, generally referring to “flushing the toilet”. “Unintentional” operation is any problem or failure related to the toilet in which water is wasted or water damage occurs, as the occurrence and result of such is unintended by the user.

### Exemplary Prior Art Fill Valve Design, Operation, and Failure Modes

As explained above, conventional fill valve 66 in FIG. 1 and FIG. 2 functions to control the flow of water into the tank 52 of a toilet 50. The fill valve 66 allows water to flow into the tank 52 until the tank is full, and then stops the flow of water. When the toilet 50 is flushed, the fill valve 66 senses the decrease in water level within the tank 52 and once again allows water to flow into the tank until the tank is again full.

Briefly, the fill valve 66 senses the decrease in water level based on the position of a buoyant “float” 112 that floats on the surface of the water within the toilet tank 52. When float 112 falls, this typically indicates that the water level within tank 52 has dropped because someone has flushed the toilet. Fill valve 66 responds by letting more water flow into the tank 52. When float 112 rises to a certain height, fill valve 66 responds by stopping the flow of water into the tank 52. This is the basic principle on which most tank-based flush toilets have operated for decades, including for example “old fashioned” or alternative “ball cock” style floats made from copper, brass, rubber or other constructions.

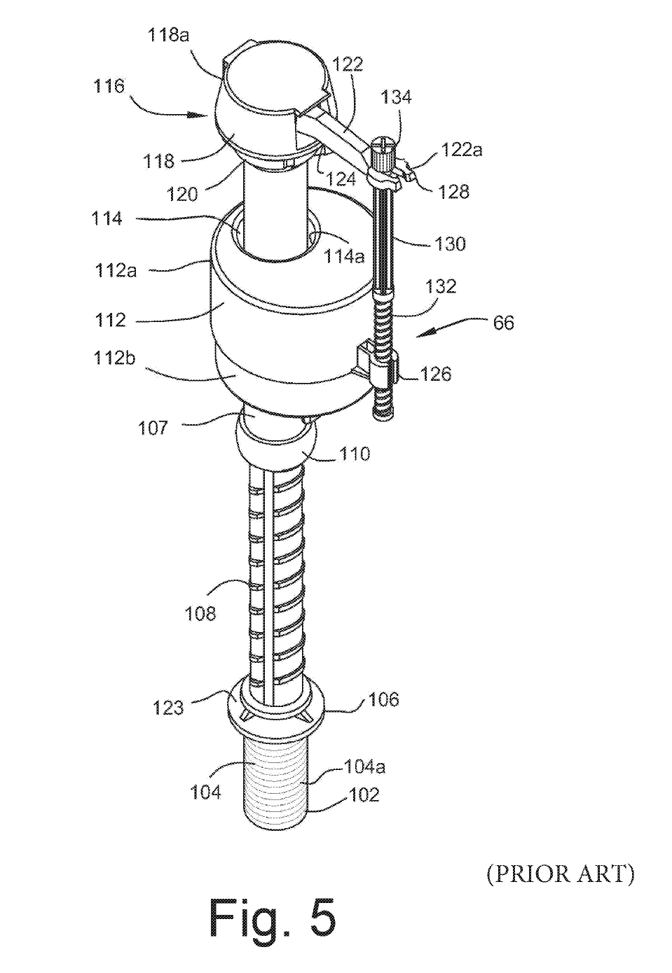

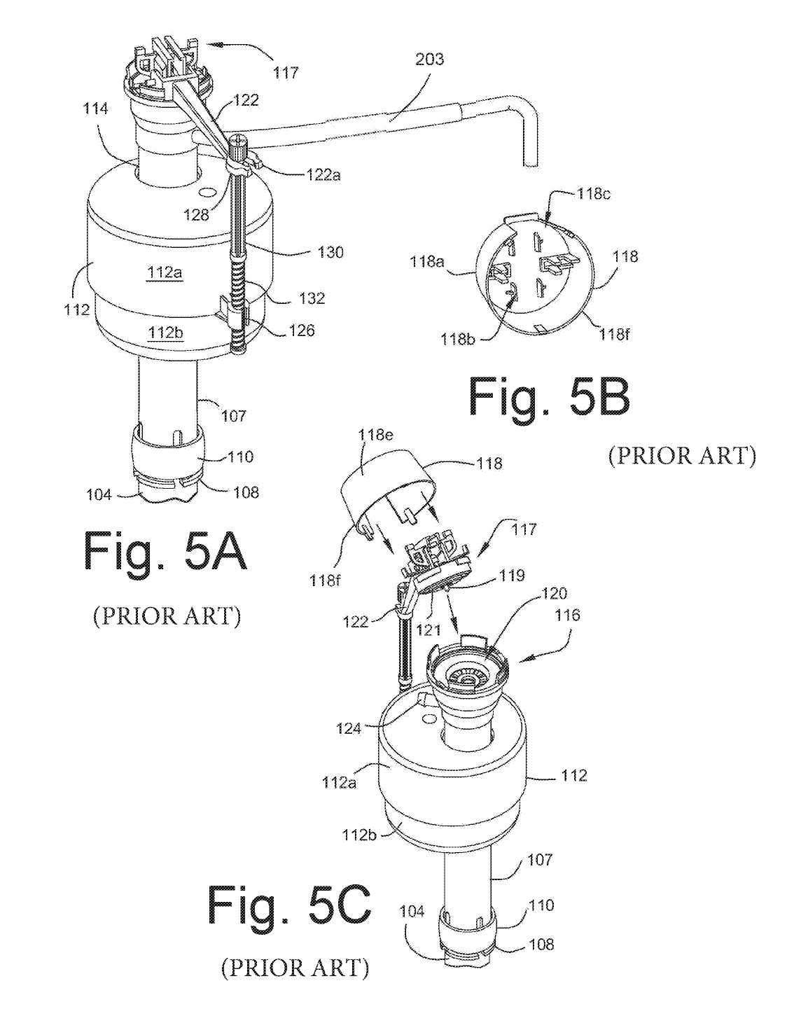

In more detail, the particular conventional fill valve 66 shown in FIG. 5 includes a shaft like valve body 102 with a stem 104 that protrudes through a hole in the bottom of a toilet tank 52. Water under pressure from a household or other cold water plumbing system is fed through the stem 104 into the valve body 102. A conventional cold water feed toilet tank fitting is used to feed pressurized water from the cold water feed line (see FIG. 2A) into the stem. Threads 104a may mate with a conventional lock nut (not shown) to firmly attach and seal the fill valve 66 to the toilet tank 52. A flange 106 and associated shank washer forms part of this seal and also supports the fill valve 66 so it remains in a vertically upright position within the tank 52.

A threaded shank 107 concentric to and surrounding fill valve body 102 provides a height adjustment mechanism. By rotating shank 107 relative to valve body 102, the sleeve ascends or descends on the valve body along threads 108. This height adjustment allows the end user to adapt fill valve 66 to a variety of differently sized toilet tanks and plumbing fixture arrangements, while also being the primary method for setting the total volume of water used during a flush. A plastic ring 110 retains the shank 107 on valve body 102 so that it does not slip off under location by the end user. One exemplary illustrative non-limiting implementation provides a height adjustment of up to five inches using this arrangement. See “Fluidmaster 400A Fill Valve Installation Instructions” Part No. 4-743 Rev. 1 (8/05) incorporated herein by reference.

Float 112 is retained by, and moves relative to, valve body 102. In this particular exemplary illustrative non-limiting design, float 112 includes an upper portion 112a and a lower portion 112b. Upper portion 112a and lower portion 112b are each hollow cups. Upper and lower portions 112a, 112b are fastened together using conventional techniques to provide a waterproof fastening and thereby function as a flotation device, which is buoyant and therefore floats on or near the surface of the water.

In the exemplary illustrative non-limiting implementation, float 112 has defined therethrough a cylindrical channel 114. Cylindrical channel 114 has a diameter that exceeds the outer diameter of shank 107. Float 112 is designed so that the cylindrical channel inner wall 114a also provides a waterproof barrier to the hollow interior of float 112. In some implementations, ridges that are vertically oriented on the cylindrical channel wall 114a nearly contact or do contact the shank 107 outer diameter to provide a low friction centering arrangement that is resistant to trapped debris and allows float 112 to freely move vertically on shank 107 as the water level changes within a toilet tank.

As shown in FIG. 5C, at an upper end portion 116 of fill valve 66, a protective cap or top 118 is used to protect an internal needle valve 117 that is disposed within an upper valve body 120. Needle valve 117 is a pin diaphragm type valve. A pin 119 is connected to a sealing diaphragm 121. When lever 122 is pushed up, the pin 119 pushes down on the diaphragm 121 which seals the valve so no water flows through the fill valve 66. When lever 122 moves vertically downward, the pin 119 lifts the diaphragm 121 to open the seal. The needle valve 117 opens and water is permitted to flow from valve body 102 to outlet port 124 and also down through valve body 102 to water exit ports 123 at the bottom of the fill valve near flange 106.

As shown in FIGS. 5B and 5C, protective cap 118 protects the needle valve 117 but is not involved in the operation of the valve. This cap 118 has a snap fit, and is designed to be removable to allow users to clean or replace the needle valve 117. Retaining projections 118b molded within the inside of cap 118 allow the cap to be removably snap-fit onto mating structures 117 a extending from needle valve 117.

In this exemplary illustrative non-limiting implementation, there is a partially cylindrically channeled, threaded retaining projection 126 formed integrally with or attached to float upper portion 112 a (see FIG. 5A-C). An end 122a of lever 122 terminates in a horseshoe shaped retaining portion 128. A vertically oriented water level adjustment rod 130 is loosely coupled to the lever end 122a and to projection 126. Rod 130 may provide a threaded portion 132 to provide adjustability. The rod 130 is retained within the horseshoe-shaped portion 128. An end user can rotate rod 130 to provide adjustments between the rod threads 132 and threaded projection 126.

In use, when flush handle 56 is depressed, flapper 62 opens and tank 52 evacuates into bowl 54. This causes the water level in tank 52 to drop. Gravity then exerts a downward pull on float 112. This causes float 112 to descend along shank 107. Rod 130 descends with float 112. As rod 130 descends, it exerts a downward force on lever 122. This downward force on lever 122 causes the lever to pull up on pin 119, which causes the needle valve 117 to open and water to flow through the fill valve 66 into the toilet tank 52.

As the water level within the tank rises, it eventually contacts float 112. As mentioned above, the float 112 is buoyant and floats on or near the surface of the water. As the water level increases, it raises the level of float 112. As float 112 rises, it exerts an upward pressure onto rod 130 which in turn raises the lever 122. When the lever 122 has been raised sufficiently, it exerts a downward force on pin 119 to seal the needle valve 117. Water then ceases to flow into the tank through fill valve 66. In this state, the toilet tank is full and the toilet is ready to be flushed.

When the toilet is flushed, the water level within the tank rapidly falls. The descending water level within the tank allows float 112 to fall under the force of gravity. As the float 112 falls, it exerts a downward pressure through rod 130 onto lever 122 that again opens the needle valve 117 and allows water to begin flowing through fill valve 66 into the toilet tank 52. This in turn, under normal conditions (i.e., assuming flapper 62 is closed), causes the water level within the tank to again rise, causing float 112 to rise again and eventually turn off the flow of water into the tank.

It should be apparent that this particular fill valve 66 shown in FIGS. 5, 5A, 5B and 5C is well designed, highly reliable and is capable of delivering long periods of trouble-free service, further evidenced by the millions of valves sold annually by the manufacturer through hardware stores and home improvement centers. As will be explained shortly, there are fill valves of inferior quality also available on the market that exhibit certain failures due to poor design and construction. Referring back to the fill valve 66 herein identified, it should be apparent that the proper operation of fill valve 66 depends entirely on the position of float 112. When float 112 is in its lower position, fill valve 66 allows water to flow into the toilet tank 52. When float 112 is in its uppermost position, flow valve 66 stops water from flowing into the toilet tank 52. The operation of fill valve 66 is thus completely dependent on the position of float 112, which in turn is completely dependent (under normal conditions) on the height of the water within the toilet tank 52.

Suppose the float 112 were to become detached, or the fill valve 66 was to jam so that it never cut off the water flow into tank 52. Theoretically, the tank 52 would overflow and flood the bathroom. But the overflow tube 199 is there to prevent that from happening, directing the extra water into the bowl 54 instead of onto the floor. Therefore, conventional toilet mechanisms have been designed to prevent overflow due to this type of malfunction of fill valve 66.

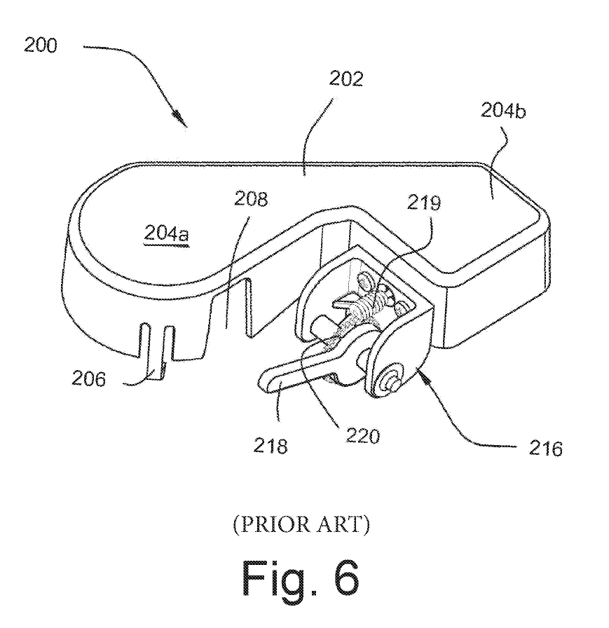

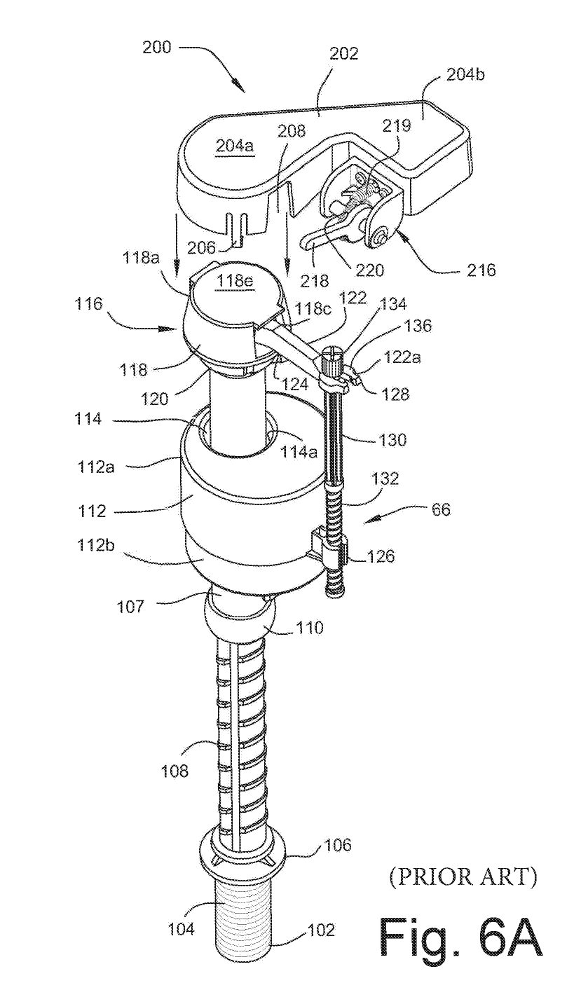

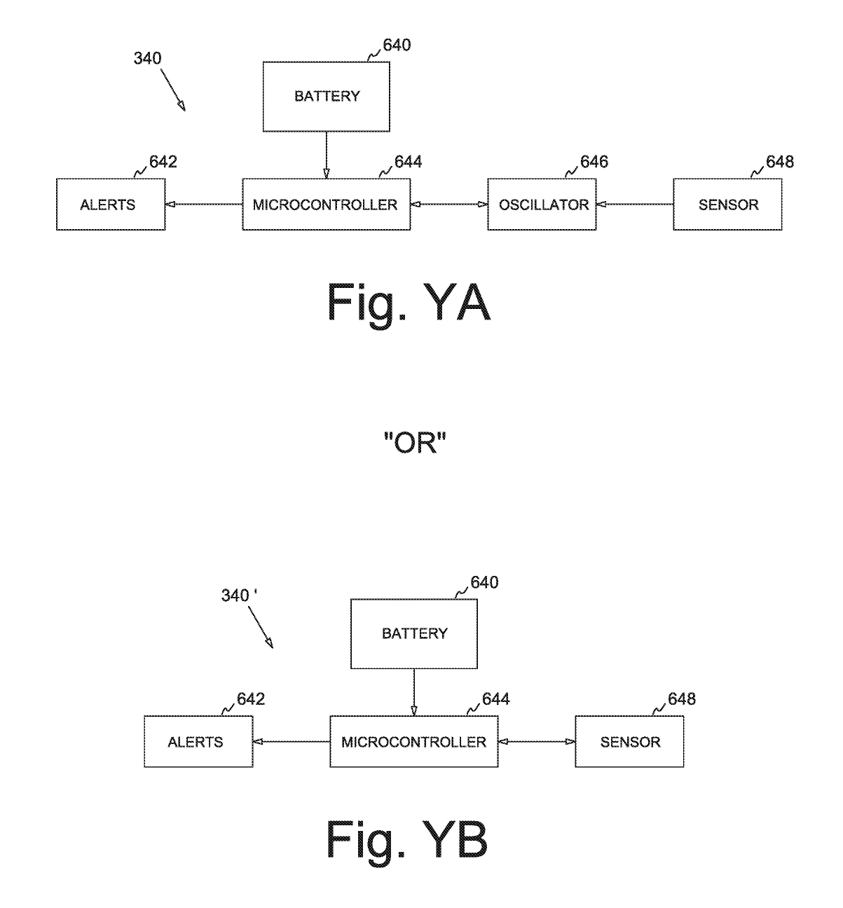

FIG. 6 shows an example of a mechanized water termination or interruption assembly that snaps onto the cap of conventional fill valve, and FIG. 6A shows a mechanized water termination or interruption assembly in view of a conventional fill valve to which it is to be attached;

### Technical Description of the Fill Valve Failure-to-Terminate-Water-Flow when the Float Reaches its Preset Water Height Termination Point

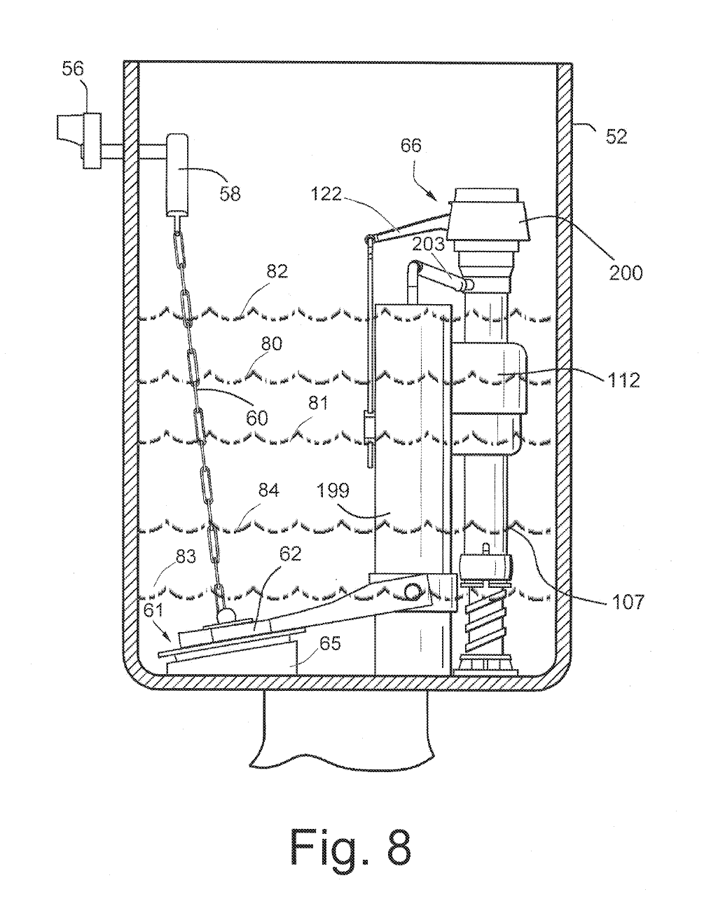

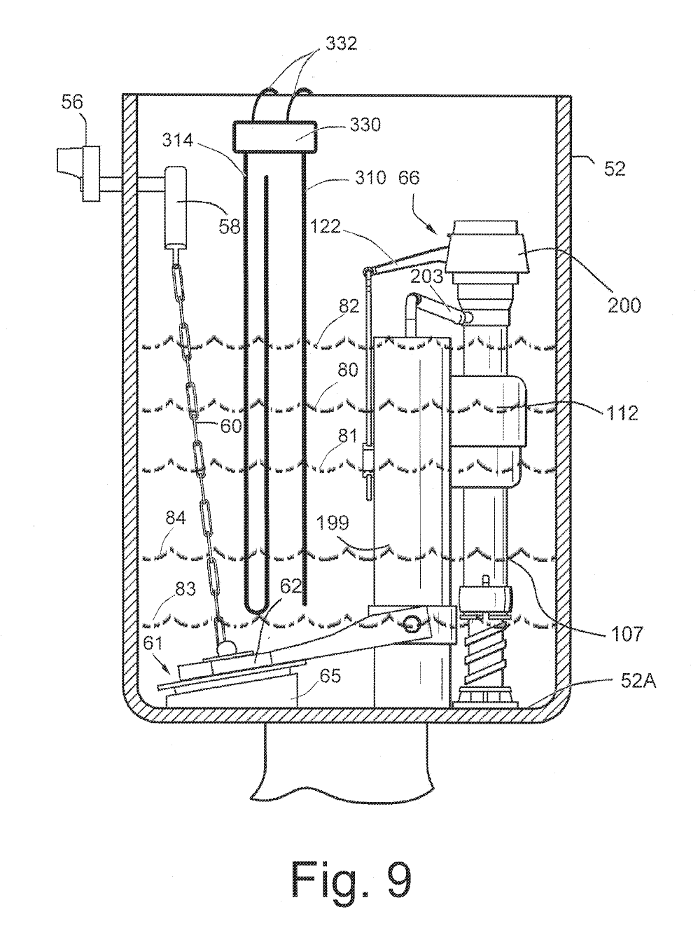

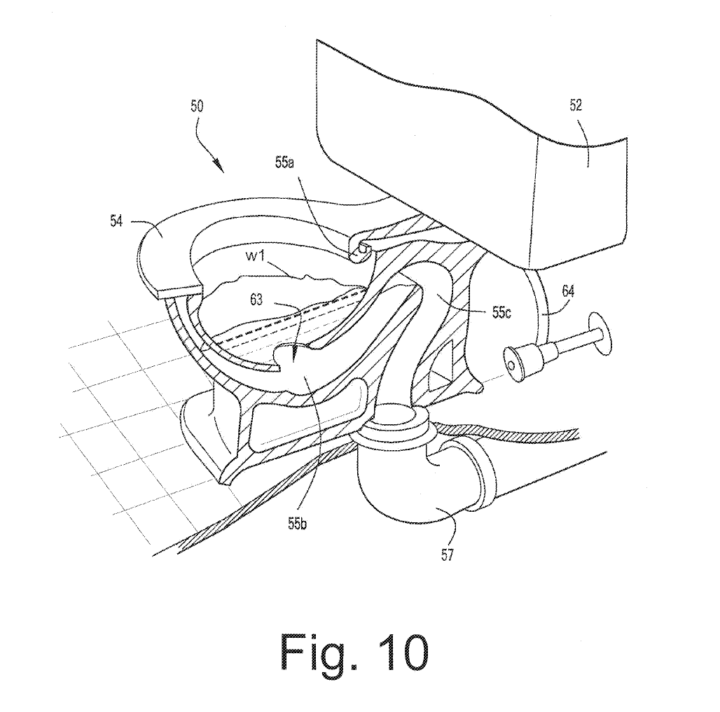

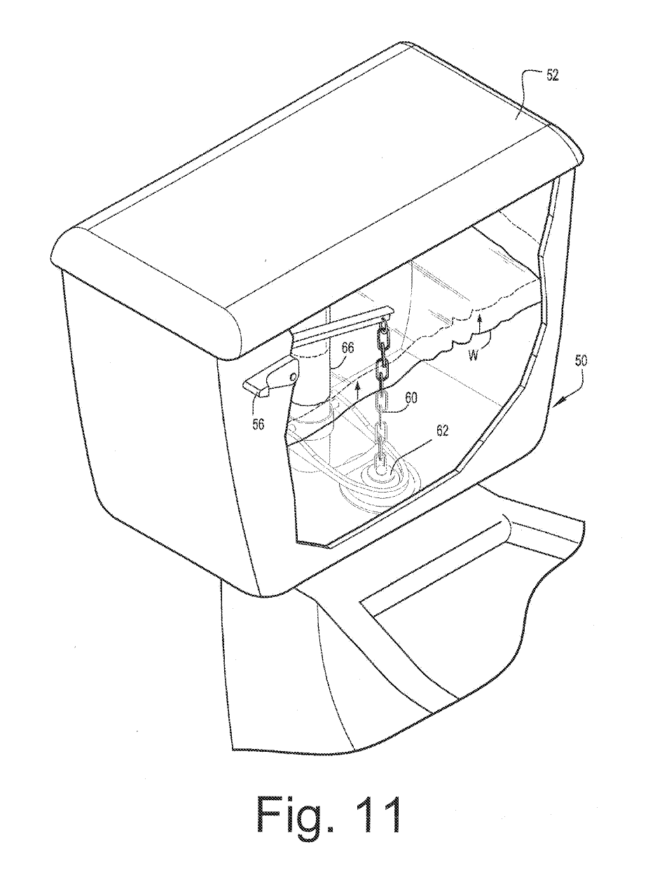

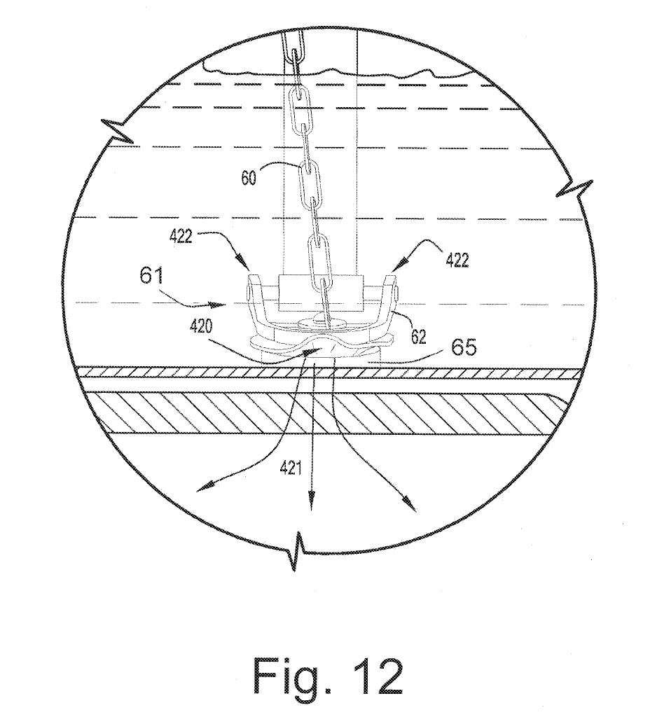

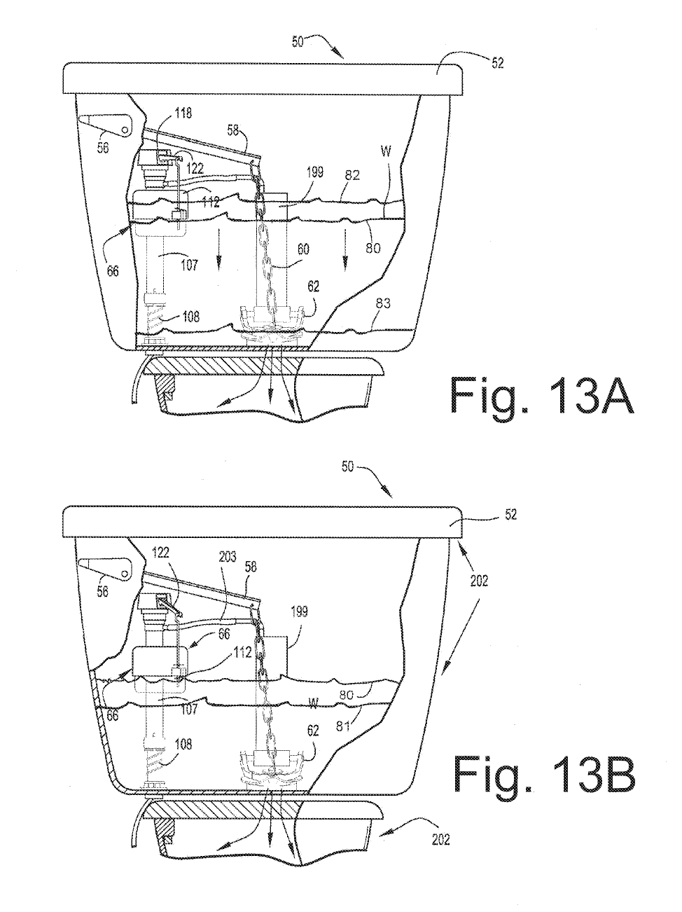

Fill valves can also fail to terminate the water flow after float 112 has risen to its maximum mechanical height at the conclusion of a flush cycle, causing the water to rise to the height of overflow tube 199 and drain into the bowl. This type of failure is referred to herein as a Fill Valve Termination Failure. FIG. 13A (see also FIG. 8 and FIG. 9) shows a typical toilet tank cross-section with various water heights corresponding to different toilet tank and component operation, as well as various water heights corresponding to different types of failures. After a flush cycle has completed, float 112 on fill valve 66 has risen to valve-turn-off water level 80 and should terminate or turn-off any additional water flow through fill valve 66 and cease filling tank 52. But when fill valve 66 exhibits a fill valve termination failure, water continues to seep or bleed into tank 52 through water exit ports 123 (FIG. 5) and siphon tube 203, resulting in the water rising in tank 52 to the overfill-water-level 82, which results in water continuously escaping into bowl 54 via overflow tube 199. Extensive testing has shown that once a fill valve begins to exhibit this type of failure, the volume rate of the leak tends to increase significantly over a relatively short period of time. As will be described and explained shortly, the toilet monitoring and intelligent control system described herein easily detects this type of failure.

### Technical Description of a Fill Valve Equilibrium Failure

When the flapper or flush valve is leaking (as is more fully described in detail in the next section, “EXEMPLARY PRIOR ART FLUSH VALVE DESIGN, OPERATION, AND FAILURE MODES”), tank 52's water level will drop. When the fill valve float 112 drops to valve-turn-on water level 81 as shown in FIG. 13B, a properly functioning fill valve 66 will turn on and refill tank 52 to valve-turn-off water level 80. This type of tank refill is often referred to as a “phantom flush”, and can often be audibly heard nearby as Canfield et al describes in detail in U.S. Pat. No. 8,310,369. But when float 112 of an inferior quality or worn fill valve drops to valve-turn-on water level 81 and does not fully open to fully refill tank 52 to valve-turn-off water level 80, but instead “bleeds” or “seeps” water into the tank at the same rate as the flapper or flush valve leak, this type of fill valve failure is referred to herein as an “Equilibrium Failure”. Equilibrium failure of the fill valve simply means that the water flowing into the fill valve is at the same rate as the water exiting tank 52 into the bowl through the leaking flapper or flush valve. Although the fill valve manufacturers might argue that the leak is the problem (not the fill valve), this overlooks several associated problems.

The first problem overlooked is that the fill valve equilibrium failure also allows water to bleed into siphon tube 203, which then dumps into overflow tube 199 and down into bowl 54. Extensive measurements of various types of fill valves exhibiting equilibrium demonstrate that the siphon tube 203 additional flow is approximately 30% of the volume leaking through flush valve 61. For example, for every 10 gallons of water that leak through the flush valve, an additional 3 gallons are additionally wasted through the siphon tube 103.

The second problem overlooked is that the audible “phantom flush” of the fill valve 66 refill does not occur. The absence of an audible “phantom flush” is simply one more reason why so many toilet leaks go undetected.

A third problem associated with equilibrium failure is that extensive testing has shown that once a fill valve exhibits this type of failure, the fill valve is likely to also begin exhibiting termination failures, as was previously described. This compounded problem has often led to home and business owners replacing flapper 62 to solve the toilet leak problem, which thereby prevents fill valve equilibrium failure, only to have the fill valve exhibit termination failure, which results in continued unintentional water loss that often goes undetected.

Fill valve “Equilibrium Failures” are widely overlooked, but represent a growing problem that needs to be addressed. As will be described and explained shortly, the toilet monitoring and intelligent control system described herein easily detects this type of failure.

### Exemplary Prior Art Flush Valve Design, Operation, and Failure Modes

FIGS. 2 and 3 show flush valve assembly 61 in both the closed and open positions, respectively. When a user-initiated flush occurs, flush handle 56 is pressed downward, raising lever 58 upward, which raises chain 60, which in turn raises flapper 62 off of flush valve seat 65. Water W begins to escape out of tank 52 through flush valve 61 and into bowl 54 while flapper 62, which has positive buoyancy, remains open until water W drops to flapper-close water level 83, at which time flapper 62 closes and effectively seats and seals flush valve seat 65, thereby stopping the flow of water from tank 52 into bowl 54. As has been previously explained, fill valve 66 is open and filling tank 52 with water W which continues to rise until the valve-turn-off water level 80 is reached, at which time float 112 turns off the fill valve 66 water flow. A properly working flush valve 61 will completely seal and prevent water flow from tank 52 to bowl 54 when flapper 62 is seated upon flush valve seat 65.

### Technical Description of Leaking Flush Valves and Flappers

Flapper 62 can fail to completely seat and seal flush valve seat 65, causing a leak from tank 52 into bowl 54. To best describe this type of leak, assume that toilet 50 has just completed an entire flush cycle, as has been previously and fully detailed herein. Referring to FIG. 8, Water W is now at valve-turn-off water level 80, which has raised float 112 and lever 122, causing fill valve 66 to terminate water flow into tank 52. When flapper 62 is leaking tank 52 into bowl 54, Water W will slowly begin to drop inside tank 52. When Water W drops to valve-turn-on water level 81 and fill valve 66 is working correctly, float 112 and lever 122 cause fill valve 66 to turn on and refill tank 52, producing what was previously identified herein as a “phantom flush”. If fill valve 66 is not functioning properly and instead exhibits an equilibrium failure, water will bleed into tank 52 at the same rate as it enters fluid fill line 64, while also producing additional flow through siphon tube 203, which drains into overflow tube 199 and then into bowl 54, as was previously described in detail. Those with a background in toilet leaks will also recognize that other types of toilet tank leaks can occur, such as the deterioration of the bolts and sealing washers which attach tank 52 to bowl 54, deterioration of the flush valve seat 65 or the sealing gasket below it, etc.

### Technical Description of a Wide-Open Flush Valve and the Numerous, Often Misunderstood, and Previously Unknown Reasons why they Occur

Now suppose that flapper 62 becomes stuck in an open position or is misaligned or otherwise does not seal properly. The fill valve 66 may never fill the toilet tank 52 with sufficient water to raise float 112 to an upper position. Instead, all water that fill valve 66 delivers into toilet tank 52 might be immediately (or soon) exhausted through the passage between the tank 52 and bowl 54 that flapper 62 is designed to seal under normal non-flushing conditions.

If the water that fill valve 66 is delivering into tank 52 escapes into the toilet bowl 54, the water level within tank 52 may never rise and float 112 will similarly remain in a lower position and the toilet will continuously “run.” Water will continue to flow through fill valve 66 through the toilet into the waste line 57 as long as flapper 62 remains open. This “running” condition can persist until a user takes corrective action to cause flapper 62 to close and seal. Even though fill valve 66 in this situation is operating exactly as it was designed to operate, toilet 50 is seriously malfunctioning and wasting huge amounts of water. During periods or in regions of water shortage or drought, this water waste can be a real problem. In a house with its own well, the owner of toilet 50 may potentially pump his or her well dry. If the house is connected to city water, the owner may receive a huge water bill for water that flows through the toilet and is wasted. In communities such as those located alongside rivers or water basins where water waste is stored in portable in-ground septic tanks to avoid contamination, a “running” toilet can overflow a tank, causing water damage while simultaneously draining into the nearby drinking water supply that the in-ground tank was supposed to protect. Adding insult to injury, this type of “running” toilet often goes undetected.

The development of this toilet monitoring and intelligent control system resulted in wide-open flush valve data being secured that has been previously unknown to water agencies and professionals. While there is certainly an awareness about the problem of wide-open flush valves, the extent of the water loss and the number of reasons why the flush valve won't close, and why this condition often goes undetected, has been understated and mostly misunderstood.

Referencing FIGS. 1, 2, 2A, and 3, the following is a short list of the main reasons why a flush valve or flapper won't close:

The extended portion of flapper hinge 422 on flapper 62 is stuck to overflow tube 199;

Chain 60 gets hung up or caught on, or around, lever 58 or flapper 62, which most frequently occurs when flush handle 56 is impatiently slapped or banged, or when chain 60's length has been improperly set during installation or flapper 62 replacement;

Any obstruction of siphon jet 55b, waste pipe 57, or exhaust port 53, can result in the tank water not dropping low enough to permit flapper 62 to close;

A purchased “Universal Flapper” to replace flapper 62 does not properly seat on flush valve 61, resulting in a significant gap which results in excessive water flow into bowl 54;

Flush handle 56 sticks or rubs against tank 52, preventing flapper 62 from seating on flush valve 61;

Flapper hinges 422 are weakened or degraded, allowing flapper 62 excessive side-to-side movement that occurs when water W from water exit ports 123 of fill valve 66 “push” flapper 62 during the flush cycle, preventing proper seating of flapper 62 on flush valve 61.

So much for the primary causes of wide-open flush valves. The following is a partial list of why wide-open flush valves often go undetected:

Using the toilet is often the last thing a person does before leaving the apartment or home, and when the departure is for a lengthy vacation or long weekend, the water loss can be tens of thousands of gallons (and when that person is in a hurry, the handle is often “slapped, as was previously mentioned);

Seldom used bathrooms, such as those in a basement or in a remote area of a dwelling, can have wide-open flush valves go undetected for extensive periods of time;

Hearing-impaired, sensory-challenged, and those completely unaware of how a toilet is supposed to work, for whatever reason, frequently fail to detect wide-open flush valves;

An individual exiting the bathroom during an impending overflow of bowl 54 is unlikely to detect an audible abnormality when the characteristic audible “whoosh” that is often exhibited by a wide-open flush valve does not occur, despite the flush valve being wide-open, because the entire flapper 62 and flush valve 61 are completely submerged by water W, resulting in a comparatively quiet escape of water into bowl 54;

Background noise, such bathroom and window fans, running sinks and tub faucets, hair dryers, music, loud conversation, televisions, yelling at children (just kidding—that never happens), yelling children (that always happens!), etc., can easily mask what might normally be an audible indication that the flush valve is wide-open.

As will be described and explained shortly, this type of toilet problem is readily detected by the toilet monitoring and intelligent control system described herein.

### Technical Description of Clogged or Blocked Toilets that can Result in Bowl Overflows

Consider now the situation shown in FIG. 3 where the toilet bowl 54 is clogged or waste pipe 57 is blocked. If the flapper 62 fails to close, the overflow can occur within seconds and, as will be described shortly herein, there is a reason why flapper 62 may fail to close during a single user-initiated flush. Suppose however that the flapper 62 closes as it is supposed to do when the tank 52 is emptied when there is a clog or blockage preventing bowl 54 evacuation. This situation will allow water flowing through fill valve 66 to begin filling tank 52. If fill valve 66 operates normally, it will continue to fill the tank 52 until float 112 has risen sufficiently to close the fill valve. Now the toilet tank 52 is full of water and the toilet is ready to flush once again. Unfortunately, in this instance bowl 52 is also now full of water. Any additional water delivered into the bowl cannot escape through waste pipe 57 due to the blockage 63. Another flush (i.e., by depressing the flush handle 56) will nevertheless once again open flapper 62 and cause the water within tank 52 to be expelled into the already-full bowl 54. This can cause an overflow of bowl 54, as shown in FIG. 4. Referring to FIG. 8, the overflow occurs even though fill valve 66 is operating normally and functioning exactly as intended because the water height in clogged toilet bowl 54 is preventing water W in tank 52 from rapidly evacuating, resulting in example water height 81 preventing positive buoyancy flapper 62 from closing. Simply stated, toilet overflows generally occur when the water volume entering the tank through fill valve 66 exceeds the water exiting through exhaust port 63, which prevents flapper 62 from closing because the water level W in tank 52 forces flapper 62 to float instead of closing and sealing off flush valve seat 65. As will be described and explained shortly, this type of toilet problem is readily detected by the toilet monitoring and intelligent control system described herein

### Summary of Reasons and Purpose of Example Non-Limiting Embodiments

It can thus be seen that the intentional and unintentional operation of fill valve 66, or problems associated with flush valve 61 and flapper 62, can sometimes cause unintentional water loss or damage. The cost-effective immediate detection of unintentional water loss and damage, and when possible, the prevention of the same, is the primary focus of this toilet monitoring and intelligent control system. Another feature of this same system is to optimize and reduce the total intentional water usage by monitoring actual toilet use and responsively controlling the refill of the tank such as to actively limit the water volume per flush.

### Brief General Discussion, Descriptions, and Analysis of Various Prior Art Leak and Damage Detection and Prevention Methods and Devices

Many of the devices are too costly to put into production and then sell into existing markets. For example, a home owner will not spend $50 or more on a product and then another $100 for a plumber to install the product.

Many of the devices are too complicated to easily attach to a toilet. Product complexity produces disinterest in the marketplace because retailers and customers cannot be convinced of the effectiveness of the product, and complexity fosters the perception that the individual may not be knowledgeable enough to install and/or use the product. Products which require plumbing expertise and the knowledgeable use of tools are primary detracting factors when the customer needs a simple solution.

For a product to be successful in the marketplace where millions of product and operational variations exist, a universal product that will work on any toilet, in any environment, is required. Much of the prior art assumes simplistic toilet structures and operation, while the actual number of toilet variations include a wide range of toilet tanks and water volume capacities, numerous types of fill valves and flush valves available from dozens of different manufacturers, variations in water pressure and drain pipe sizes, all of which determine the physics of water-in/water-out in all toilets, different and varying physical characteristics related to leaks and overflows, etc.

Aesthetics matter, so prior art which converts a common bathroom toilet into a Star Trek Klingon attack ship may be embraced by gadget freaks and bachelors who will never marry, but those “designs” are generally not favorably received by most home and business owners. Much of the prior art have mammoth valves on the water feed line, big boxes hanging onto the front or side of the toilet, and many even have unsightly wires around, inside, and on the outside surface of the toilet itself, including bowl sensors that are just downright ugly. Aesthetics is also a practical matter when it comes to cleanliness, as the ability to completely and easily clean the toilet surfaces and bowl is an important design consideration that is often overlooked by those who focus only on the problem, instead of the market and how users must necessarily interact—and in this case, clean—the product.

For the reasons stated above, the ideal device described herein is inexpensive, installs in seconds without tools, requires no calibration or set-up, does not compromise toilet aesthetics or present a barrier to cleanliness, yet absolutely identifies a multitude of toilet anomalies and problems and quickly alerts the user or property manager accordingly in order to prevent excessive water loss or damage, or automatically terminates water flow when the anomalies and problems are detected.

### Example Non-Limiting Monitor Device Embodiments

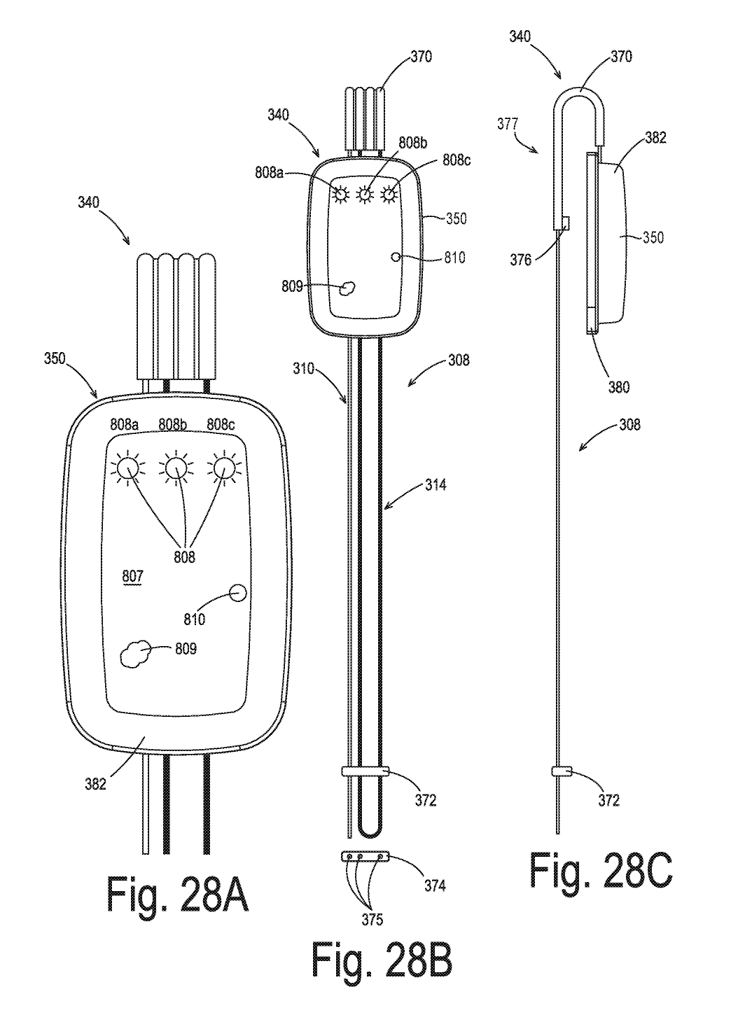

FIGS. 28A, 28B, 28C show an example non-limiting monitoring device 340. Monitoring device 340 includes an annunciator module 350 and a probe 308. As shown in FIG. 28A, annunciator module 350 provides a user interface 807. In one example implementation, user interface 807 may be relatively simple and low cost, consisting of indicator lights 808 and a push button 810. Additionally, an audible annunciator 809 (which may be within enclosure 350) provides audible output. Any number of indicators 808 may be used, and may comprise any technology including but not limited to light emitting diodes. Other example implementations could use different user interface technology such as a liquid crystal display or some other type of low powered display, more buttons or other input controls, a microphone, a speaker, a touch screen or touch panel, or a Bluetooth/Wi-Fi or other wireless interface to an external user interface device such as a Smartphone or IOT hub. The FIG. 28A embodiment user interface 807 is non-limiting, but is preferred for at least some applications that require minimal cost and power usage as well as simplicity of operation.

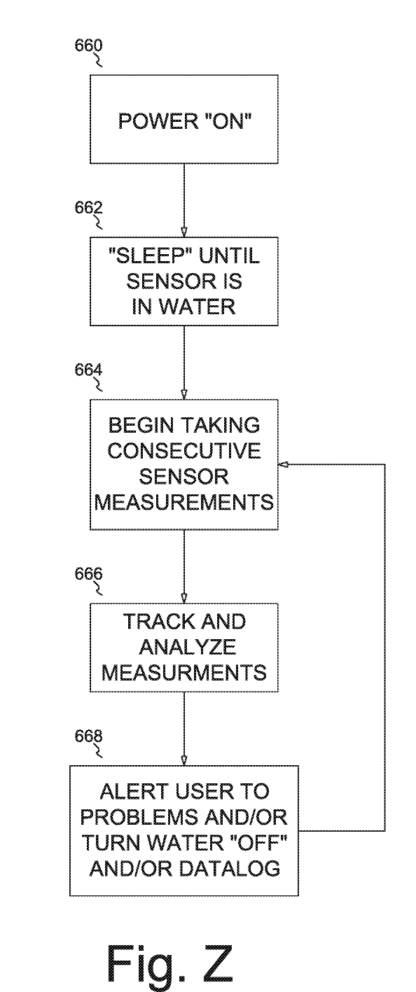

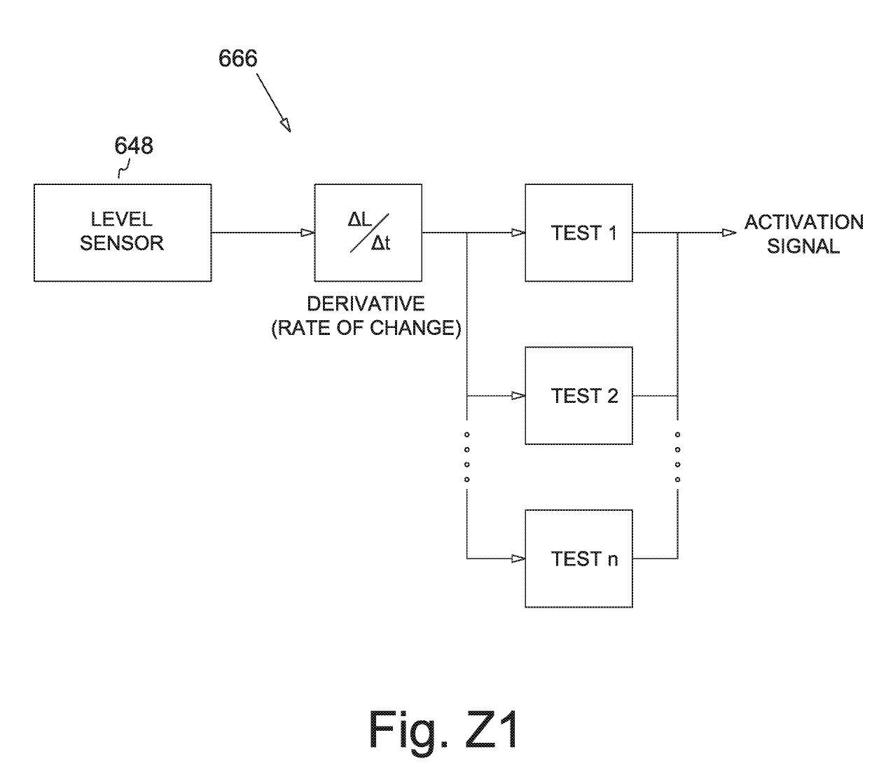

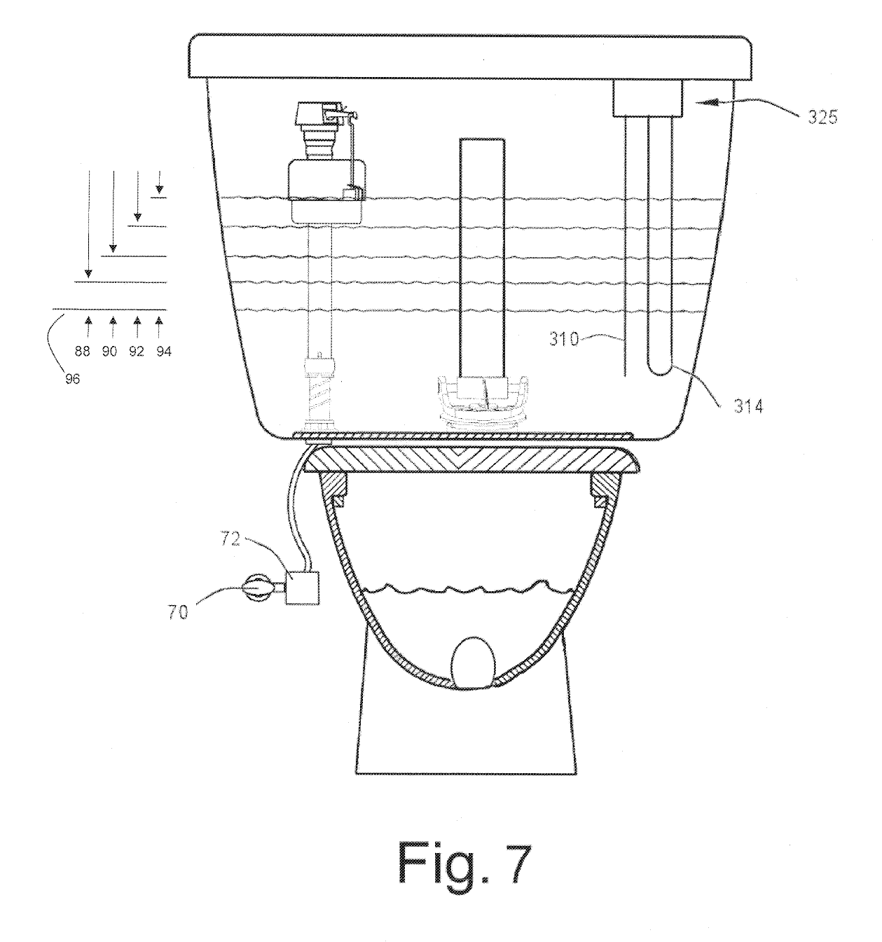

In the particular example shown (see also FIG. 7), a probe 308 is fixedly attached to annunciator module 350. In this example non-limiting implementation, probe 308 includes several conductors 310, 314 and a spacer 374. The conductors 310, 314 include an uninsulated conductor 310 and an insulated conductor 314. The uninsulated conductor 310 when immersed in the water of a toilet tank provides direct electrical current conduction path into the water. The amount of conduction depends on several factors including the mineral content of the water. The uninsulated conductor 310 and the surrounding water it is conductively connected to forms one plate of a two-plate capacitor. The other conductor 314 is insulated and is thus not electrically connected to the surrounding water in the toilet tank. This other conductor 314 acts as a second plate of the two-plate capacitor. The equivalent circuit to conductors 310, 314 is thus a 2-plate variable capacitor—with the capacitance between the two plates varying based on the level or height of the water into which the conductors are immersed as well as the mineral content, temperature and other characteristics of that water, and the length of at least the conductor 314. Since temperature and mineral content of the water in the toilet tank are relatively stable and do not change erratically, they can be ignored or compensated for when measuring the capacitance between the two plates.

An important factor that changes the capacitance between the two capacitor plates and the equivalent circuit is thus the water level or height. By measuring the capacitance, a highly accurate determination of water level or height is possible.

In the example shown in FIG. 28C, insulated conductor 314 comprises a loop or “U” that is insulated over its entire length. Spacing between the conductor 310 and the conductor 314 is constrained by a spacer 374 including holes 375 through which the conductors 310, 314 pass as shown. Spacer 374 can be made of any light-weight non-conductive material such as plastic. In other embodiments, conductor 314 could comprise a single non-looped conductor or have other configurations. Similarly, in other embodiments, conductors 310, 314 need not be parallel to one another over the entire lengths, nor would they need to be coextensive in length.

In the embodiment shown, the conductors 310, 314 are hard-wired into the annunciator module 350, exit the top of the annunciator module and are bent 90° at a bend 377. This bend 377 is used as a hanger to hang monitoring device 340 on the lip of a toilet tank with the annunciator module 350 external to the tank and the probe 308 hanging down within the tank. Other material insulating tubing 370 can be used to protect the portions of conductors 310, 314 that are in contact with the toilet tank lip and to also reduce transmitted vibration and allow compression of the rubber tubing when the toilet tank lid is in place. Such rubber tubing 370 thus allows the toilet tank lid to lock the monitoring device 340 in place so it does not move much in response to water turbulence within the tank. A bumper 376 may be provided to space the probe 308 away from the inside wall of the toilet tank, and spacer 372 similarly can be used to provide such spacing.

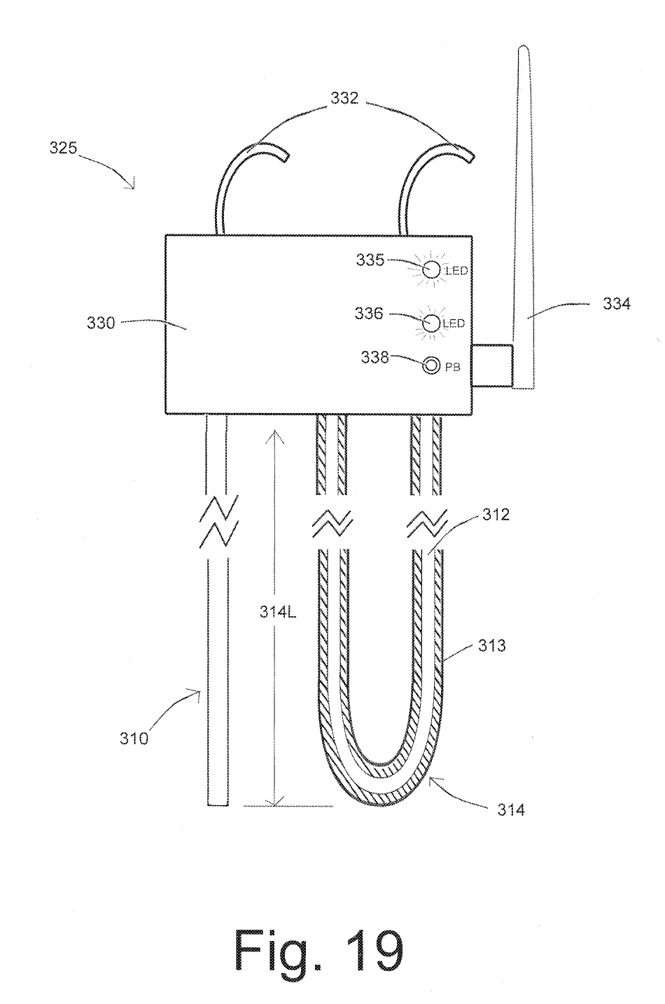

FIG. 19 shows an alternative embodiment in which a waterproof annunciator module 300 is configured to be disposed inside the toilet tank (some customers might not want to see the annunciator module). In this embodiment, the annunciator module 300 hangs from the toilet tank lip by hangers 332, and the conductors 310, 314 hangs downward from the module. The module 330 may be further equipped with a wireless communications capability (e.g., antenna 334) to wirelessly communicate with a monitoring network, LAN or the like via Wi-Fi, WAN, Bluetooth or any other convenient wireless technology. Such wireless communications enables module 330 to communicate alerts to a user, management office or other remote location without the need to remove the toilet tank lid. Such installations might find particular application in hotels, rental properties, or ordinary homes or businesses equipped with IOT (Internet of Things) hubs or Wi-Fi networks. In such applications, it might be useful also to equip device 330 with temperature measuring capabilities (e.g., to allow an absentee homeowner to detect toilet freezing conditions) and remote control capabilities (e.g., to turn off a water supply valve remotely).

FIGS. YA and YB show example high level schematic block diagrams for a monitoring device 340. In the FIG. YA non-limiting embodiment, a microcontroller 644 powered by a battery 640 receives measurement signals from a sensor 648 via an oscillator 646. The microcontroller 644 analyzes the received measurement signals and conditionally generates alerts 642 via a user interface. In the FIG. YB alternative embodiment, the oscillator 646 is omitted and microcontroller 644 directly interacts with sensor 648.

FIG. Z shows an example state diagram for the operation of the embodiments shown in FIGS. YA and YB. In the FIG. Z state diagram, a monitoring device 340 being powered on (state 660) enters into a sleep mode until the microcontroller 644 detects that the sensor 648 has been placed in water (state 662). In this particular embodiment, there is no power on and off switch. Rather, the power on state 660 is entered when the battery 640 is first connected to the monitoring device (e.g., at time of manufacture or in other embodiments, in the field). The microcontroller 644 occasionally wakes itself up and samples the measurement signal output by sensor 648 to detect whether the sensor has been placed in water. Once the measurement device 340 is awakened (state 664), it begins taking consecutive measurements and tracks and analyzes those measurements (state 666). It will alert the user to problems and/or turn the water off (in some embodiments) and/or log data (state 668). It performs such state transitions and functions continually, sleeping whenever possible to reduce the drain on battery power.

FIG. Z1 shows an example implementation of state 666 in one non-limiting implementation. In the FIG. Z1 example, the level sensor 648 produces a measurement signal that the microcontroller 644 analyzes by calculating rate of change (i.e., derivative) ΔL/ΔT. The derived rate of change signal is then tested using n tests, with different tests or combinations of tests generating an activation signal.

### Brief Explanation of Water Level Sensing Methods in View of the Various Types of Toilet Leaks and Failures

As will be explained shortly, in order to identify virtually any type of toilet anomaly or failure related to water flow using only a single in-tank sensor, or to precisely and automatically implement water conservation operation without user interaction or device calibration, real-time monitoring and tracking of water height W in tank 52 with a very high degree of accuracy, at a reasonably high sampling rate, is required. Before explaining the novel device and method embodied herein, a brief review of some prior art water and fluid height measurement methods is necessary.

A lot of prior art has been devoted to the sensing of water at specific levels in both toilet tanks and bowls. From limit switches and floatation switches to magnetic sensors and conductivity switches, just about everything has been tried and, to-date, all of it without much commercial success or market acceptance.

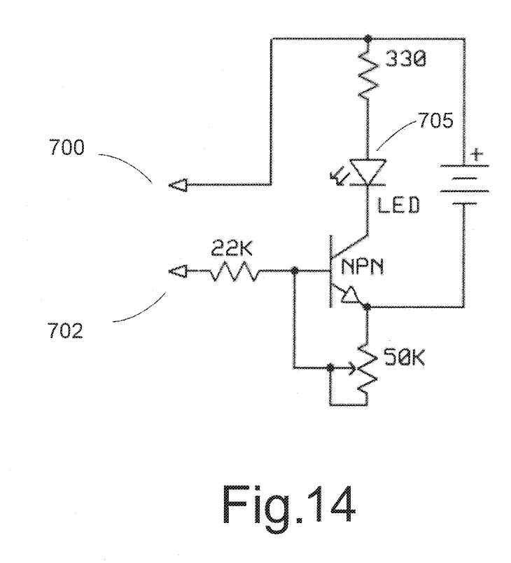

Perhaps the least expensive and ultimately most reliable type of fixed-position water level switch is the electrical conductivity switch. FIG. 14 shows a simple transistor-based circuit that turns on LED 705 when probes 700 and 702 both make contact with water. In this circuit, the NPN transistor turns on when the circuit detects conductivity between probes 700, 702, activating LED 705.

While in theory a reasonable system capable of detecting various toilet problems could be made from multiple electrical conductivity switches, the number of switches required in both the toilet tank and the bowl, plus the necessary calibration and mounting of the switches, has been and will continue to be prohibitive in nature. Not to mention the rats nest of wires in and around the toilet. Single electrical conductivity sensors and switches are also incapable of determining the direction of water height (tank evacuation verses tank fill), as well as any time or slope-dependent measurements. While various resistive ladder-type electrical conductivity sensors and switches have been proposed, they lack accuracy, are cost-prohibitive, and are also cumbersome, making them impractical for toilet water height sensing. Resistive and potentiometer-type sensors also tend to drift substantially as liquid temperatures change, and it is not unusual for the pre-flush water temperature of a toilet tank to be substantially warmer or colder than the post-flush refilled tank temperature, resulting in measurement inaccuracies over a very short time duration which, for the purpose of discerning anomalies corresponding to changes in water height, could lead to numerous false positives or the inability to detect the anomalies and problems.

### Exemplary Prior Art Pressure-Based Sensing of Water Levels

Pressure sensors and transducers have long been used for water level and water height measurements. From a practical perspective, however, the sensors and transducers have been too costly to be practically considered for use in toilet tanks and bowls. In most instances, a pressure sensor or transducer is connected to an air tube that is submerged completely into the toilet tank or bowl. As the water height changes, the pressure in the tube changes.

### Exemplary Prior Art Capacitive Fluid Level Sensing Circuits and Methods

For practical and safety reasons, most devices attached to or inserted within a toilet will likely be powered by a battery, making conservation of power and battery life an important design consideration. Unlike pressure sensors which can consume substantial power, conductive and capacitive sensors require relatively little power to operate. And while the disadvantages of conductive, resistive, and potentiometer-type sensors have already been discussed, capacitive water height sensors could offer specific advantages if obstacles can be overcome in their design and methodology of use, such as the new and novel features described herein. Unfortunately, for a capacitive water height sensor to detect toilet anomalies, accuracy and high resolution are required.

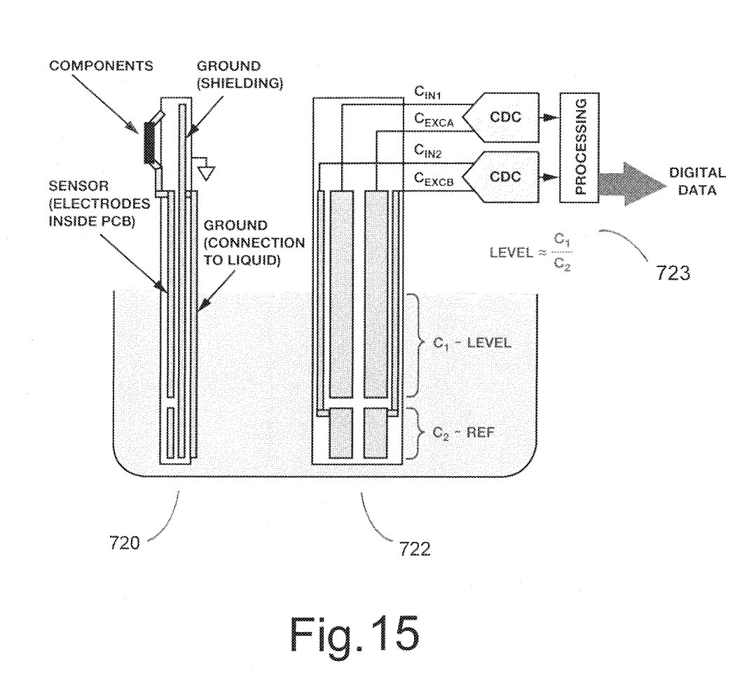

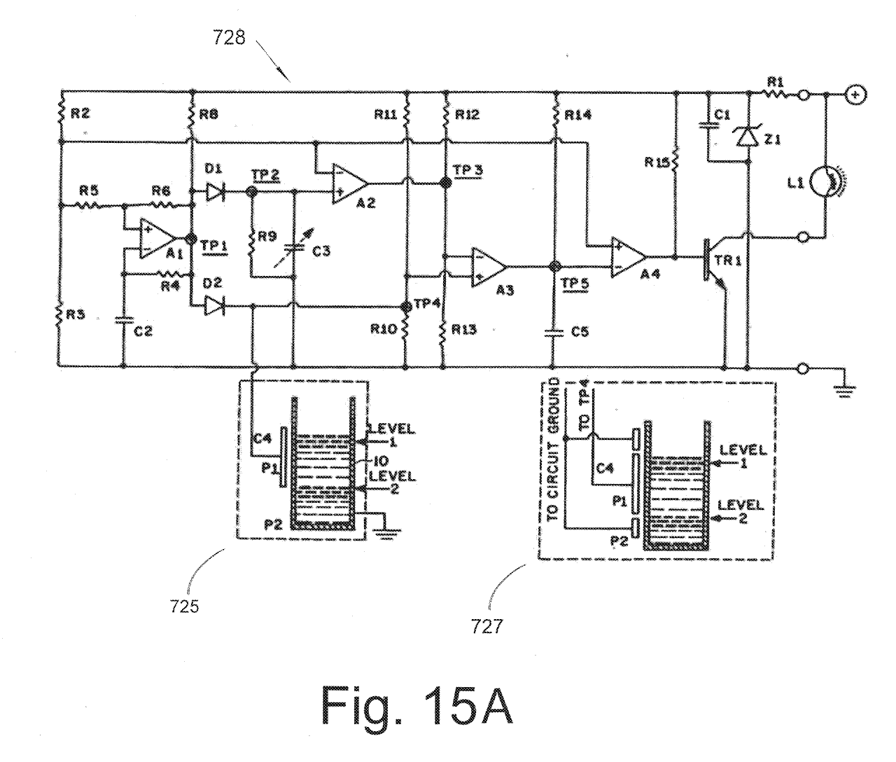

Some well-known accurate and high resolution capacitive liquid level and height sensors are shown on FIGS. 15 and 15A. Printed circuit board sensor 720 is a side view of the front view of PCB sensor 722, which is a 4-layer printed circuit board where the non-conductive layers act as dielectrics and the conductive layers form the plates of the capacitive, with the outer-most plate directly contacting the liquid. The capacitance-to-digital converter 723 is connected to reference sensor C2 and level measurement sensor C1, and the water level is then determined by the relationship of C1/C2. This circuit is accurate and exhibits very high measurement resolution, while also being impractical for mass production and deployment due to the prohibitive cost of manufacturing as the capacitance-to-digital converter 723 is an Analog Devices AD7746, which alone costs more than $8.00 in high quantities.

FIG. 15 shows the operational circuit diagram of a commercially available type of capacitive fluid level sensor.

The well-known circuit of the type shown in FIG. 15A can use two different types of sensor configurations, but does not require direct contact with the liquid to be measured. Sensor 725 and sensor 727 both show plates P1 and P2 as being positioned on the outside of a non-conductive liquid container wall. Circuit 728 is essentially a square wave oscillator formed by resistors R4, R5, R6, and capacitor C2. The varying capacitance of sensor 725 or sensor 727 corresponds to a change in the liquid level inside the container, resulting in a frequency change at the output of operational amplifier A1 at test point TP1. Although circuit 728 is configured to illuminate lamp L1 when a specific liquid level occurs within the container, it is obvious that the varying square wave output of operational amplifier A1 could be directly resolved such as to indicate the liquid level inside the container.

These prior art capacitive sensors could be used for toilet tank water height measurements, except that they are prohibitively expensive to manufacture, even in large quantities, and often require some sort of calibration or, as is shown in FIGS. 15 and 15A, require a separate “fixed plate” calibration sensor to ensure accuracy and repeatability as the temperature, conductivity, presence and concentration of contaminants, and other factors related to the water changes. The aforementioned capacitive sensors still tend to require too much power for battery operation, removing them from consideration in view of consumer and/or mass-produced products. For instance, the quiescent current of the Analog Devices AD7746 capacitance-to-digital converter 723 is approximately 750 microamperes, which would preclude the use an ideal battery such as the CR2032 lithium cell that is widely available and perfect for consumer products as its maximum power delivery is limited to approximately 220 milliampere-hours.

### Detailed Description of Cost-Effective Circuits that Convert Capacitance to Square Waves and/or Pulses

Because cost, performance, ease-of-installation, simplicity-of-use, reliability, and maintenance-free are the most important factors to consider if the goal is to equip millions of toilets with a high quality water conservation and damage prevention product, extra attention must be paid to the important parameters of battery life and circuit operation, both of which read on all of the other factors. The sensor and circuit must therefore draw very little power, permitting low cost and readily available batteries to last for several years, or longer. The sensor itself must be extremely reliable, very accurate, repeatable over an extended period of time, resistant to degradation and corrosion, and yet still be inexpensively manufactured.

Before describing the novel capacitive sensor, circuitry, and method, some attention must be given to the types of circuits which could make use of such a sensor, and the type of output ideally desired from those circuits. In order to use a low cost microcontroller as the foundational component in a toilet monitoring and intelligent control system, the most advantageous outputs of a capacitive sensor circuit would ideally be either an analog voltage or square wave, both of which would vary as a function of capacitance. While analog-to-digital (ND) converters are widely available in many microcontrollers, it is more practical and cost-effective to measure the time periods of square waves using low-cost microcontrollers.

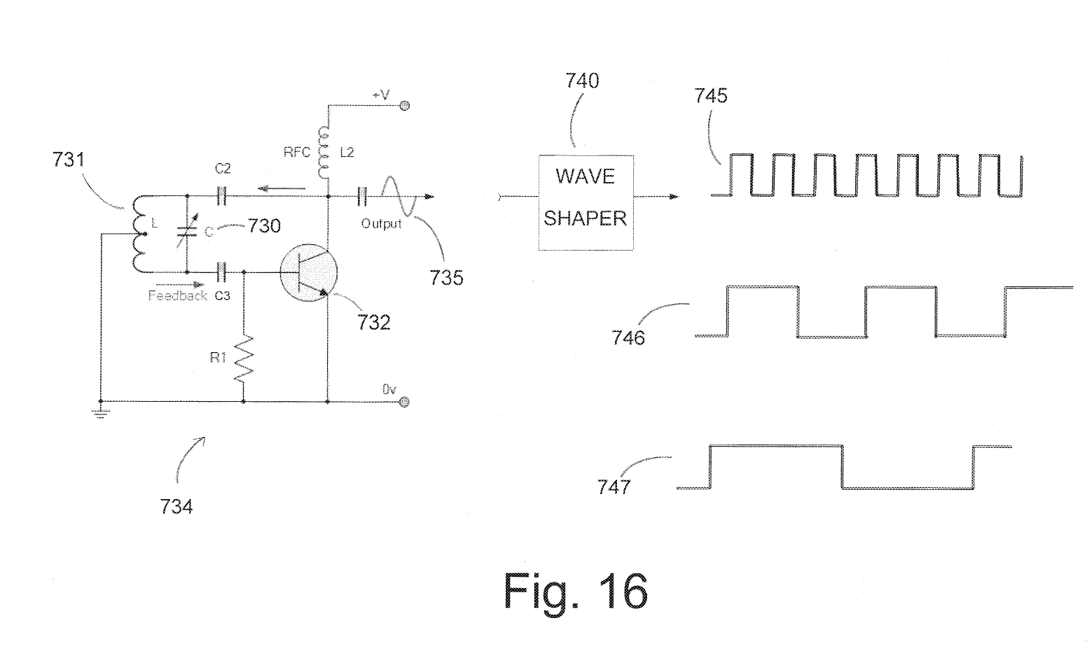

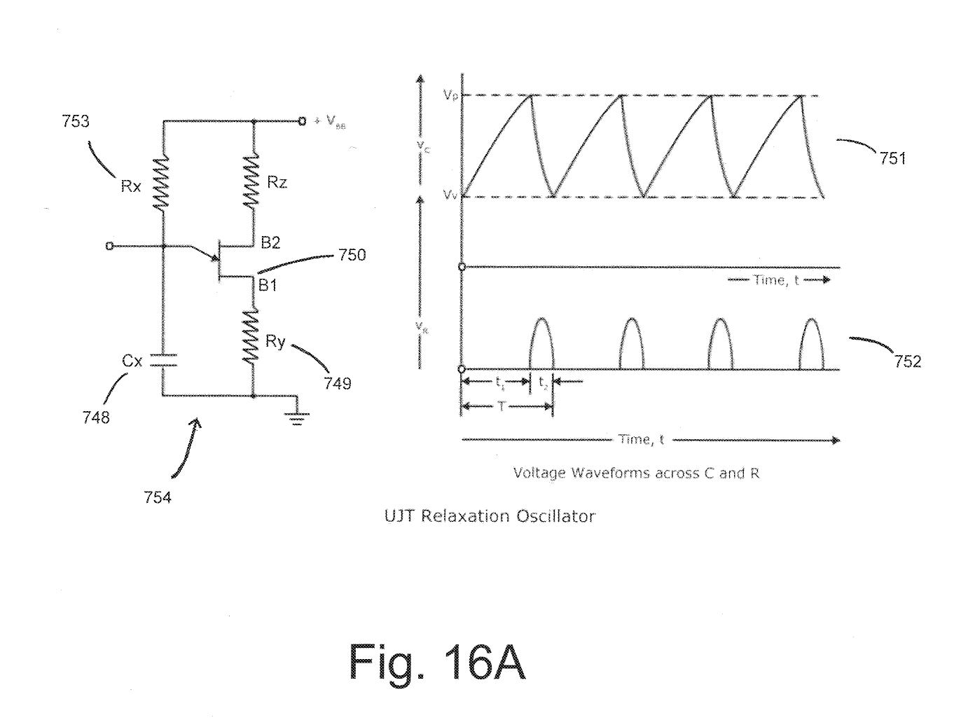

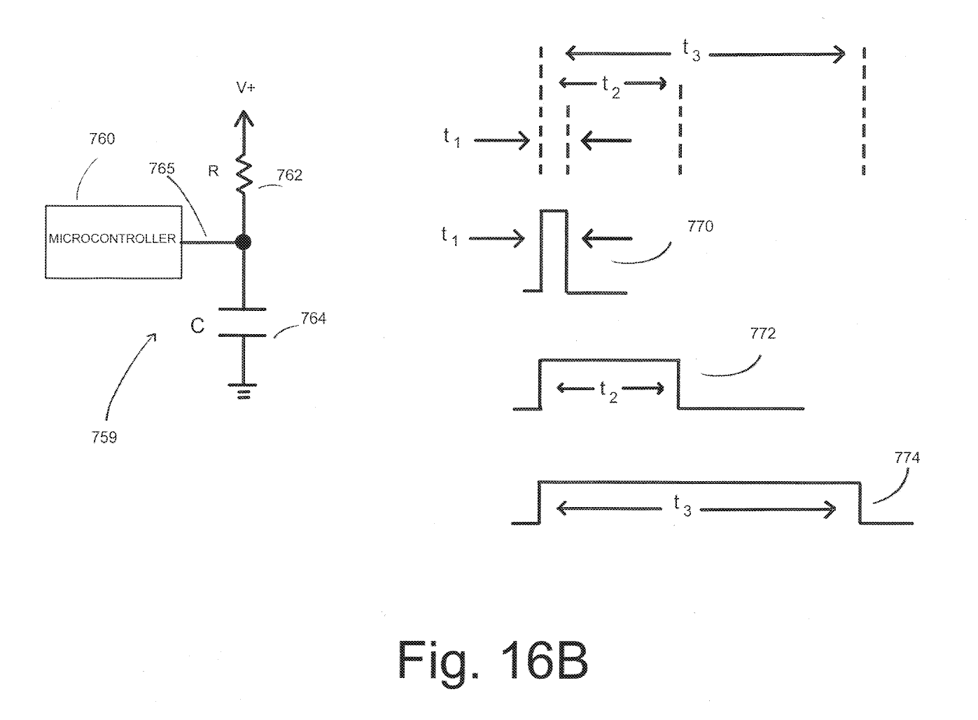

FIGS. 16, 16A, and 16B, show three different example circuits that convert capacitance to measurable square waves or pulse widths. FIG. 16 is the classic and well-known Hartley oscillator 734 which those skilled in the art will immediately recognize, the frequency output of which is characterized by this equation:

$$f = \frac{1}{2 π \sqrt{{L}_{T} C}}$$

where L_{T} is either the inductance of inductor 731, or the total cumulatively coupled inductance if multiple coils are used, which would also include their mutual inductance. Assuming all other components remain fixed, the value of variable capacitor 730 would determine the frequency of sine wave 735, which when directed to wave shaper 740 results in square wave 745 being generated. Square waves 746 and 747 reflect the change in frequency of sine wave 735 due to the increase in capacitance of variable capacitor 730, as initially compared to square wave 745. Summarily, the output frequency of wave shaper 740 varies with respect to the change in capacitance of capacitor 730.

FIG. 16A is shows UJT relaxation oscillator 754, also known as a unijunction transistor relaxation oscillator. Resistor 753 and capacitor 748 determine the frequency of oscillation, the equation of which is usually given as: F=1/(RC ln(1/(1−η)), where η is the intrinsic standoff ratio and ln stand for natural logarithm. When power is applied, capacitor 748 starts charging through resistor 753. Capacitor 748 keeps on charging until the voltage across it becomes equal to 0.7V plus ηVbb. This voltage is the peak voltage point Vp denoted in capacitor voltage waveform 751. After this point the unijunction transistor 750 emitter resistance drops drastically and capacitor 748 starts discharging through this path. When capacitor 748 is discharged to the valley point voltage Vv in capacitor voltage waveform 751 the unijunction transistor 751 emitter resistance climbs again and capacitor 748 starts charging. This cycle repeats and results as the sawtooth waveform shown in capacitor voltage waveform 751. Either base B1 or B2 of unijunction transistor 750 could then be directed to wave shaper 740, resulting in similar square waves as shown in 745, 746, and 747 in FIG. 16, as a function of the varying capacitance of capacitor 748 which, as should be noted, could be the novel capacitive sensor that will be described momentarily below.

FIG. 16B shows another very simple approach to resolving the capacitance of any given capacitor or capacitive sensor. Circuit 759 consists of microcontroller 760, resistor 762, and capacitor 764. Microcontroller 760 briefly takes port 765 low, or to ground, in order to fully discharge capacitor 764. Port 765 is then made an input, at which time an internal timer begins counting in microcontroller 760. With a high impedance now on port 765, capacitor 764 begins to charge through resistor 762. When the voltage across capacitor 764 crosses the input threshold of port 765 such as to force a transition from low to high, the internal timer of microcontroller 760 is stopped. The capacitance of capacitor 764 can thus be measured in terms of elapsed time. Replacing capacitor 764 with a variable capacitor, such as the novel capacitive sensor described shortly herein, it can then be seen that the variable pulse widths 770, 772, and 774, are responsive to the change in said variable capacitor. This method of measurement, as performed by microcontroller 760, can therefore be repeated as often as possible, in precisely timed intervals, in order to determine the value of the varying capacitance as a function of time.

At first glance, it would seem that FIG. 16B would offer the least expensive method for simple capacitive sensor water height measurement. But as will soon be described, in order to detect a wide variety of toilet-related problems as a function of the change of toilet tank water height, a high degree of resolution and measurement accuracy is necessary. For the circuit and method of FIG. 16B to be practical, the plates of capacitor 764 would have to be substantially large in order to produce distinguishably different pulse width resolutions relative to minute changes in water height, as a crucial determining factor is the microcontroller's clock speed, which establishes pulse width resolution. Microcontroller current consumption also increases with the clock speed, which reduces battery life. Another consideration is the overall capacitive sensor stability, which generally decreases as the plate surface area increases.

### Detailed Description of the Novel Capacitive Toilet Tank Fluid Level Sensor and Accompanying Circuitry

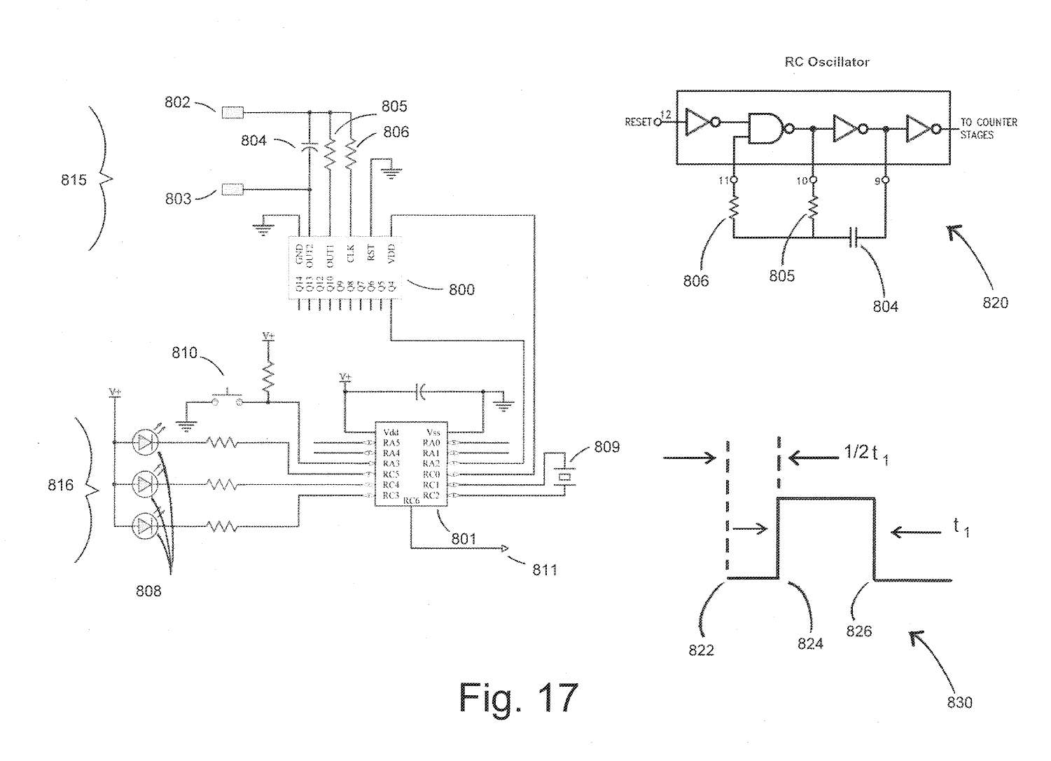

(4060 Description & Operation) The oscillator/divider circuit 815 shown in FIG. 17 shows an ideal low power approach and exhibits both a high degree of measurement accuracy with a physically small capacitive water height or fluid level sensor. Binary counter/oscillator IC 800 can be any of several conventional integrated circuits, like the CD4060 from Texas Instruments. RC oscillator circuit 820 is the exploded oscillator view of binary counter/oscillator IC 800, which shows that capacitor 804 and resistors 805 and 806 set the fundamental oscillator frequency, which binary/divider oscillator IC 800 divides down to lower frequencies that are available on the various ports of IC 800. To change the fundament oscillator frequency of oscillator/divider circuit 815, an additional fixed or variable capacitance can be paralleled with capacitor 804, as will be expanded upon below. To keep the current burden of oscillator/divider circuit 815 as low as possible, resistors 805 and 806 are necessarily in the order of megohms. To ensure stability over temperature and time, resistors 805 and 806, and capacitor 804, are 1% tolerance or less, with very low temperature coefficients. The inexpensive CD4060 from Texas Instruments, when used as binary/divider oscillator IC 800, exhibits very little drift with respect to supply voltage, negating the need for a voltage regulator on battery operated circuits.

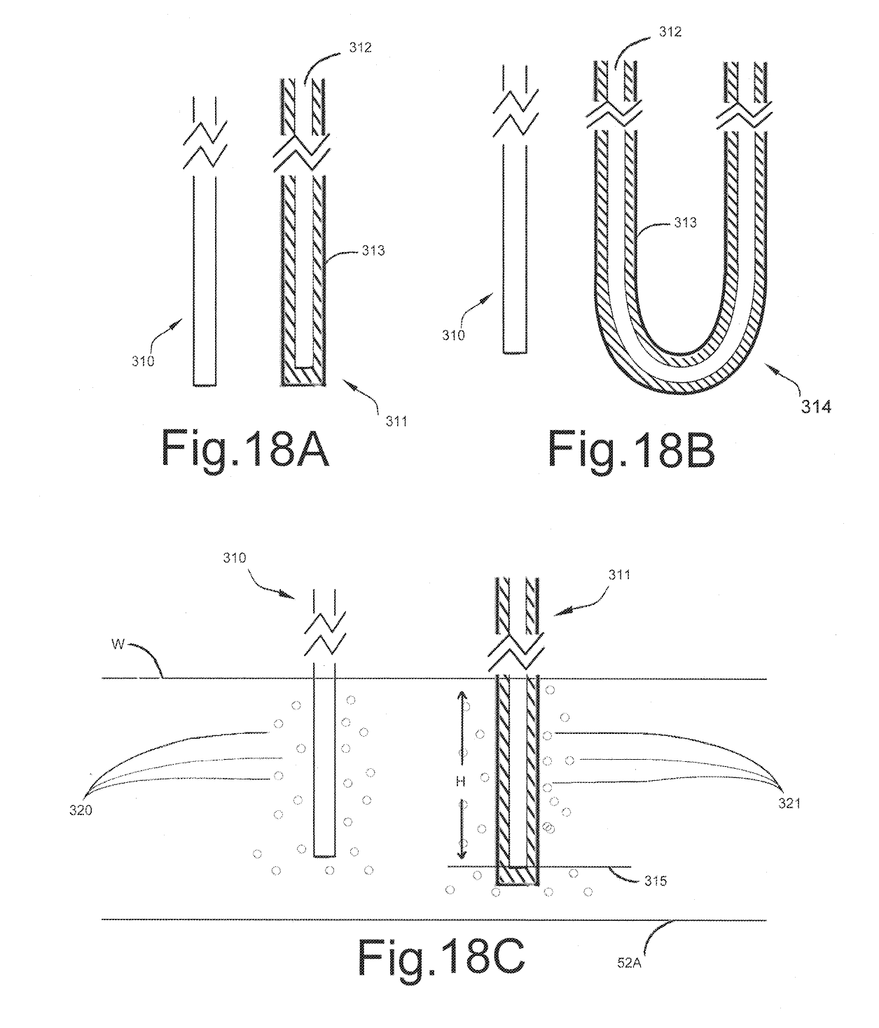

(Sensor Description) FIG. 18A shows the basic mechanical and electrical construction of the novel capacitive water height or fluid level sensor. Uninsulated conductor 310 can be a bare copper, tinned, or gold-plated wire, but could also be virtually any conducting material which makes contact with the fluid or water, including the bolts which attach tank 52 to bowl 54. Insulated conductor 311 is ideally an inexpensive enamel-coated wire, where center conductor 312 is copper wire and insulation 313 is the enamel coating. Insulated conductor 311 could also be virtually any electrical conductor that is fully covered with an insulator, such as a conformal-coated circuit board or similar. A variation of FIG. 18A is shown in the exemplary sensor of FIG. 18B, which shows U-shaped insulated conductor 314 as being substantially longer than insulated conductor 311, the purpose for said U-shape which will momentarily be explained. The advantage of insulated conductor 311 or 314 being enameled-coated wire or similar is that the hydrophobic properties of the enamel coating prevent water from adhering to the surface during flush cycles, which allows for very accurate real-time tracking of the water height. A further benefit to using enameled coated wire or similar for insulated conductor 314 is the enamel itself is an excellent dielectric that is extremely consistent in thickness, enhancing sensor reliability and manufacturing predictability.

FIG. 18C shows the novel capacitive water height or fluid level sensor of FIG. 18A being inserted into water W to a water height H. Uninsulated conductor 310 makes direct electrical contact with water W, forming one plate of a capacitor as it surrounds insulated conductor 311. Center conductor 312 forms the second plate of the capacitor, the total plate area of which can be defined in simple mathematical terms as A=2πr×L, where r is the wire radius and L is the total length of the submerged wire as defined by water height H. Insulated conductor 311 therefore acts as the dielectric. The well-known formula C=εA/d shows that total area A multiplied by dielectric permeability ε, when divided by dielectric thickness d, will yield an approximation of the actual capacitance. It is therefore easily seen mathematically that the greater water height H, the greater the capacitance of the submerged sensor of FIG. 18A. Further, it can be seen mathematically that the capacitance of the FIG. 18A sensor is a linear function of water height H. The exemplary sensor of FIG. 18B shows U-shaped insulated conductor 314, which doubles the capacitance of the sensor in order to increase the resolution in terms of water height H. The sensor of FIG. 18A requires the very tip of insulated conductor 311 to also be fully isolated from the water, while the exemplary sensor of FIG. 18B does not require the tip to be isolated and, instead, can actually be easily and more cost-effectively deployed in production by attaching both ends of U-shaped insulated conductor 314 to the circuit enclosure or monitoring device 325 as shown in FIG. 19, which shows monitoring device 325 as one possible configuration for in-tank use in a typical toilet.

(advantages of enamel-coated wires; points about enamel as a dielectric; resistance to water [hydrophobic] and contaminants;) (contaminants in water; ionization required for conduction; extremely high impedance; all point to virtually unchanging characteristics; plus, CMOS 4060 remains fairly constant over battery depletion) It is obvious that the uninsulated conductor 310 must be in contact with the same water or liquid as that of insulated conductor 314 for the sensors of FIG. 18A and FIG. 18B to function in accordance with the specification herein. However, extensive empirical testing has demonstrated that when uninsulated conductor 310 and insulated conductor 314 are in contact with the same container of water or liquid, that the mechanical form, shape, and length of uninsulated conductor 310 have little to no effect on the accuracy of the resulting capacitance measurement. Tests using other uninsulated conductors, such as connecting directly to conductive fluid fill line 64 or using a conductive flush chain 60, have produced excellent and accurate results. Due to the very high impedance of RC oscillator 820 in FIG. 17, the sensors of FIG. 18A and FIG. 18B exhibit no substantial variation in accuracy over a wide range of liquid or water impurities, conductivity, temperature, depth of submersion, or variation of metals that might be used to construct uninsulated conductor 310.

When the sensor of FIG. 18A or FIG. 18B is connected to the circuit of oscillator/divider circuit 815, such that uninsulated conductor 310 is attached to conducting probe input 802, and insulated probe 311 or U-shaped insulated probe 314 is attached to insulated probe input 803, the sensor, whether the sensor of FIG. 18A or that of FIG. 18B, presents a capacitance that is now parallel to that of capacitor 804. Basic electronic theory shows that parallel capacitances are additive, where C_{T}=C₁+C₂, with the total capacitance being C_{T}, C₁ representing the fixed capacitor 804 and C₂ representing variable capacitance of sensor FIG. 18A or sensor FIG. 18B, both of which will vary in capacitance as a function of water height H. When either sensor or one of similar construction is connected across capacitor 804 as was previously described, the total capacitance increases and the RC oscillator 820 frequency decreases, as do all of the divided down outputs of binary counter/oscillator IC 800. When the sensor makes contact with water and as the water height H increases, the RC oscillator circuit 820 frequency decreases, resulting in square waves at the various divided down outputs of binary counter/oscillator 800, the pulse widths of which are directly correlated to water height H. It should be noted that when the capacitive sensors have no contact with water, empirical and mathematical data demonstrate that the added capacitance is negligible, predictable, and extremely stable, permitting microcontroller 801 to “sleep”, thereby drawing very little current, until the increase in total capacitance C_{T} indicates that the capacitive sensor has been placed in a toilet tank, having come into contact with water, whereby microcontroller 801 “wakes up” and begins to function as a toilet monitoring and intelligent control system. This feature is an operational benefit to the end-user, which permits the battery powering the circuit to be shipped installed and connected, further simplifying the operating instructions and use for the user.

(Description of remainder of FIG. 16: microcontroller and ancillary circuitry; explanation of sensor/circuitry water height measurement) Microcontroller 801 preferably has very low quiescent current drain during operational and sleep modes, a configurable internal oscillator, program memory, EEPROM storage for datalogging, and sufficient ports for controlling the connected ancillary circuitry. For example, the Microchip 16LF series of microcontrollers offers a wide selection of components that are perfect for this type of application.

Water height measurement is initiated when port RC0 of microcontroller 801 outputs logic “1”, herein interchangeably defined as HIGH, Vdd, or the positive power supply rail, which turns on binary counter/oscillator IC 800. Upon power-up, ports Q4 through Q14 of binary counter/oscillator IC 800 initialize as logic “0”, herein interchangeably defined as LOW, GND, or the negative supply rail. Also upon power-up, the RC oscillator 820 section of binary counter/oscillator IC 800, comprised of resistor 805, resistor 806, capacitor 804, and the exemplary water height sensor of FIG. 18B, immediately begins its astable operation. In the preferred circuit embodiment shown in FIG. 17, the Q4 output of binary counter/oscillator IC 800 is selected, which divides the fundamental frequency of RC oscillator 820 by 16. If the initial fundamental frequency of RC oscillator 820 is X, then the frequency at Q4 would be X/16, and the t1 period would be 1/(X/16). For example, assume an RC oscillator 820 frequency of 1,000 Hz at a given fixed water height. The Q4 output would be 62.5 Hz, with a t1 period of 16 milliseconds. Timing diagram 830 shows the output of Q4. Power-up of binary counter/oscillator IC 800 begins with Q4 held LOW at oscillator power-up time 822 and remaining low for one-half of the normal t1 period, shown as ½t1 in FIG. 17, or for 4 RC oscillator 820 clock cycles. Rising edge 824 occurs on the 5^{th} clock cycle, which causes microcontroller 801 port RA2 to trigger an internal timer/counter. Falling edge 824 is detected by port RA2 to terminate the internal timer/counter, the duration of which corresponds to the t1 period of 8 RC oscillator 820 clock cycles, which varies as a function of the change in capacitance of the exemplary sensor of FIG. 18B. When the t1 period has been determined, port RCO goes LOW and powers down binary counter/oscillator IC 800 to conserve battery power. The resolution of the internal timer/counter of microcontroller 801 determines the water height measurement resolution of the exemplary sensor of FIG. 18B. For example, if the internal timer/counter resolution is in 10 microsecond intervals and the RC oscillator 820 frequency of 1,000 Hz is assumed at a given fixed water height, the t1 period of 8 milliseconds would be resolved as 800 increments, or bit counts, of the timer/counter. As will be explained shortly, each incremented timer/counter bit corresponds to a very precise and linear water height displacement amount. The RC oscillator 820 passive components, the variable capacitance range of the exemplary sensor of FIG. 18B, the internal oscillator frequency of microcontroller 801, and the resolution of the internal timer/counter used to clock the t1 interval, determine the water height accuracy and resolution of the toilet monitoring and intelligent control system.

(Specifications relative to example operation and responsivity of exemplary sensor and electronics; sensor wire dimensions; displacement measurements) In practice, the combination of the exemplary sensor of FIG. 18B, the timing characteristics of microcontroller 801, and the RC oscillator 820 have been optimized to produce a baseline t1 period of approximately 300 bit counts when the total conductor length 314L of uninsulated conductor 310 and insulated conductor 314 of FIG. 19 or FIG. 28 is approximately 13 inches in total length and having no contact with water. For every linear inch of water that uninsulated conductor 310 and insulated conductor 314 are submerged, the internal timer/counter of microcontroller 801 increments approximately 324 bit counts, or approximately 3.25 bits for every 1/100th linear inch. For instance, if uninsulated conductor 310 and insulated conductor 314 are submerged to a depth of 5 inches in an average toilet tank or other liquid carrying vessel, the t1 result of microcontroller 801's internal timer/counter would be the baseline of 300 bits, plus 324 bits multiplied by 5 inches, for a total t1 count of 1920 bits. At a timer/counter resolution of 10 microseconds, the total resulting active microcontroller 810 and binary counter/oscillator IC 800 time required to determine t1 is 19.2 milliseconds. Adding in the ½t1 time of approximately 10 milliseconds, the total operational measurement conversion time is about 30 milliseconds. From the Microchip microcontroller 16LF or 18LF series datasheets, when the internal RC oscillator is configured for a clock speed of 4 mhz and binary counter/oscillator IC 800 is running, the average operational current during the complete measurement conversion cycle is less than 200 microamperes. Operationally and by way of example, if water height measurements are executed every 500 milliseconds and the average measurement conversion is approximately 30 milliseconds, the current required from the battery to power the circuits approaches a 6% duty cycle, or an average hourly drain of 12 microamperes. It should be noted that the microcontroller 801 is in the “sleep” or low-power mode during the remaining 94% of the time, drawing less than 2 microamperes. In view of the above current drain data, an average 225 mAh CR2032 lithium battery is more than capable of powering the preferred toilet monitoring and intelligent control system for up to 18 months without replacement.

There are several different measurement methods that can be used to track the water height in a typical tank-based toilet using the accurate and repeatable exemplary system described herein. Once a flush cycle has been detected, microcontroller 801 port RC0 can enable binary counter/oscillator IC 800 to run continuously while port RA2 and the internal timer/counter track sequential t1 intervals, which provides the most accurate measurement of the water height with respect to time. During continuous measurements, the duty cycle of the resulting Q4 square wave is approximately 50%, although it should be obvious that the HIGH and LOW time periods will vary during flush cycles. During non-flush periods, periodic measurement conversion cycles can be executed, as was previously described, and the resulting interval data analyzed for leaks and other toilet malfunctions, the methods of which are described below.

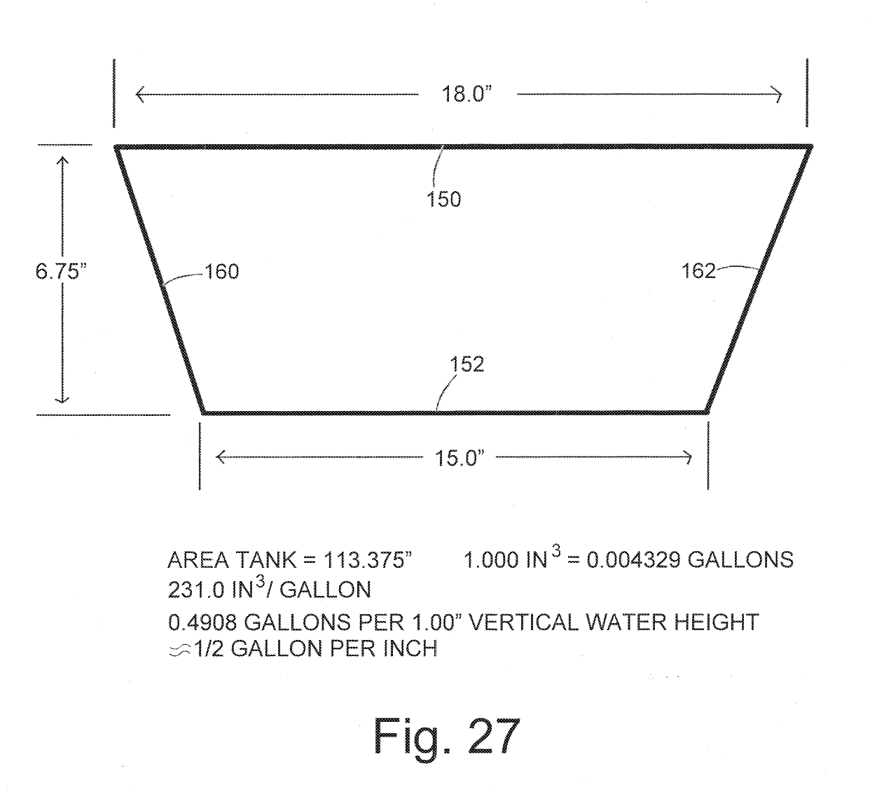

FIG. 27 shows the top-down cross-section of the average tank-based toilet. From the trapezoidal measurements shown, the average area is approximately 113.375 inches. A gallon of water is 231 cubic inches. Therefore, a 1 inch displacement of water in tank 52 is approximately one-half gallon of water. The exemplary system described herein has the accuracy and resolution to track and detect intentional and unintentional water flow through tank 52 in virtually every mode of toilet operation including, but not limited to, flush cycles, leaks, wide-open flappers, overflows, and faulty fill valves.

### Detailed Description of the Toilet Tank Water Level Responsivity During Normal Operation and in Response to Various Leaks and Failures

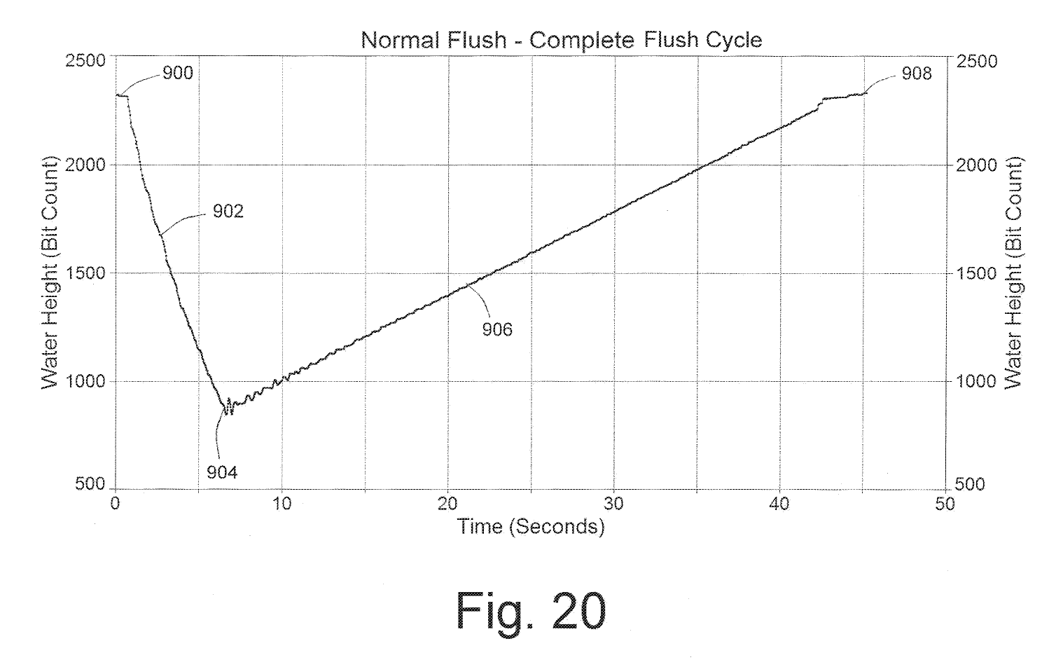

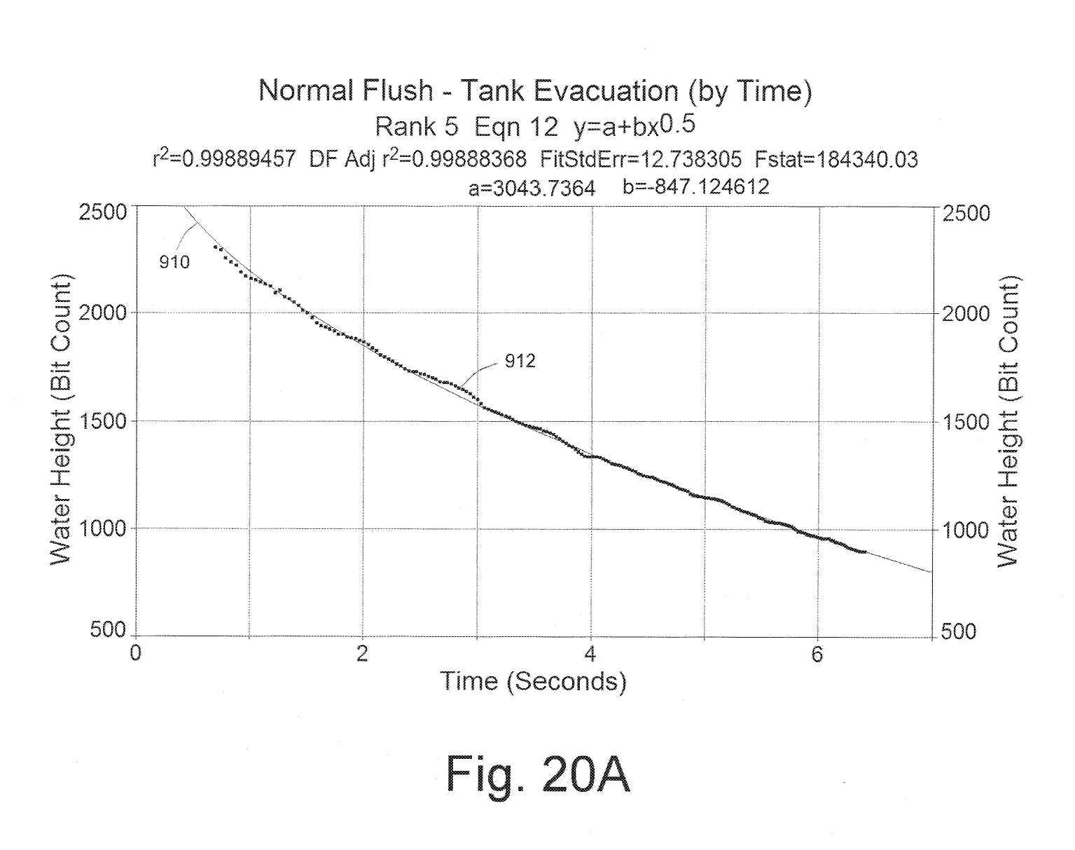

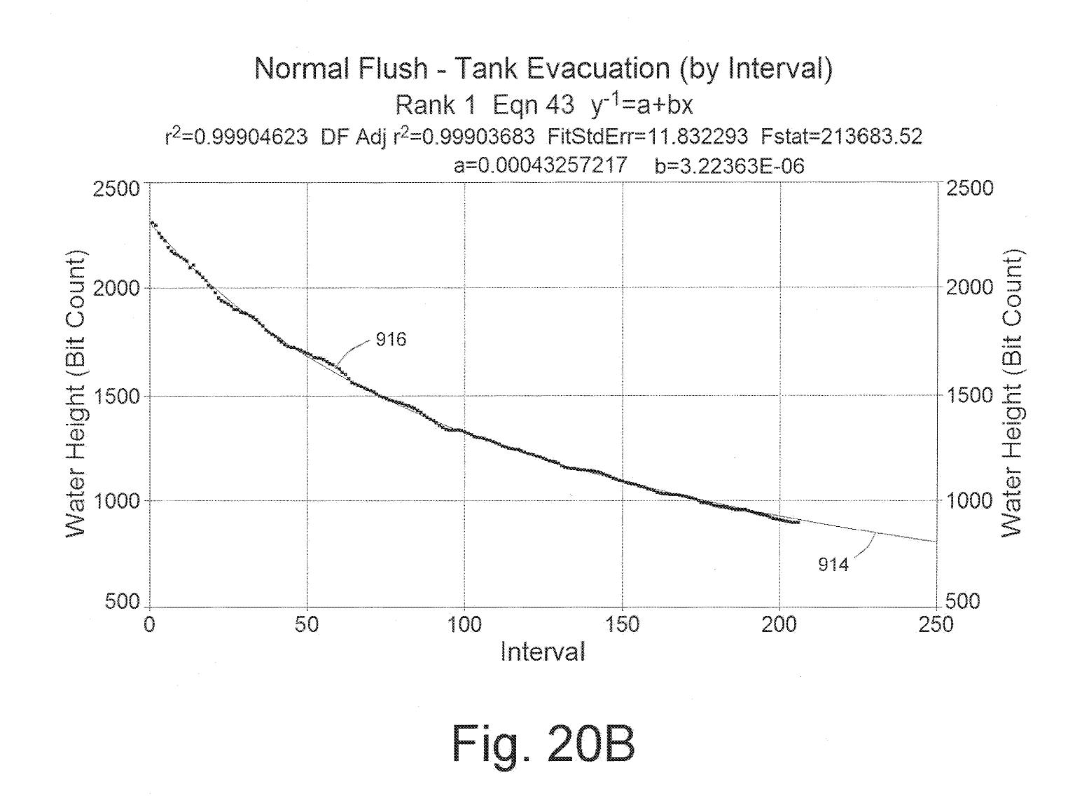

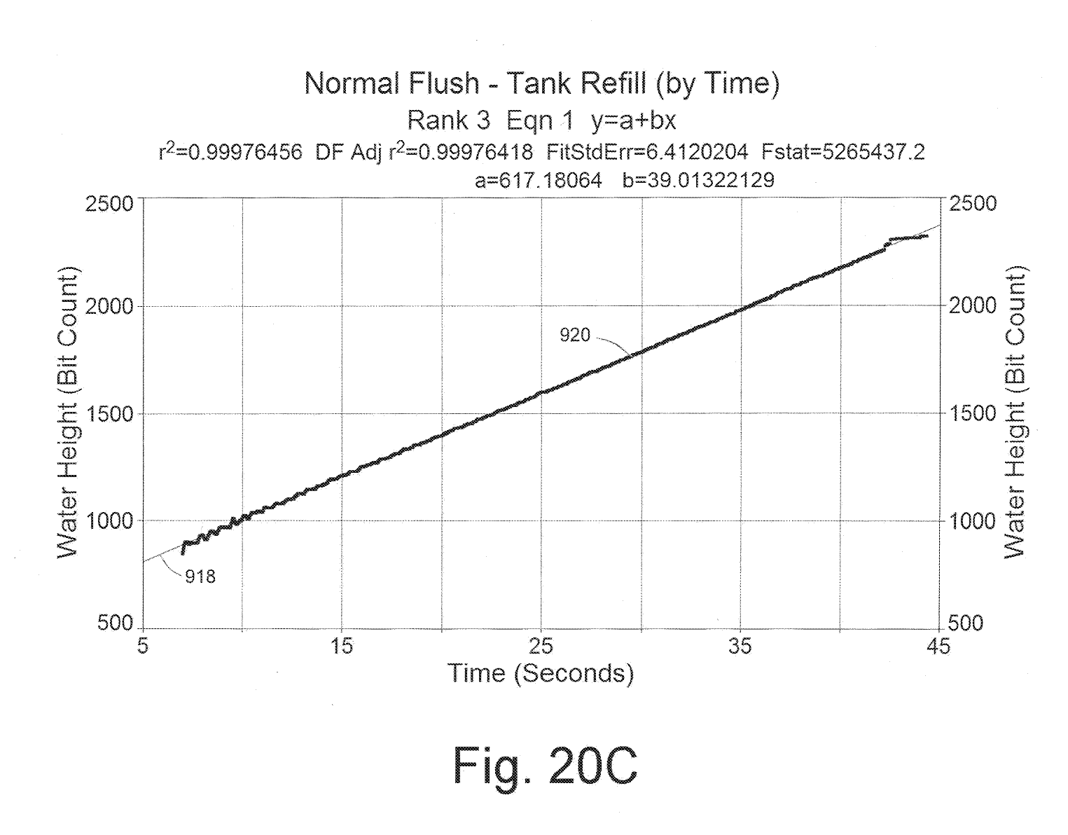

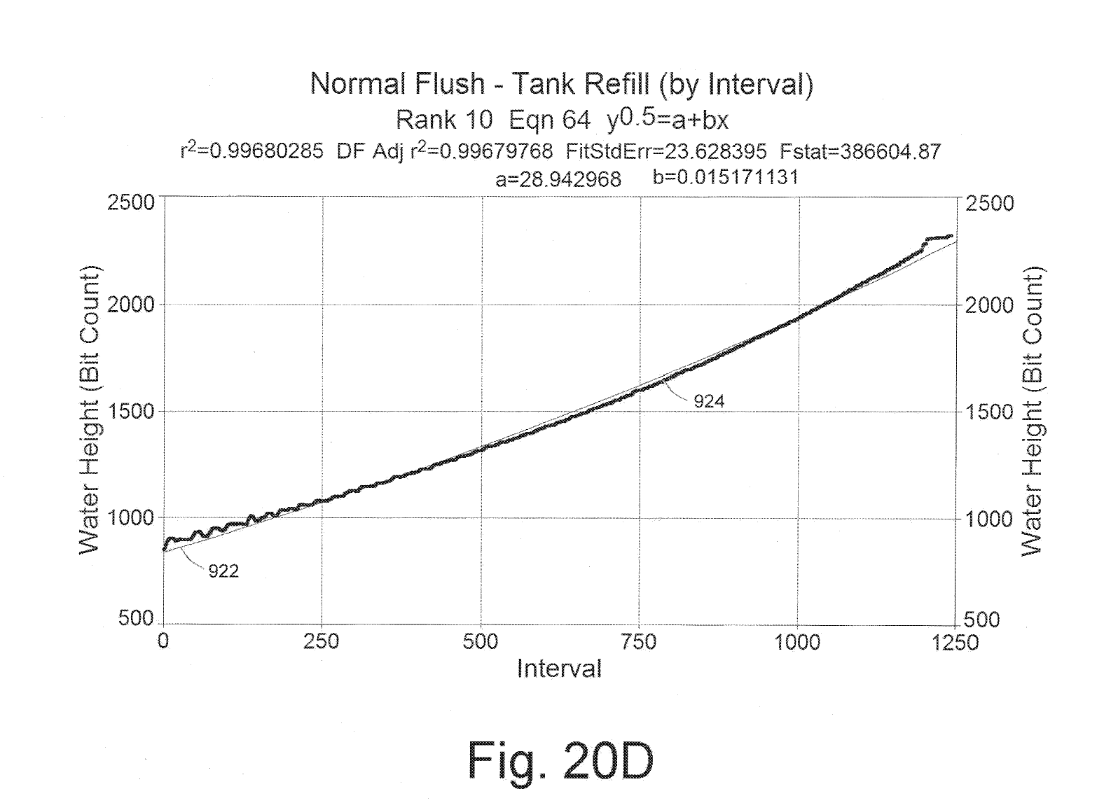

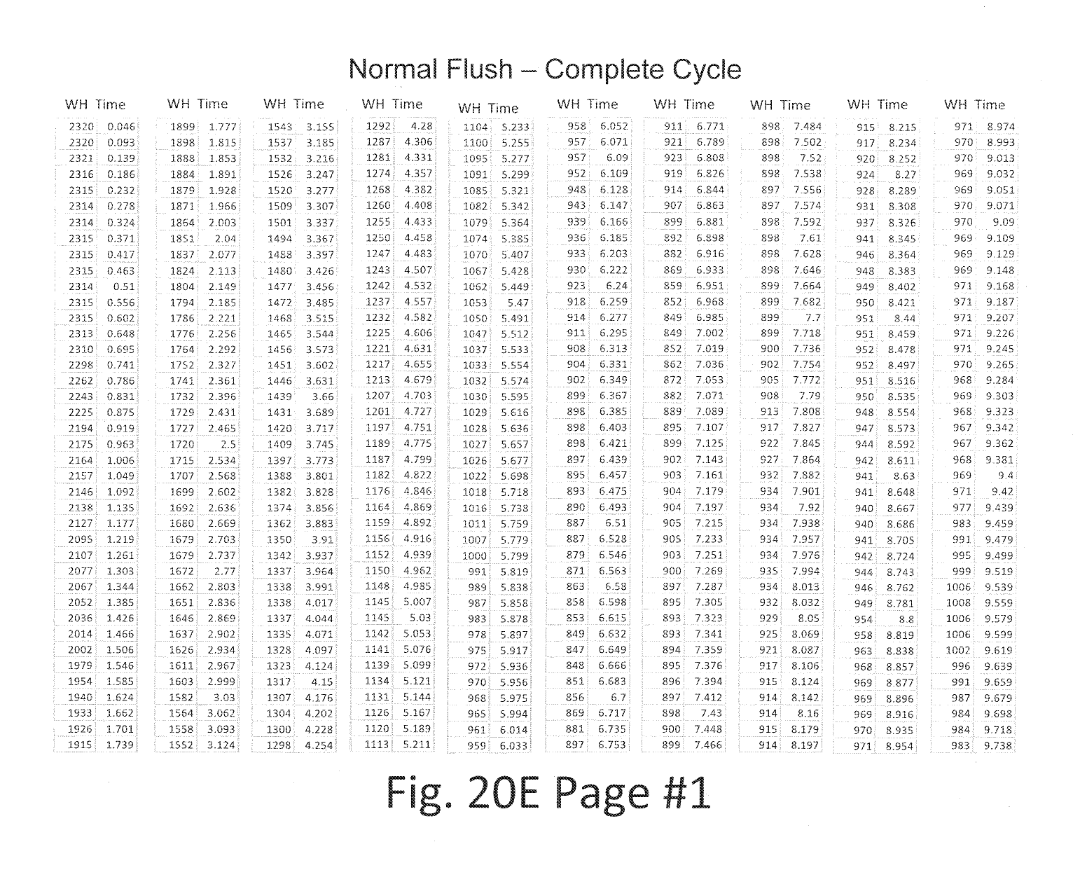

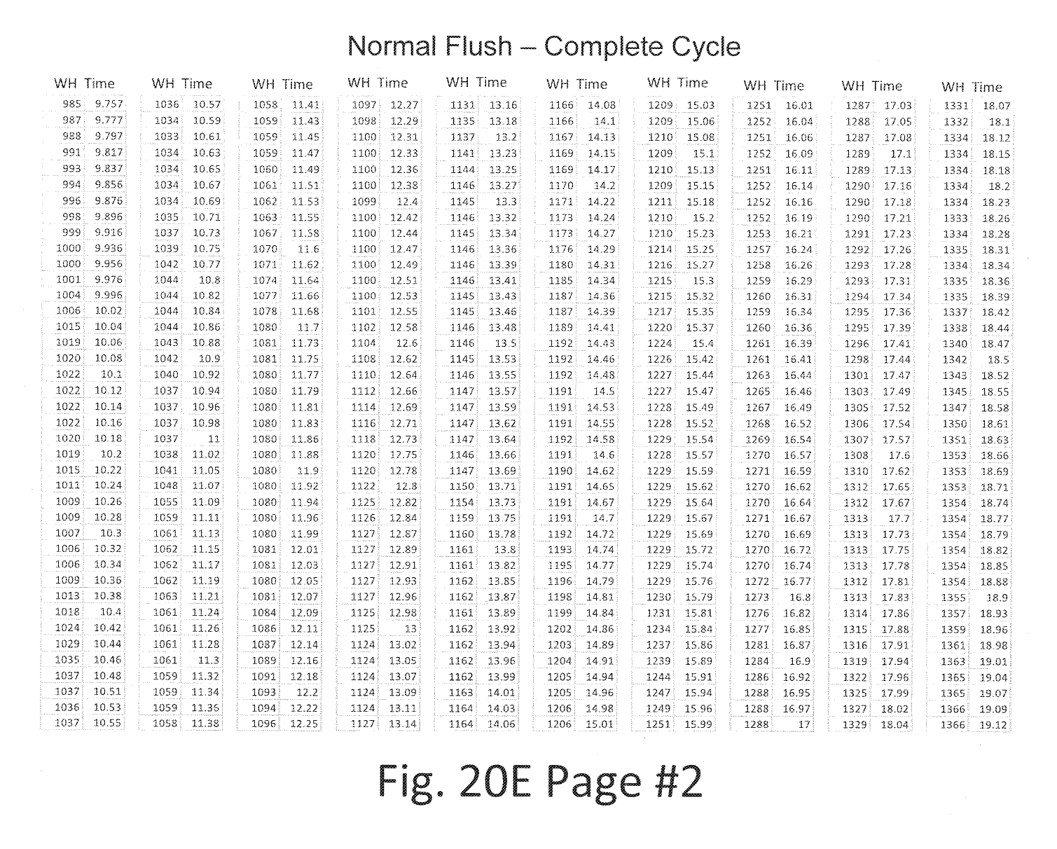

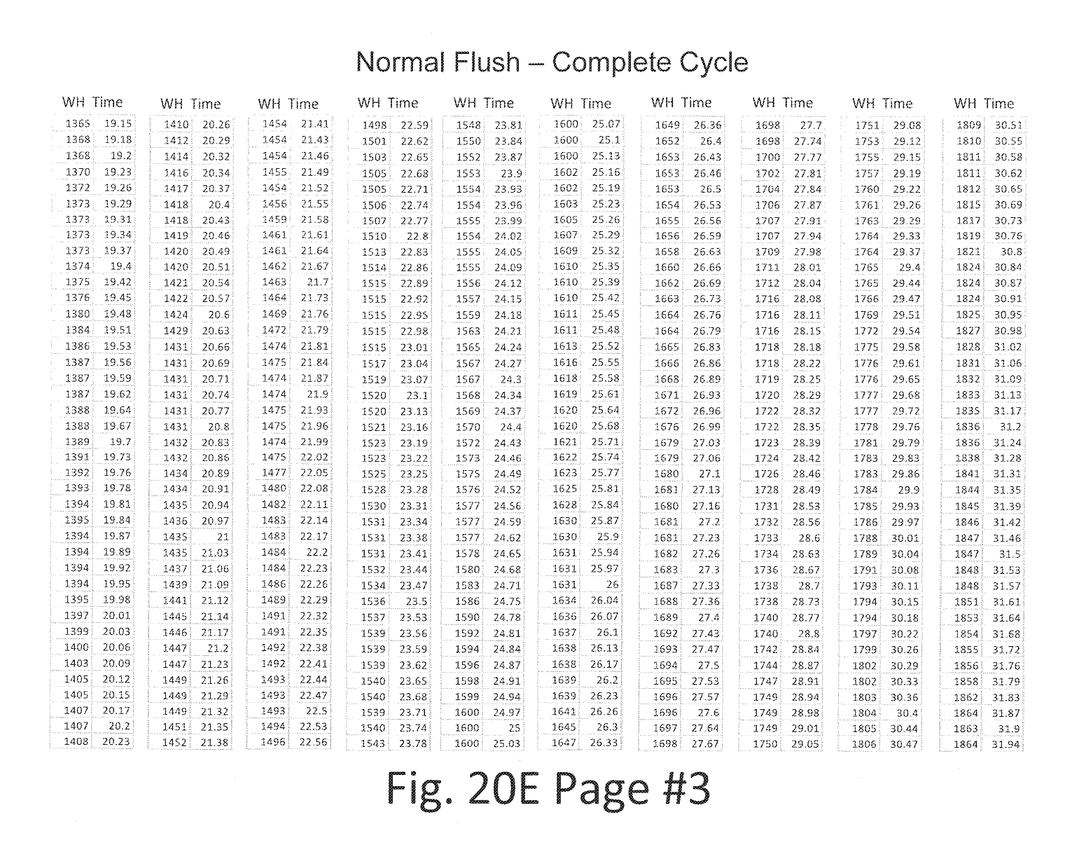

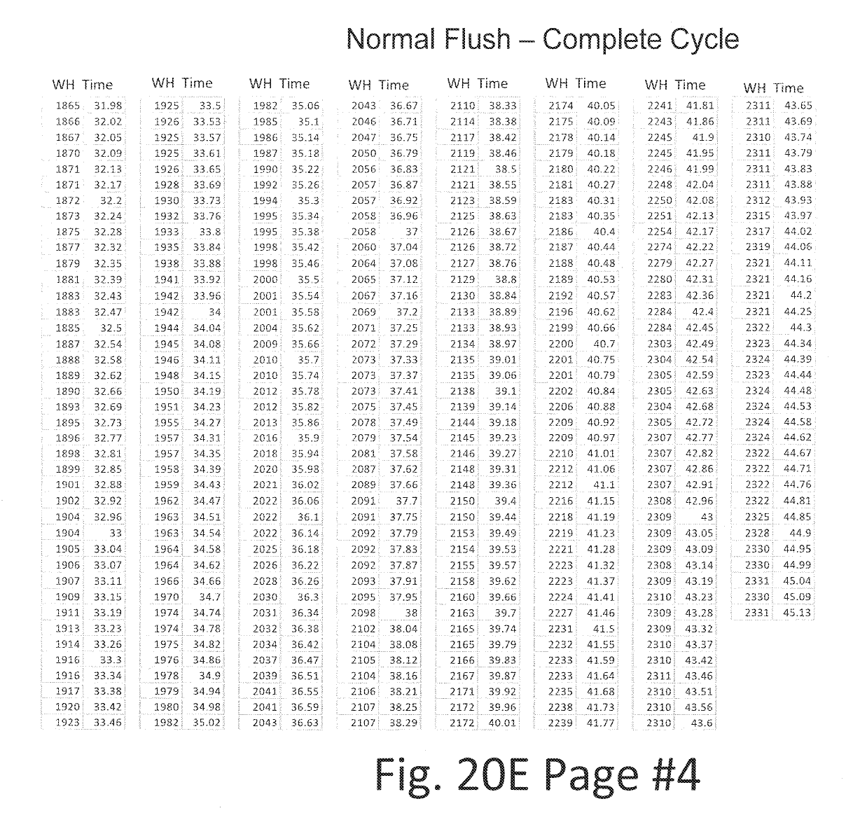

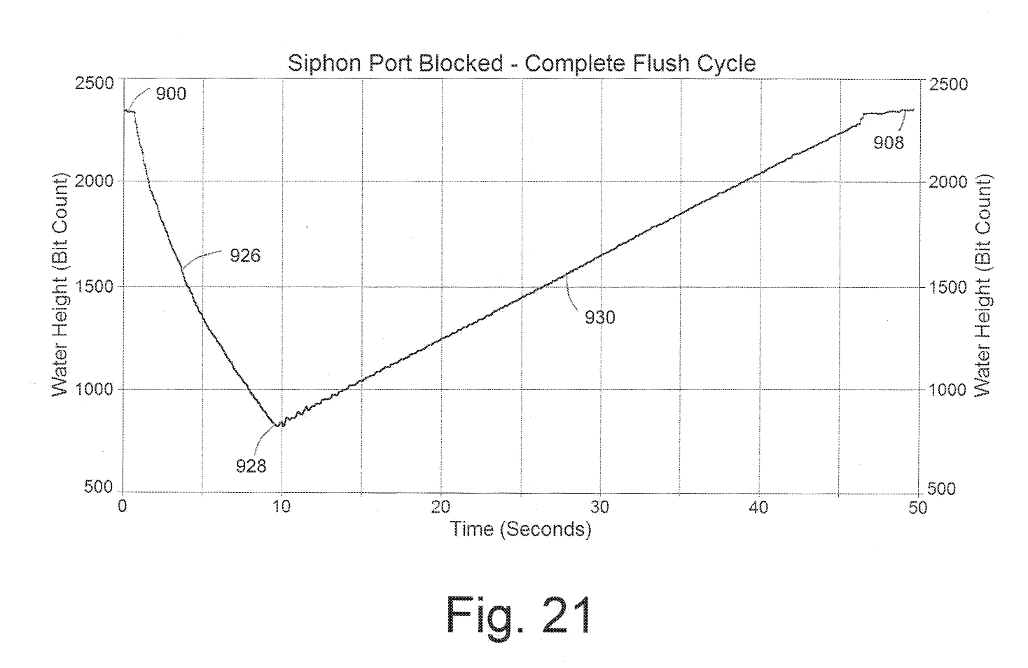

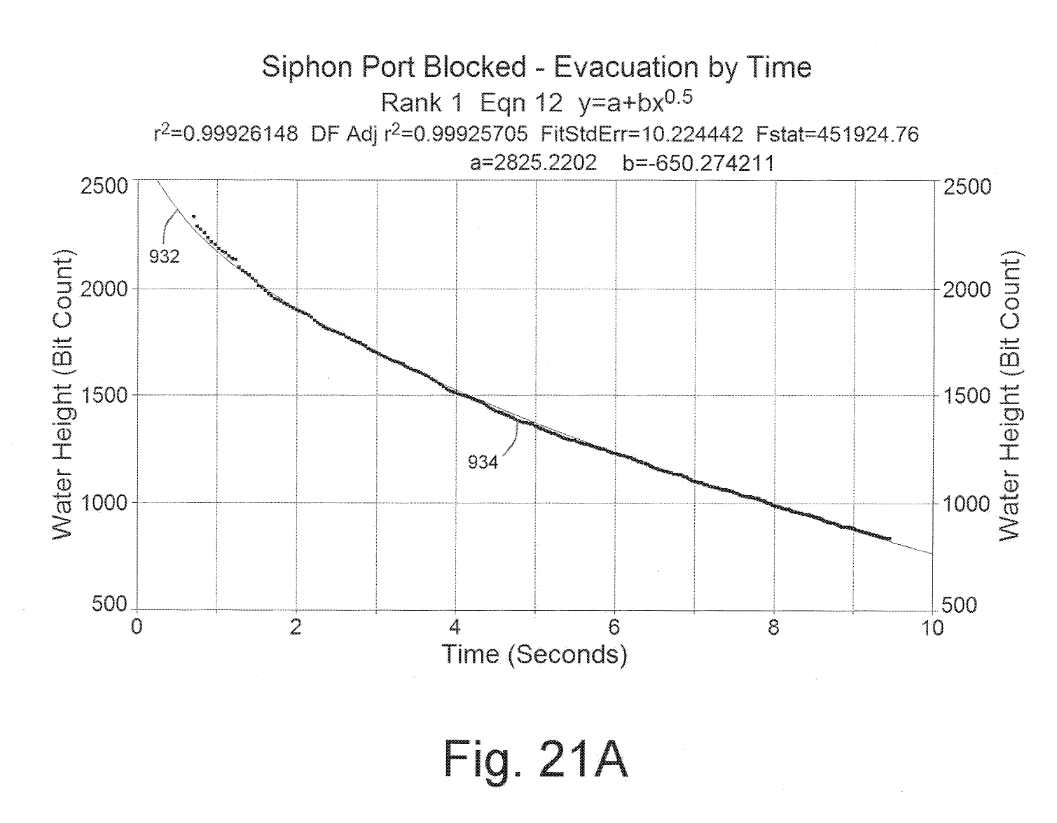

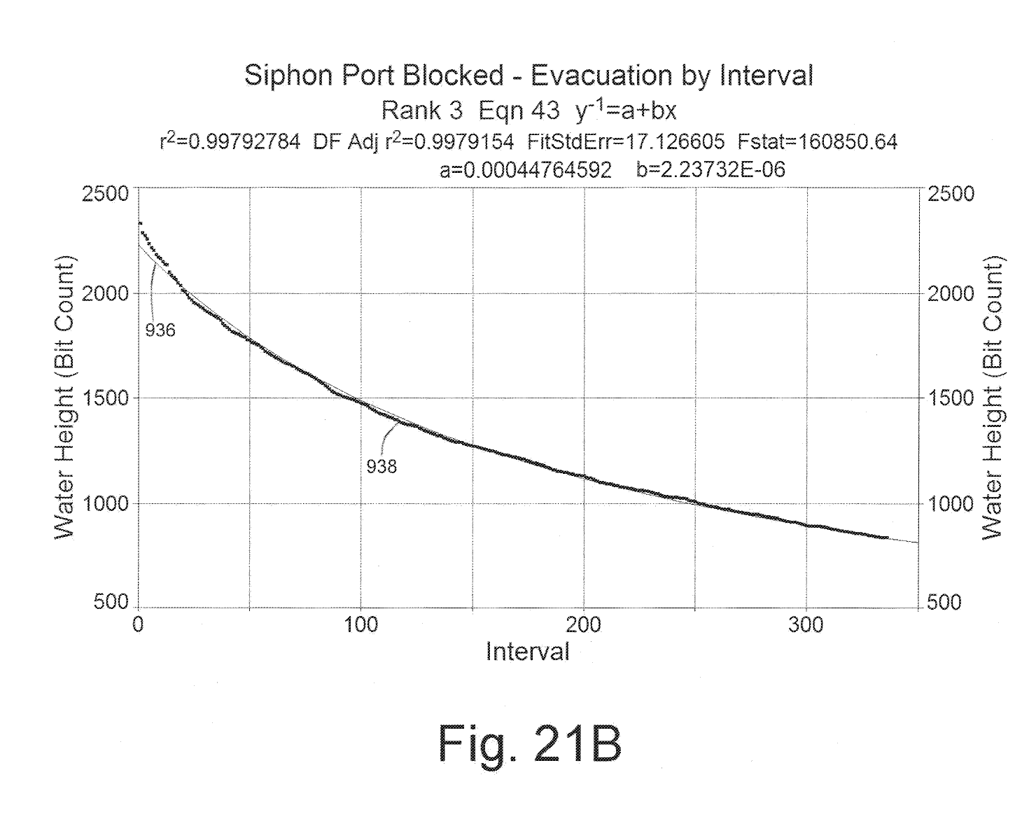

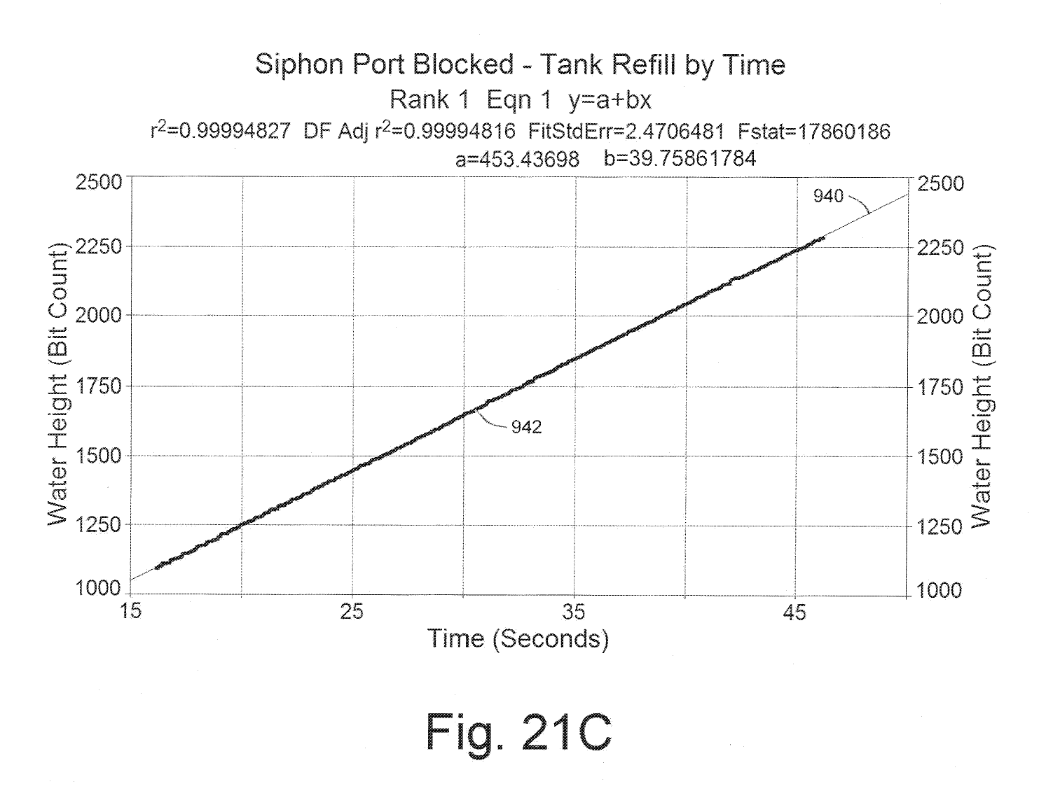

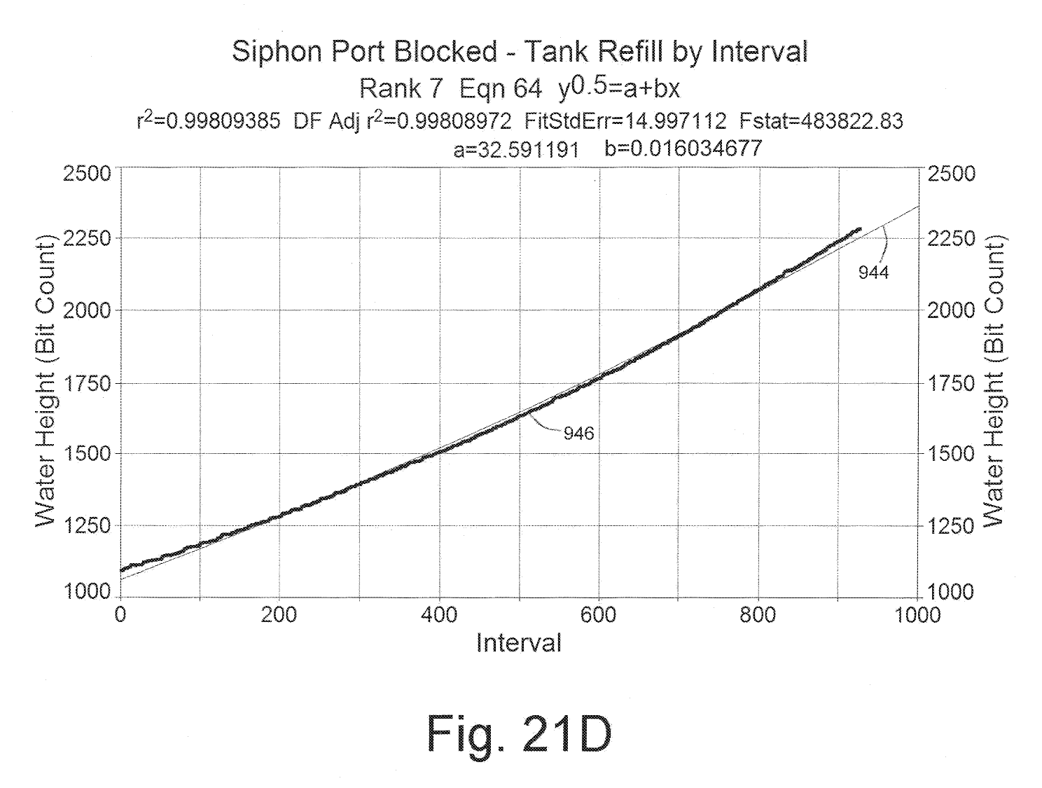

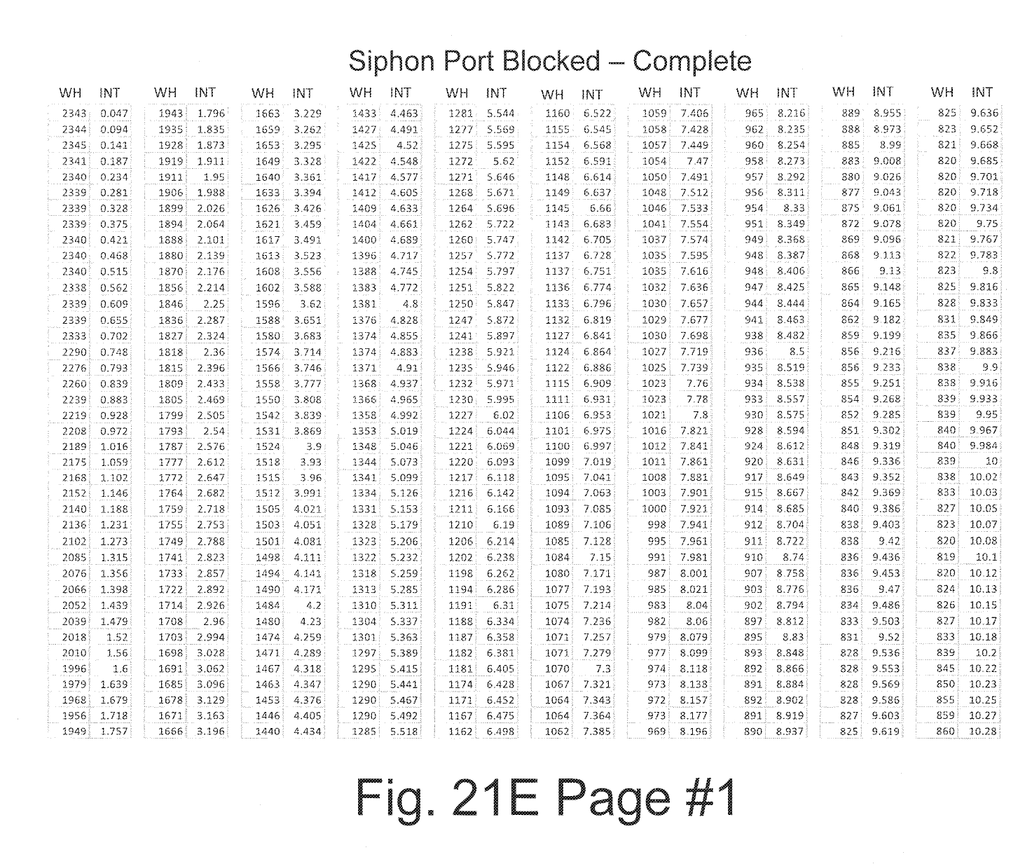

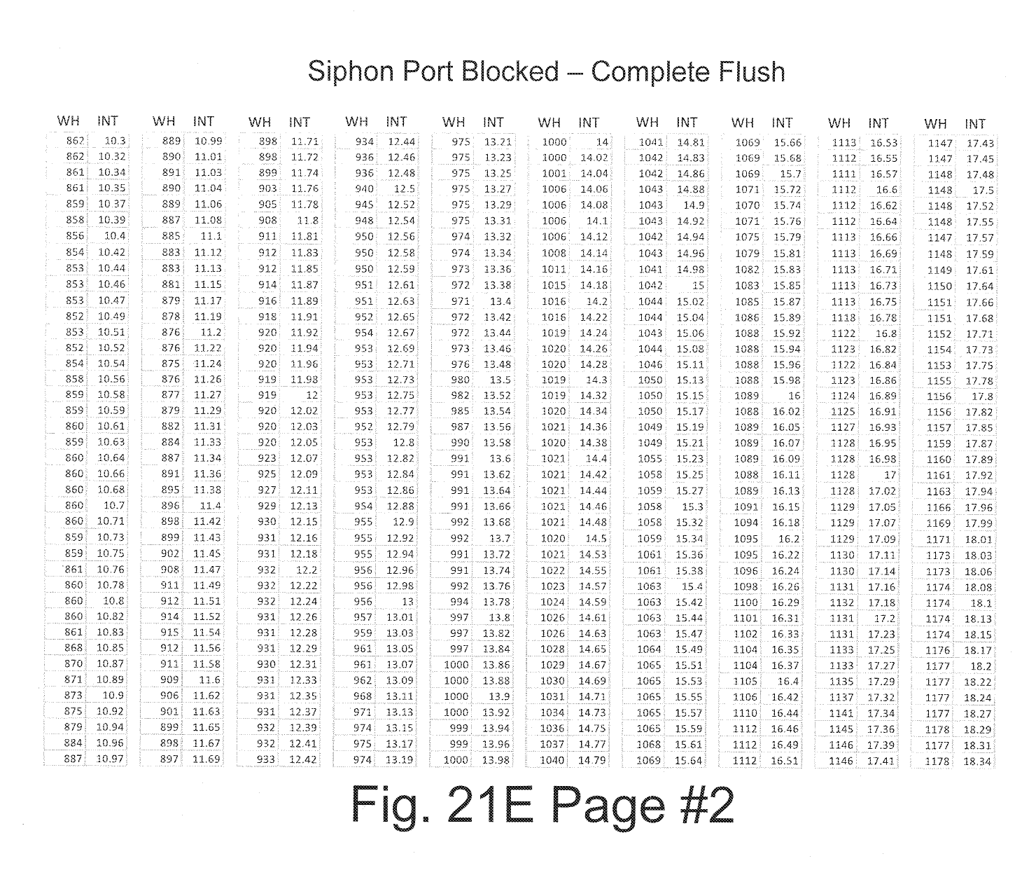

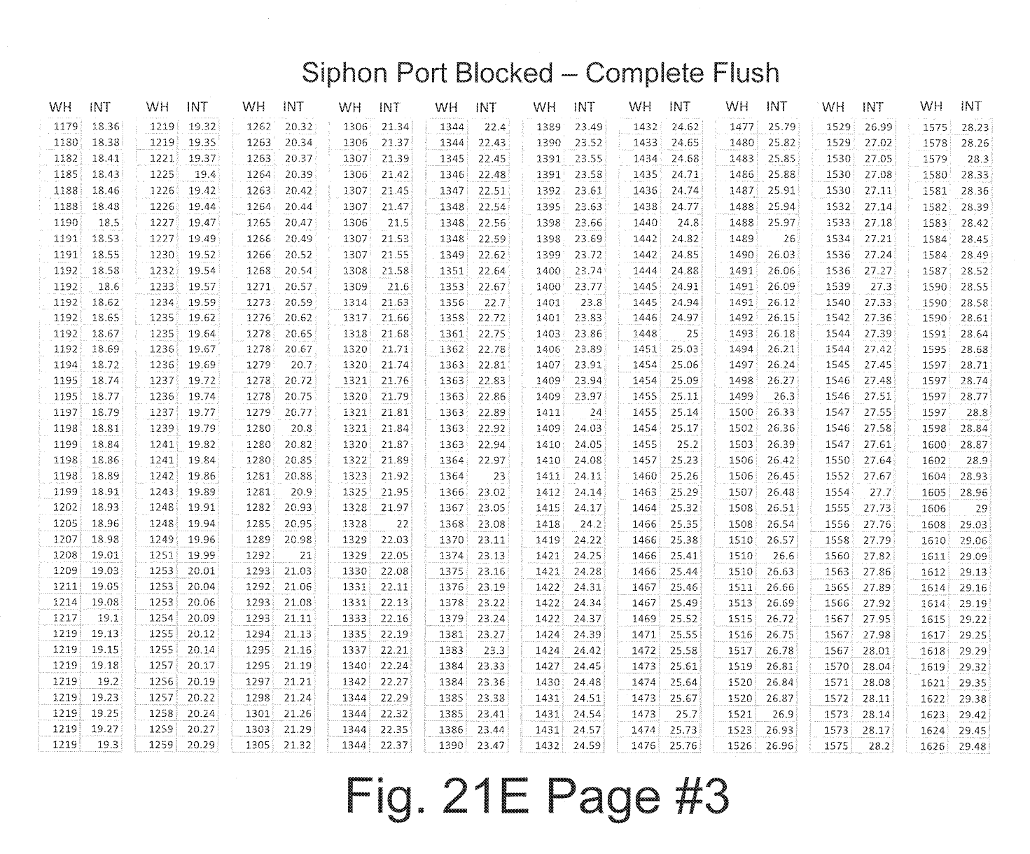

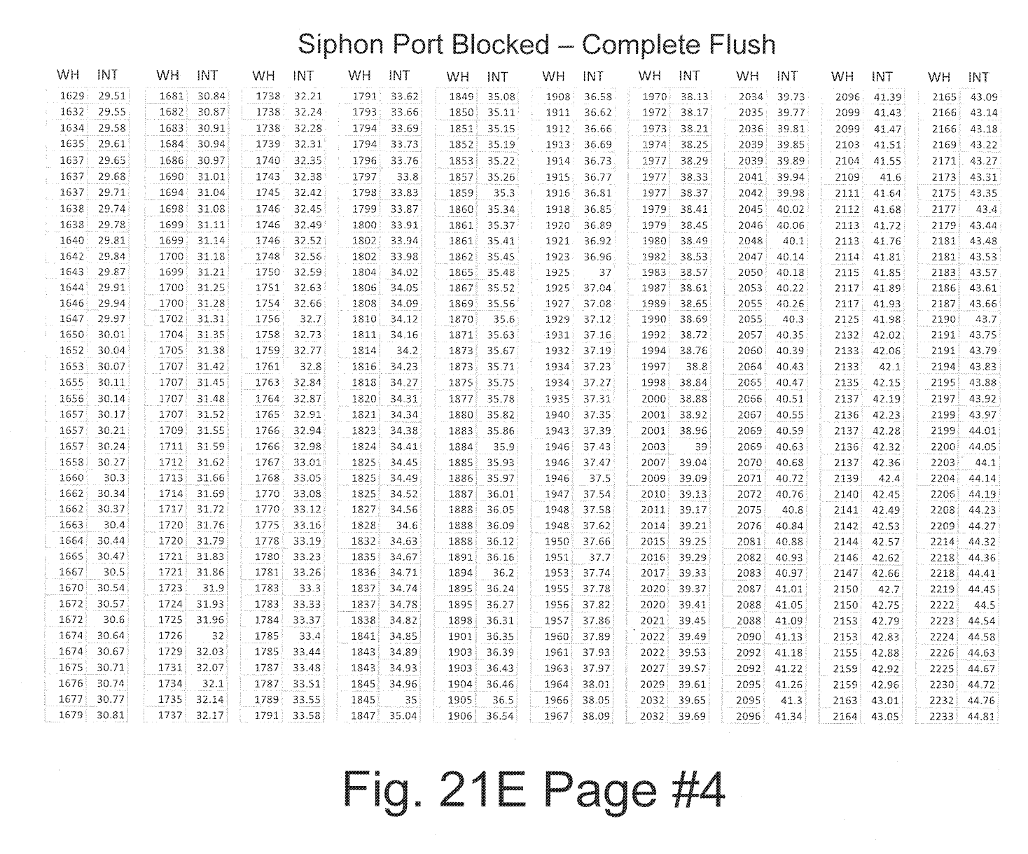

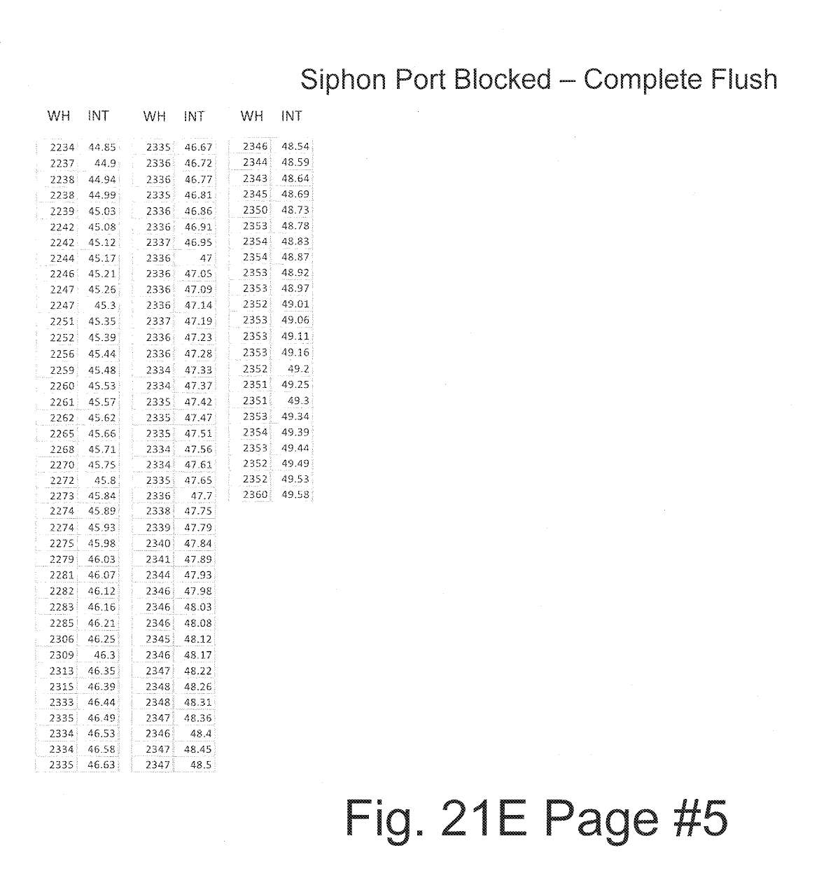

(FIG. 20 thru 26: Data and graphs derived from exemplary sensor and microcontroller as they correspond to toilet operation) FIG. 21 through FIG. 26 show actual water height data gathered by the exemplary toilet monitoring and intelligent control system. The graphs will be used to demonstrate how the water height, as a function of time or cumulative water height intervals, can be used mathematically by equation, or with respect to time or intervals, in order to identify toilet problems and anomalies. For the purpose of clarity, it is mentioned here that binary counter/oscillator IC 800 is permitted to run non-stop in the astable mode when collecting any sequential data, such as during a flush cycle. In non-flush mode operation, however, the binary counter/oscillator IC 800 is operated in the low power mode, which collects t1 intervals periodically, until a flush is detected, as was explained previously and again below. FIG. 20 graphs the complete normal flush cycle of a properly working toilet that exhibits no anomalies or problems of any kind. FIG. 20E shows a complete listing of the graphed data, which will be used herein for reference. Starting water height 900 shows the toilet tank 52 water height at the moment the toilet is flushed. Tank evacuation 902 is the relatively linear decrease in water height that occurs as toilet tank 52 drains into unobstructed bowl 54 through flush valve 61. After most of the water has drained from the tank, flapper 62 seals off flush valve 61 and terminates the tank evacuation process, shown as flush valve closure water height 904. Fill valve 66, which opened during tank evacuation when float 112 dropped, continues to allow water to enter tank 52, resulting in tank refill 906. End-of-flush water height 908 indicates that float 112 has reached it maximum vertical height, and water flow through fill valve 66 is terminated. FIG. 20A shows only the tank evacuation 902 of FIG. 20. Tank evacuation data trace 912 is the actual water height data gathered by the exemplary toilet monitoring and control system, which is best modeled and represented by y=a+bx^{̂0.5}, where y is the water height and x is time. It has been found that for the normal flush for most tank-based toilets, the formula constants a and b are generally in the range of 3045 and −850, respectively. Therefore, when the exemplary toilet monitoring and intelligent control system is installed into any given toilet without calibration or set-up, the formula y=a+bx^{0.5}, when used with the a constant of 3045 and b constant of −850, can be used to determine if tank evacuation 902 is normal or abnormal. An explanation of how the formula can be used to detect abnormal tank evacuation will be explained shortly. But suppose after initial installation the exemplary toilet monitoring and intelligent control system simply monitors the first actual flush, recording the water height as a function of time. In that instance, it can easily be seen that the a and b constants can then be more accurately mathematically derived from the recorded data, if desired. During the initial flush it is also obvious, for example, that the water height could be sampled one or more times during tank evacuation 902, as a function of time, and stored for later comparison, the purpose for which will be described shortly. For example, the water height in tank 52 could be sampled every one-half second and recorded. Recorded data during tank evacuation 902 can also be used to establish the rate of change of the data, in terms of water height with respect to time. From the FIG. 20E data, it can be seen that time is the cumulative function of the t1 interval of binary counter/oscillator IC 800, and is derived by adding the LOW time period immediately preceding a given t1 interval, to the t1 interval, as is cumulatively represented in the FIG. 20E column identified as “Time”. FIG. 20B shows the normal tank evacuation profile of FIG. 20 of tank 52 water height as a function of interval, where the t1 intervals are simply consecutively tracked on the graphs x-axis. In this graph, tank evacuation data trace 916 is shown in view of the derived tank evacuation equation trace 914, which is of the form y⁻¹=a+bx. Using this equation and with respect to most toilets, the constants a and b are generally in the range of 0.000433 and 3.224E-6, respectively. Although those schooled in mathematics will recognize there are other possible equations that could be used for modeling and resolving the water height and time data, the simple linear equations above are optimum for use in inexpensive non-floating point microcontrollers.

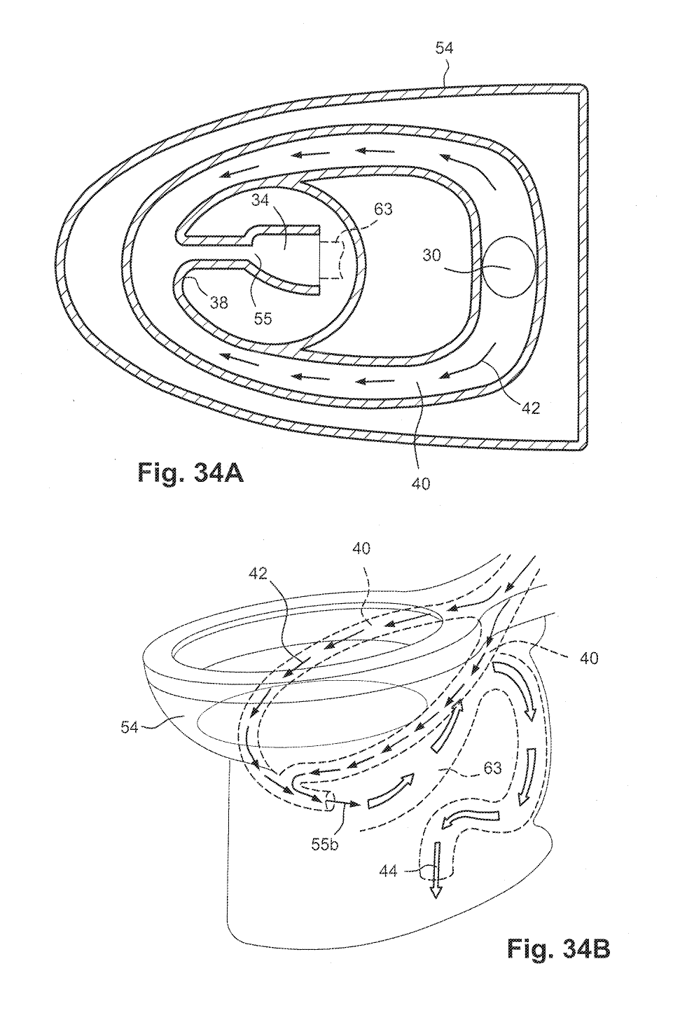

Although different toilet designs may have different evacuation rates that can cause the a and b constants to change in order to more accurately model the evacuation mathematically, this is easily accommodated. The exemplary toilet monitoring and intelligent control system recognizes a flush when any t1 interval falls below a predetermined setpoint of the average and/or standard deviation of 4 preceding t1 intervals. For example, assume the water height W is stable in tank 52 with a bit count of 2500. When the user initiates a flush by pressing flush handle 56 and raising flapper 62 off of flush valve seat 65, and water height W drops more than 50 bits within a single t1 interval, the t1 interval negative displacement compared to the average pre-flush water height W average and/or standard deviation indicates that a flush has occurred. Generally speaking, there is no anomaly or problem with any type of tank-based toilet that impairs or changes the flush cycle within the first 2 or 3 seconds of the flush. But within those first 2 or 3 seconds, the internal water channels 40 in FIG. 34A and FIG. 34 B, which connect to siphon jet 55b and rim holes 55a, have completed filled, reducing the rate at which tank 52 can evacuate through flush valve 61 and into bowl 54. FIG. 7 illustrates an example starting water height 94 before a flush is initiated, corresponding to starting water height 900 in FIG. 20. Water heights 92, 90, and 88, show the successively lower water heights at the 1 second, 2 second, and 3 second intervals, respectively. That 2 or 3 seconds after the flush has been initiated provides enough recorded data for the complete normal flush profile to be mathematically derived, in terms of the a and b constants, particularly if the sample rate during the mentioned 2 or 3 seconds was substantially high. The now derived a and b constants can now be used, for example, at the 5 second mark during the same flush cycle, in order to determine if an anomaly or problem has occurred. For instance, using the actual data of FIG. 20E, suppose the water height data from approximately only the 0.695 second time, which is where the flush was detected as beginning, to the 2.04 second moment of tank evacuation 902, was used to calculate the a and b constants used in the aforementioned or similar linear equation to predict where the water height in tank 52 should be at a future point in time, such as at 5 or 6 seconds within the same flush evacuation 902. Using linear regression analysis, the a and b constants could be calculated by microcontroller 801, allowing microcontroller 801 to predict that water height in tank 52 at a subsequent time in the same flush evacuation 902. A deviation from the predicted and expected water height at said subsequent time would indicate an anomaly or problem, such as those described in the sections below.

FIG. 20C and FIG. 20D show only the tank 52 refill portion of the FIG. 20 complete normal flush cycle as water height with respect to time and interval, respectively. Similar to the evacuation graphs in FIG. 20A and FIG. 20B, the data is easily modeled. Because there is generally no anomaly or problem which can occur during the refill phase of the flush cycle, as long as the water supply pressure to the toilet remains constant, fill valve 66 will refill tank 52 and maintain the equation of y=a+bx, which the overlay of tank refill data trace 920 and tank refill equation trace 918 clearly show. For references purposes, FIG. 20D, which shows the water height in view of intervals, is also shown and is represented by the equation y^{0.5}=a+bx. The graphed curve is the result of the changing interval time period that occurs as the water rises and the t1 interval increases accordingly. The very linear and predictable consistency of the refill phase allows the exemplary system to accurately estimate the total volume of water for each flush cycle, as was previously described in terms of FIG. 27, as well as the actual water flow rate into tank 52 from fill valve 66. For example, if the starting water height in tank 52 is known prior to a flush cycle being initiated by the user, and the flush valve closure water height 904 is determined, the net difference in height as measured by the t1 intervals, when multiplied by the tank 52 cross-section, will provide the total tank 52 flush volume. Further, extensive testing of different types of fill valves have shown that the additional water fill valve 66 dumps into overflow tube 199 through siphon tube 203 during an entire flush cycle, on average, is approximately 25% of the total tank 52 flush volume. In addition to the flush cycle, any of the anomalies and problems that produce unintentional water flow that results in any tank 52 change in water height, can be calculated accurately by simply measuring water displacement with respect to time and, if desired, recording or datalogging the same. The tank refill 906 also allows the volumetric water flow of fill valve 66 into tank 52 to be calculated accurately, as any desired water height interval can be finitely measured in terms of both displacement and time.

The graph and corresponding data of FIG. 20 establish the baseline from which most toilet-related anomalies and problems can be compared and therefore detected, which include not only the tank-specific problems of leaks, wide-open flush valves, and faulty fill valves, but the bowl-specific problems of overflows and the user-related anomaly of double-flushes. FIG. 21 through FIG. 26 provide actual comparison data in graph form.

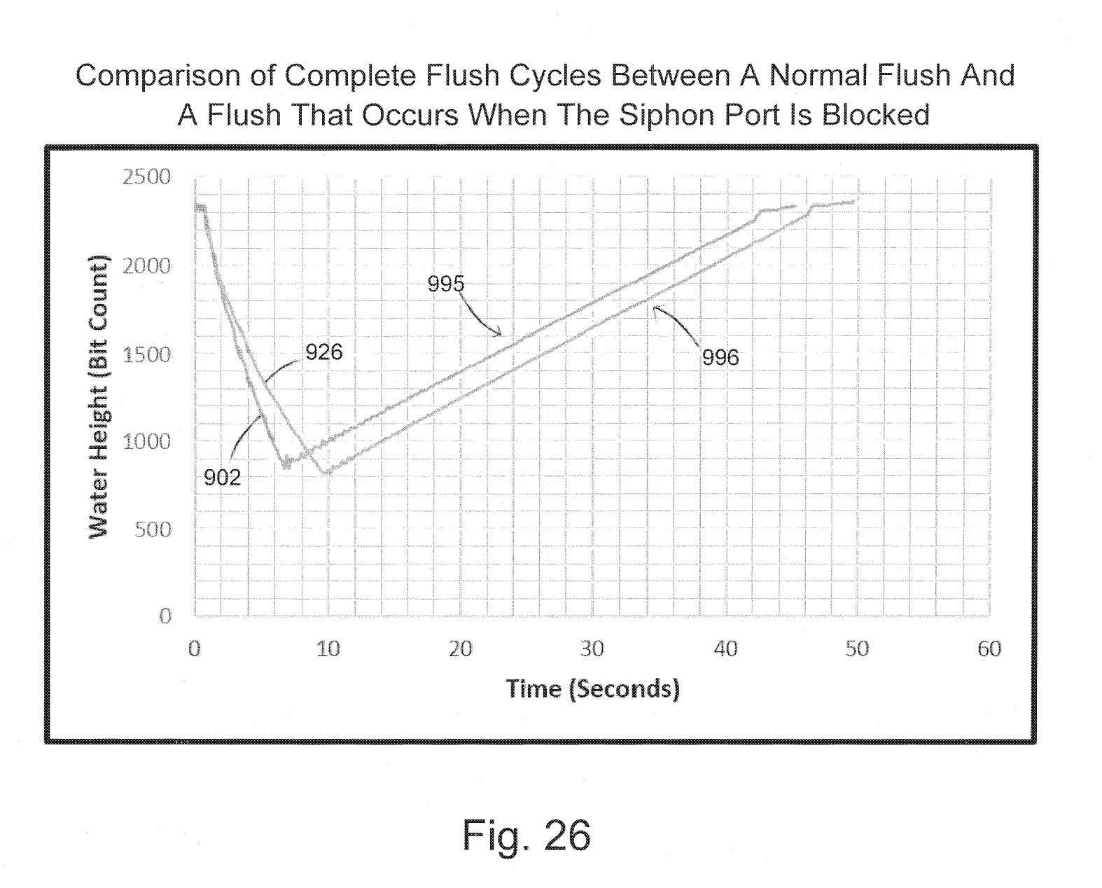

(Blocked Bowl) FIG. 34A shows a top down view of the toilet bowl 54 and FIG. 34B shows a slightly rotated side view of the same toilet bowl 54. When a flush is initiated by the user and flush valve 61 is opened, water enters bowl 54 through water entry port 30 and begins to fill the empty interior water channels 40, exiting into bowl 54 through siphon jet 55b and rim holes 55a, with intake water flow arrows 42 showing the direction of flow into bowl 54 and exhaust water flow arrows 44 showing the direction of flow out of the bowl. During a normal flush where the water evacuating bowl 54 into exhaust port 63 is not impeded or blocked, such as shown in FIG. 3 where bowl 54 is empty or lacking substantial waste product, the tank evacuation 902 of FIG. 20 reflects a profile which consistently and repeatedly mirrors tank evacuation equation trace 910. But when obstruction 68 in FIG. 3A is in any way reducing the flow rate of water w1 in bowl 54, or if a blockage is present anywhere in or beyond exhaust port 63, which in turn cause water w1 in bowl 54 to begin to rise, the water evacuation of tank 52 through flush valve 61 into bowl 54 is impeded, resulting in a measurable change in tank evacuation 902's profile. When water w1 in bowl 54 continues to rise until rim holes 55a are covered, the water flow from tank 52 into water channels 40 is further impeded, presenting the possibility of an imminent overflow if the water is not terminated immediately, the overflow being addressed herein shortly. FIG. 21 shows the graph of a complete single flush cycle when the siphon jet—also known as the siphon port—is blocked or there is an obstruction immediately in front of the siphon jet that is preventing the water in the toilet bowl from draining, as was just described above. In FIG. 21, flush valve closure water height 928 indicates that despite the blockage, flapper 62 has seated on flush valve seat 65 and closed flush valve 61, preventing further water evacuation into bowl 54 from tank 52. Nevertheless, tank evacuation 926 is noticeably different from tank evacuation 902 shown in FIG. 20. FIG. 26 shows the tank evacuation graphs of FIG. 20 and FIG. 21 overlaid onto as a single graph to make the visual comparison straightforward. Tank evacuation 926, which is the result of obstruction 68, results in a slower evacuation of tank 52. Comparing the data in FIG. 20E with that in FIG. 21E shows that within 4 seconds, the water height W in tank 52 of tank evacuation 926 is lagging behind that of tank evacuation 902 by nearly 165 bits, which is roughly equivalent to one-half inch in terms of actual water displacement. At 6 seconds the lag is nearly 265 bits, which is more than three-quarter inch difference in water displacement. It can readily be seen that the failure of bowl 54 to evacuate properly can be determined by either time or equation, as was previously discussed. This indicates that at the same moment in time of a given flush cycle, the tank 52 water height as reflected by tank evacuation 926 due to bowl 54's obstruction is going to be higher than that of tank evacuation 902, which does not have an obstructed bowl 54. Any lag of more than one-quarter of one inch of water height difference in displacement from that of the profile established by tank evacuation 902 will cause exemplary system to recognize the developing problem and identify it accordingly as a blocked or obstructed bowl 54. For the purpose of comparison with FIG. 20B, FIG. 21B has been included to show the graph of the obstructed bowl with respect to water height and interval. Also for the purpose of comparison, FIG. 21C and FIG. 21D show the tank refill with by time and interval, respectively. As was pointed out previously, despite the obstruction and change in the tank evacuation due to the obstruction in bowl 54, the tank refill is basically unaffected and therefore mirrors the equations of y=a+bx and y^{0.5}=a+bx with respect to those shown in FIG. 20C and FIG. 20D.

(Double-Flush due to Blockage) FIG. 21 graphs the complete flush profile when only a single flush is initiated by the user. Unfortunately, a severe blockage of exhaust port 68 often results in an elevated water height w1 in bowl 54 for a period of time following that initial flush. Because of a tendency by many people to believe that more water pressure is necessary to clear the blockage, or as a result of panic or embarrassment because it is now obvious that one's excrement has created a problem, the toilet is often flushed a second time shortly after the first flush, and often before the first flush cycle has completed, which frequently results in bowl 54 overflowing.

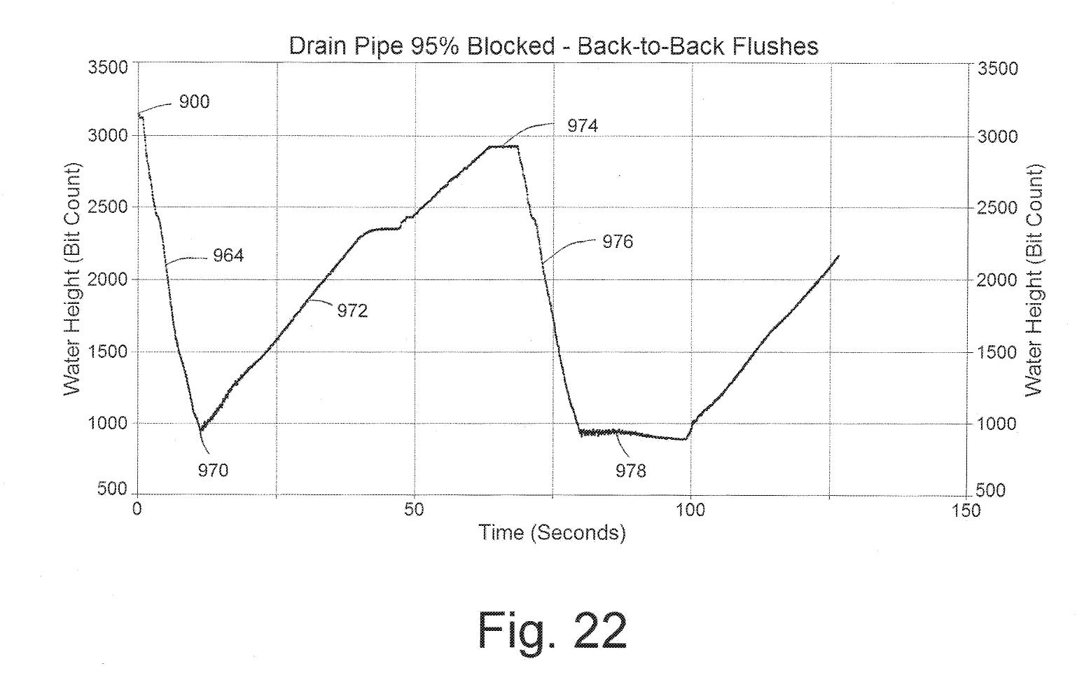

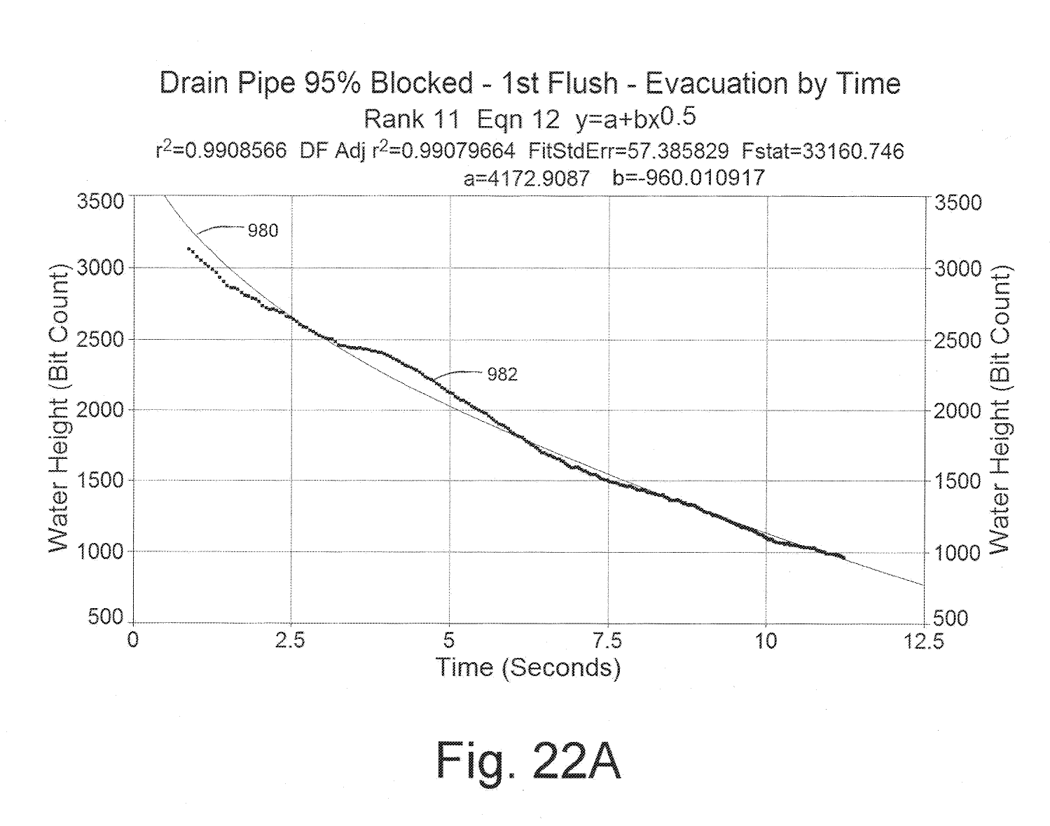

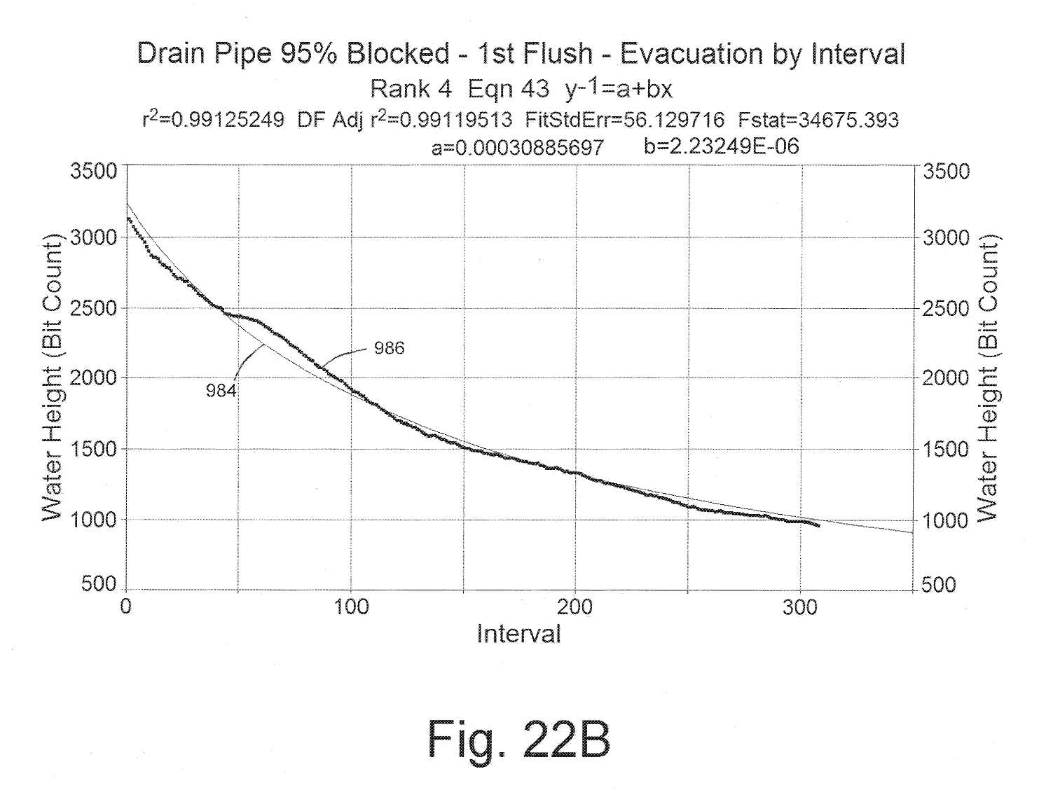

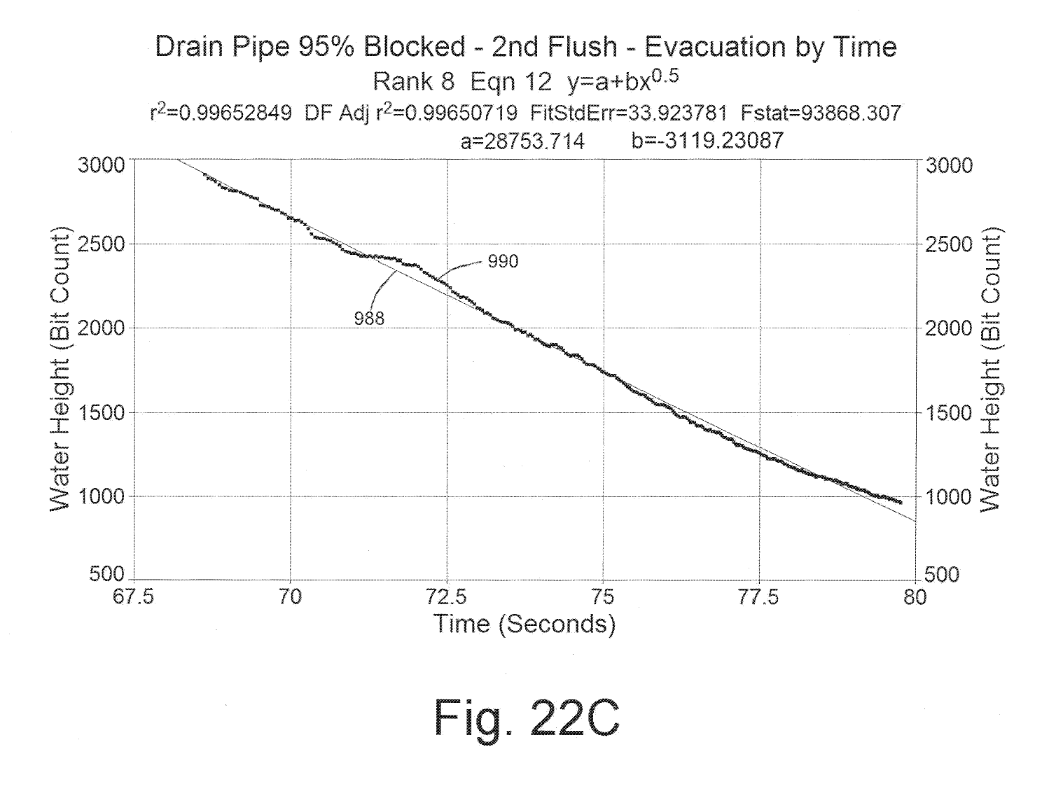

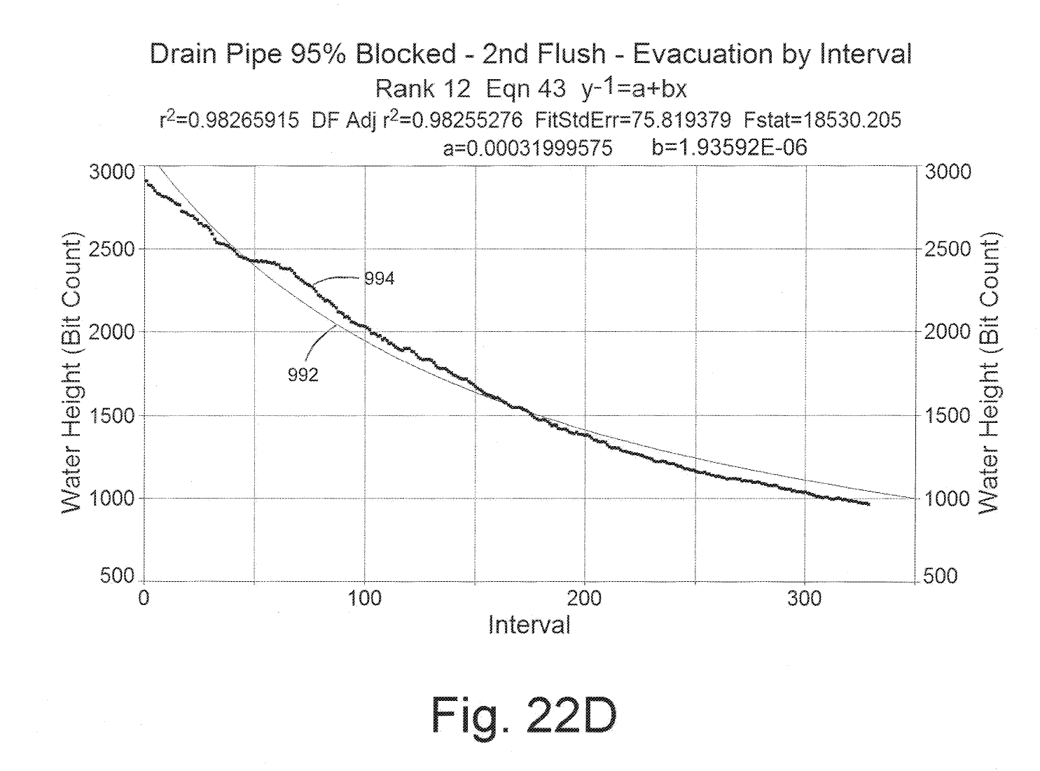

FIG. 22 shows the graph of a back-to-back flushes within a brief time interval when an obstruction is preventing exhaust port 68 from evacuating bowl 54. In contrast to tank evacuation 902 of a normal flush that takes approximately 6 seconds, first flush tank evacuation 964 is more than 10 seconds in duration, during which time bowl water height w1 is rising in bowl 54 due to the obstruction. Flush valve closure water height 970 shows that flapper 62 closed at the approximate water height 83, as shown in FIG. 8, and first flush tank refill 972 occurred within the expected approximately 45 seconds, but shortly after end-of-first-flush water height 974 occurred, the toilet was again flushed. Second flush tank evacuation 976 took more than 12 seconds, and flush valve wide-open interval 978, which remains basically flat and stable, indicates that flapper 62 failed to close and seal off flush valve 61, because the tank water height 84 has not dropped low enough for positive buoyancy of flapper 62 to drop, resulting in an overflow condition of bowl 54 where water w1 is now above the rim and draining onto the floor. The exemplary system described herein is able to detect: (a) the obstruction on the basis of the change in either the time of evacuation, or by equation, of first flush tank evacuation 964; (b) the brief interval between the first and second flush; (c) the impending overflow on the basis of the change in either time of evacuation, or by equation of the second flush tank evacuation 976; and (d), the actual overflow condition on the basis of the absence of the rate of change in flush valve wide-open interval 978, which followed the analysis of the second flush tank evacuation. FIG. 22A, FIG. 22B, FIG. 22C, and FIG. 22D show the exploded first and second tank evacuations by time and by interval, with their respective linear equations and the a and b constants associated with the same, for reference.

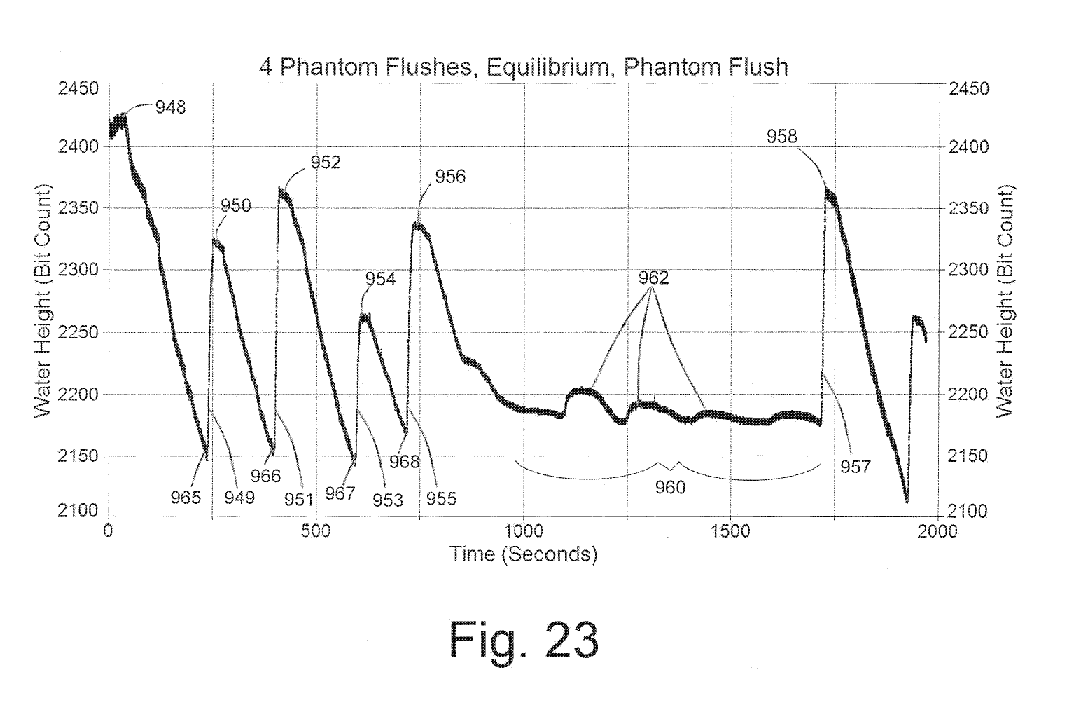

(Multiple Phantom Flushes, Fill Valve Equilibrium Failure, followed by a Phantom Flush) As has been described previously herein, a leak from tank 52, which typically occurs due to a faulty flapper or fill valve, generally results in water moving from tank 52 to bowl 54, or leaking from tank 52 directly onto the floor because of cracks in the porcelain, loose or rusted tank 52 retaining bolts, or a degraded or defective gasket immediately below and between flush valve 61 and bowl 54. Fill valve 66 responds to the leak by refilling tank 52 and float 112 responds to the corresponding change in tank 52 water height. As was also previously described, fill valves may exhibit “phantom flushes” or “equilibrium” failures during the refill of tank 52. FIG. 23 shows the tank water height response to a leak whereby the fill valve “phantom flushes” 4 times, followed by the fill valve temporarily exhibiting the “equilibrium” failure mode, concluding with 1 additional “phantom flush”. Fill valve open water heights 965, 966, 967, and 968, all reflect the float 112 water height 81 in FIG. 13B, at which point fill valve 66 allows water to fill tank 52 until fill valve closure water heights 950, 952, 954, and 956, which correspond to water height 80, have been reached, causing fill valve 66 to terminate water flow. The exemplary system described herein can track and detect just the negative water height displacement over time, or the cyclic water height displacement over time, identifying either/or as a toilet leak. After fill valve closure water height 956 occurs, the leak once again causes a negative displacement of water, resulting in water height 81, but instead of fill valve 66 responding by opening and once again filling tank 52 to water height 80, fill valve equilibrium water height 960 occurs, which although is relatively stable, produces fill valve flow variation water height peaks 962 for a period of time. This is followed by tank refill 957, fill valve closure height 958, which is followed by a succession of additional “phantom flushes” (not shown in the graph). FIG. 23 models the water height in view of a fill valve exhibiting both “phantom flushes” and “equilibrium” failures, but any given fill valve can exhibit only one or the other condition, or both conditions. When the exemplary system described herein detects the sequence of an initial drop in tank 52 from water height 80 to a lower and stabilized water height 81 which does not substantially increase over time, a fill valve equilibrium failure is determined. If the exemplary system detects a “bad leak”, which is herein is described as being more than several gallons per hour, regardless of the cause, an additional alert may be produced by microcontroller 801 on annunciator module 350. Further, if a leak or faulty fill valve 66 goes uncorrected for a prolonged period of time, microcontroller 801 may have annunciator module 350 produce an additional alert. In addition to annunciator module 350, monitoring device 325 and 340 could additionally transmit data and alerts via any one of several RF frequencies and protocols.

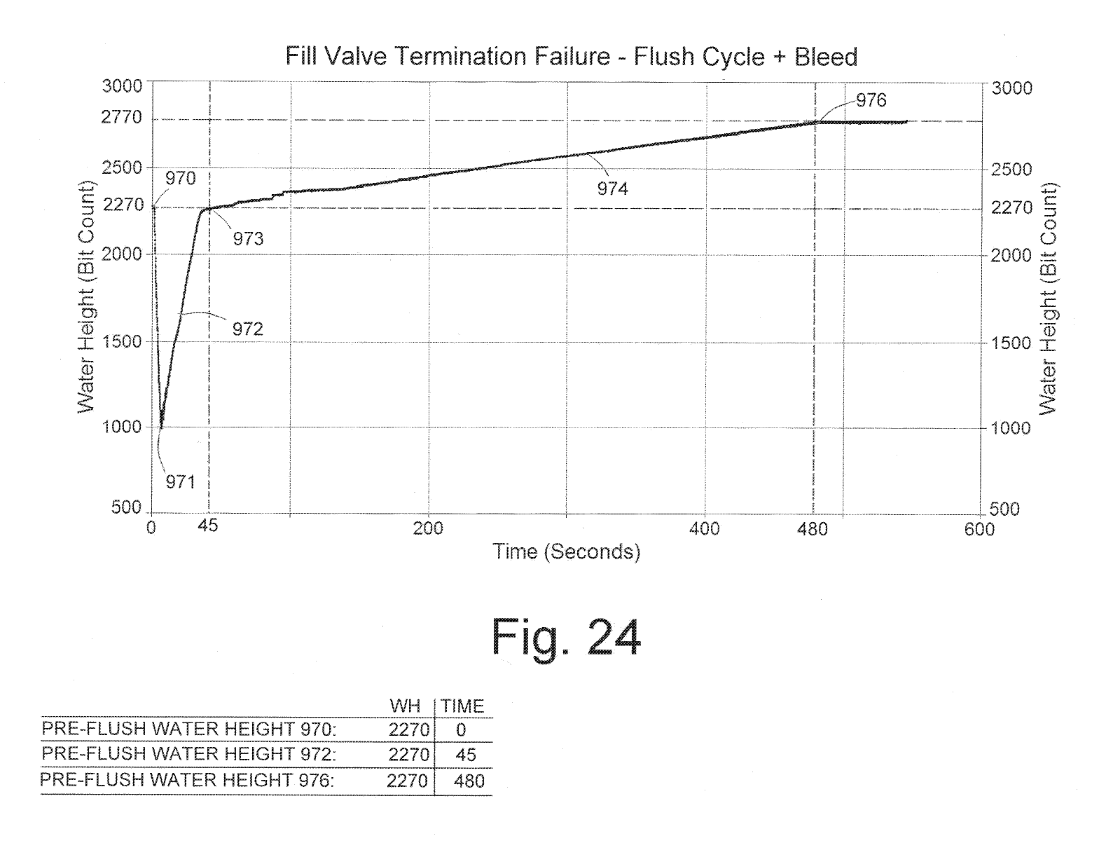

(Fill Valve Termination Failure) FIG. 13A shows the tank 52 water displacement when a fill valve fails in the “open” condition, allowing water to “bleed” or “seep” into tank 52 when float 112 has risen to its maximum vertical height, which should cause a properly functioning fill valve to terminate water flow completely. However, because fill valve 66 is faulty and “bleeding”, tank water height W has continued to rise to water height 82, which is the maximum height of overflow tube 199, and begins to drain into overflow tube 199 and then into bowl 54. FIG. 24 shows the graph of this type of fill valve failure following a flush. A flush has been initiated and the sequence of tank evacuation 970, followed by flush valve closure water height 971, tank refill 972, and fill valve closure water height 973. Because fill valve 66 continues to “bleed” water into tank 52, increasing water height ramp 974 continues to rise until it reaches overflow tube water height 976, at which point the water drains into overflow tube 199 and then into bowl 54. The FIG. 24 increase from fill valve closure water height 973 to overflow tube height 976 is approximately 500 bits, which represents a displacement of approximately 1.5 inches. From FIG. 24 it can be seen that increasing water height 974 spans a period of approximately 435 seconds, a timeframe that occurs 8.2 times per hour. From FIG. 27 and the previous water volume calculations described herein, the leak graphed in FIG. 24 is therefore approximately 8.2×1.5″×0.5 gallons, or 6.15 gallons-per-hour. The exemplary system described herein tracks the increasing water height 974, thereby detecting the faulty fill valve 66, as well as accurately tracking and/or datalogging the amount of water lost over any given period of time.

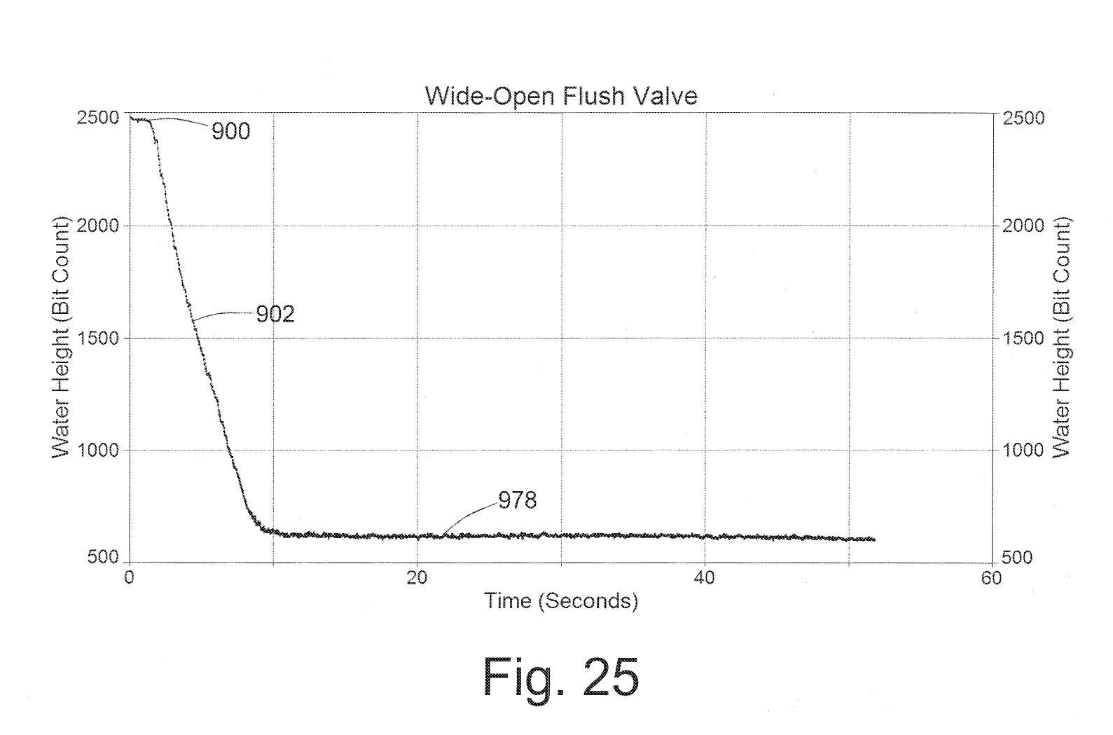

(Wide-Open Flush Valve) FIG. 3 shows flush valve 61, comprised of flapper 62 and flush valve seat 65, where flapper 62 is in the full vertical position, indicating that flush valve 61 is “open” and allowing water W to freely drain from tank 52 into bowl 54. FIG. 25 shows a pre-flush water starting height 900, at which point the user has initiated a flush. Tank evacuation 902 occurs, but the flapper 62 failing to close upon flush valve seat 65 creates flush valve wide-open duration 978, which continues until the problem is corrected. The exemplary system described herein tracks and detects the wide-open flush valve problem, as well as accurately tracking and/or datalogging the amount of water lost over any given period of time. The wide-open flush valve can be determined by the exemplary system when: (a), wide-open duration 978 represents no rate of change for a period of time; or (b), when a tank refill does not occur within a period of time.

(Solenoid Valve) FIG. 7 shows monitoring device 325 deployed within tank 52, while FIG. 28 shows a monitoring device 340 which hangs over tank 52's rim, with annunciator module 350 on the exterior surface and conductors 310,314 positioned inside tank 52 and in contact with water W. FIG. 7 also shows a solenoid valve 72 positioned between water supply valve 70 and fill valve 66's valve body stem 104. Microcontroller 801's port 811 can be configured to actuate a simple circuit that is connected to solenoid valve 72, turning it “on” or “off”, as needed. Microcontroller 801, for instance, may turn solenoid valve 72 “off” if a leak, wide-open flush valve, overflow, or faulty fill valve is detected.

(Automatic Flush Volume Control Method and Function) A major problem encountered by users of low-volume-flush toilets (LVFT's) is the need to double-flush, which not only defeats the purpose of having an LVFT, but often also results in overflows, which the exemplary system described herein can detect and, when desired, can alert the user as well as terminate the water flow. Despite the proliferation of LVFT's, many of these toilets have had their fill valve float heights improperly set, which means that the actual flush volumes are higher than the manufacturer's recommended volume-per-flush, and in many cases are unnecessary. Further, many non-LVFT toilets are installed around the world, frequently using 3, 4, and even 5 gallons-per-flush. Often times in low income property management environments where there are multiple housing units that are not sub-metered and where water conservation is a bottom line issue financially, maintenance personnel are not trained properly when it comes to setting the fill valve float height, leading to further unnecessary water waste when the float is set at, or near, it's maximum height. But the amount of water necessary to evacuate waste actually also varies as a function of the toilet users themselves. A large man with a hefty appetite is more likely to need additional water to evacuate the toilet bowl than a tiny woman on a vegan diet, yet their respective toilets may have identical flush volumes, despite the vast difference in the necessary amount of water required to reliably and consistently evacuate the toilet bowl.

Common sense suggests that a toilet that is rarely or never double-flushed may be wasting water because the flush volume exceeds the needs of the occupant. Common sense would also suggests that a toilet that is always double-flushed is likewise wasting water, particularly if a slight increase in flush volume would preclude the necessity of double-flushing. Another feature of the exemplary system is microcontroller 801's ability to track actual usage of the toilet to which it is attached by determining if and how often back-to-back double flushes are used and responsively turning “on” and “off” solenoid valve 72 to control the amount of that fills tank 52 through fill valve 66. When monitoring device 325 or 340 is connected to solenoid valve 72, in addition to terminating water flow due to a leak or other problem to prevent water loss and/or water damage, solenoid valve could be turned off prematurely before float 112 of fill valve 66 reaches its maximum height, and thereby decreasing the flush volume of the next flush. In one instance, no double-flushes or a minimum number of double-flushes are detected over a given time period. When the exemplary system detects the tank refill 906 occurring, solenoid valve could be turned “off” before water height W raises float 112 and fill valve 66 turns off, thereby decreasing the total flush volume. For instance, if no double-flush were detected for a given time period, solenoid valve may be turned off during tank refill 906 at reduced water height 92 (FIG. 7) instead of float 112 water height 94. If another period of time elapsed where no double-flushes occurred, microcontroller 801 may actuate port 811 to turn off solenoid valve 72 at reduced water height 90. Conversely, consider a situation where the fill valve 66 float 112 is intentionally set at or near maximum height for a given user or tenant, with the purpose being to allow monitoring device 325 or 340 to optimize the flush volume over time. Further, that the automatically reduced flush volume is not sufficient for evacuating bowl 54 due to excessive double-flushes, in which case microcontroller 801 may allow port 811 to fill tank 52 to a higher water height W in order to increase the flush volume. Or, if the flush volume is already at its maximum level due to the setting of fill valve 66 float 112, microcontroller could signal an alert that the flush volume is insufficient, which could also signal that the potential for overflows exists.

### Toilet Monitoring and Intelligent Control System in Operation

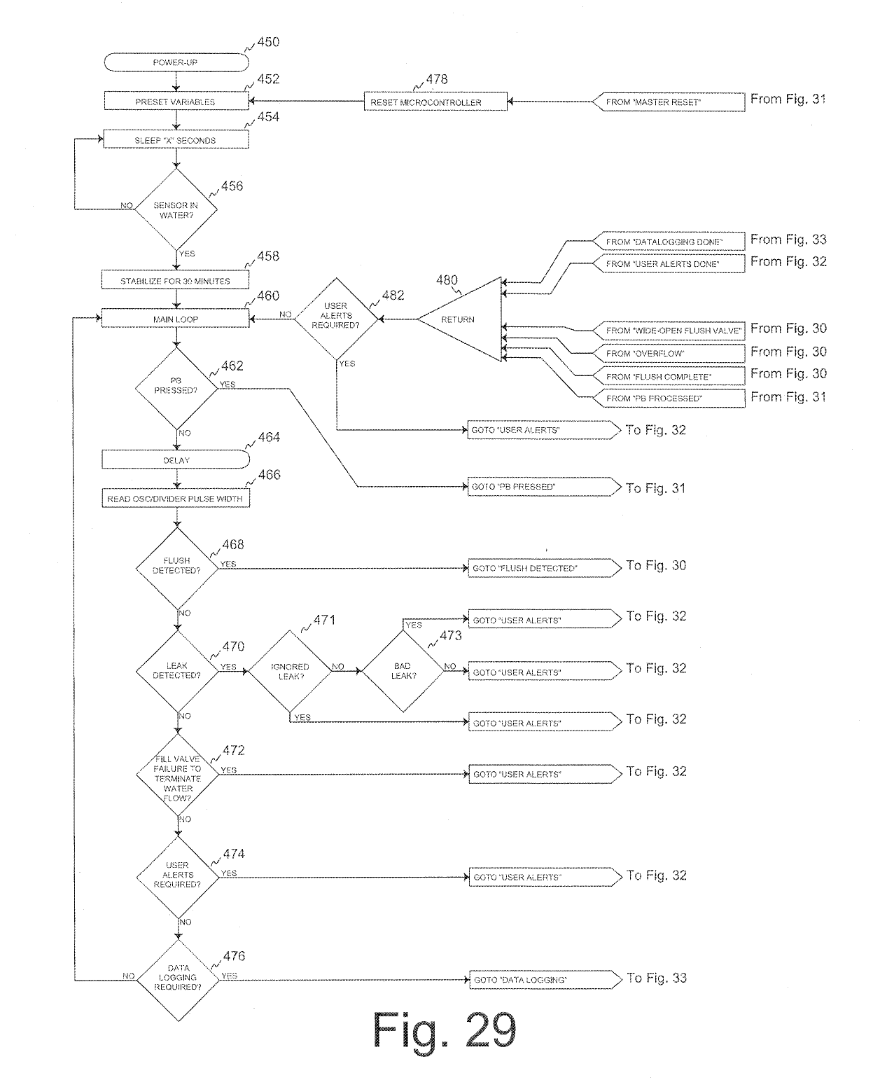

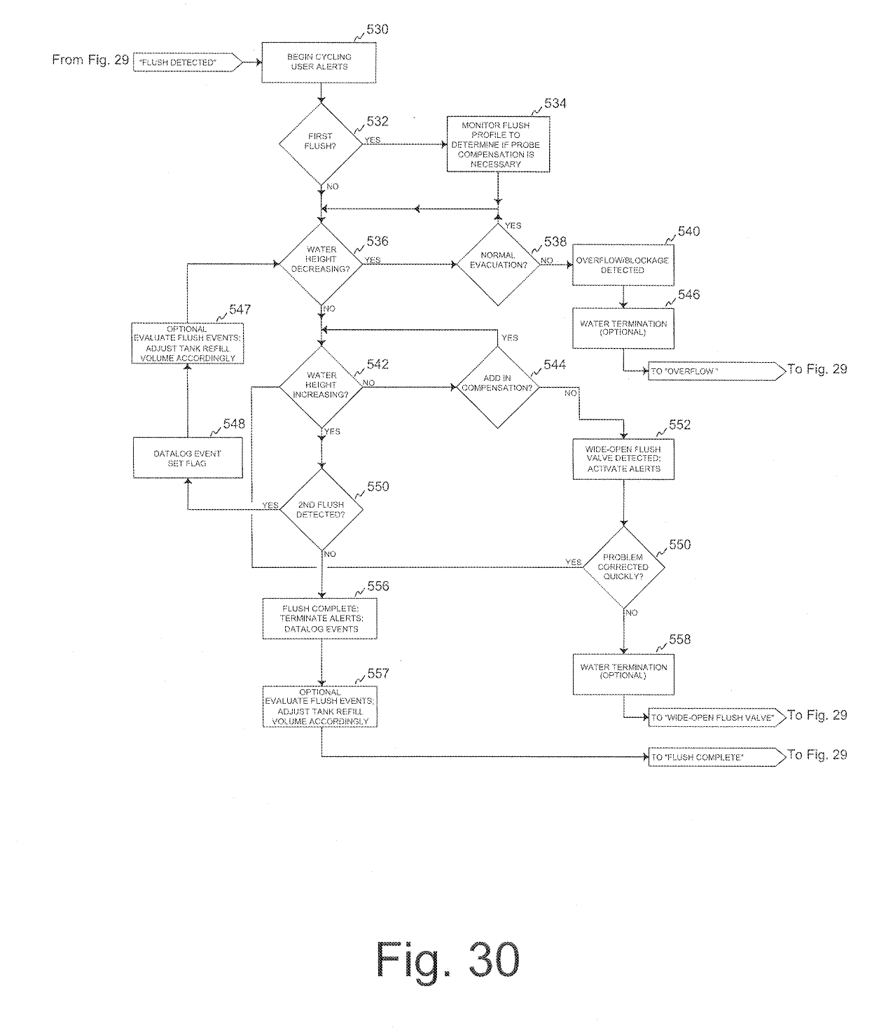

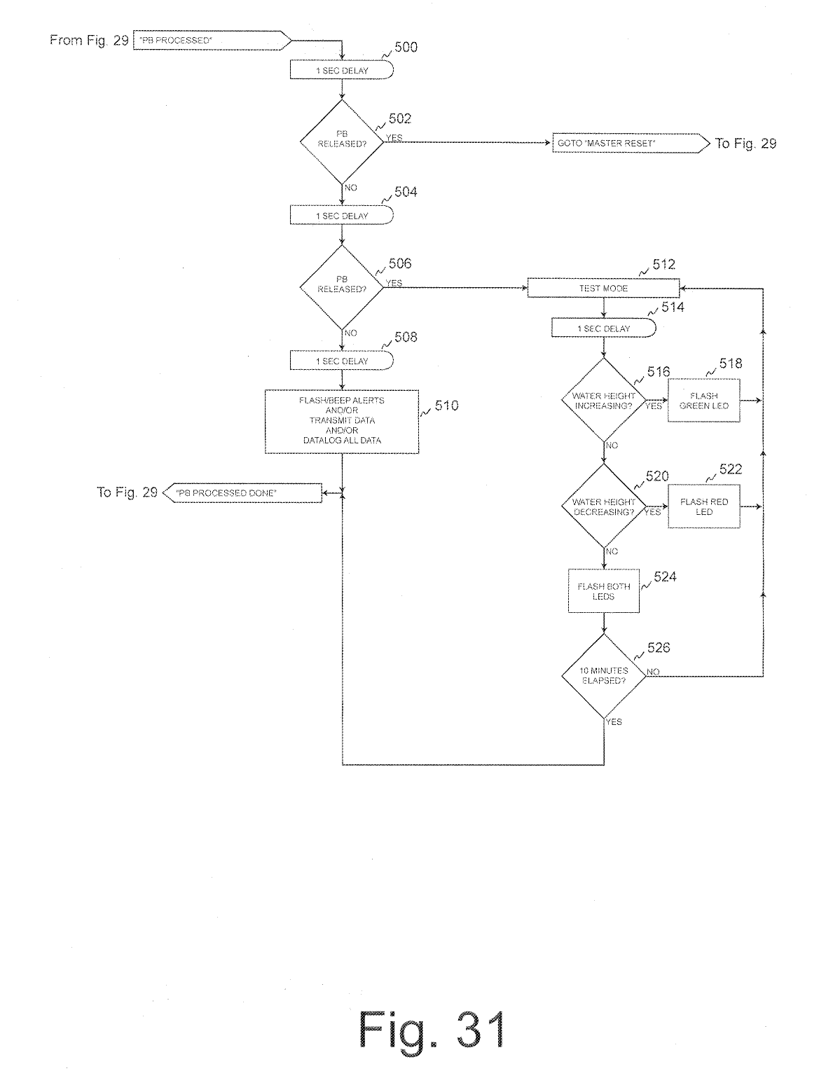

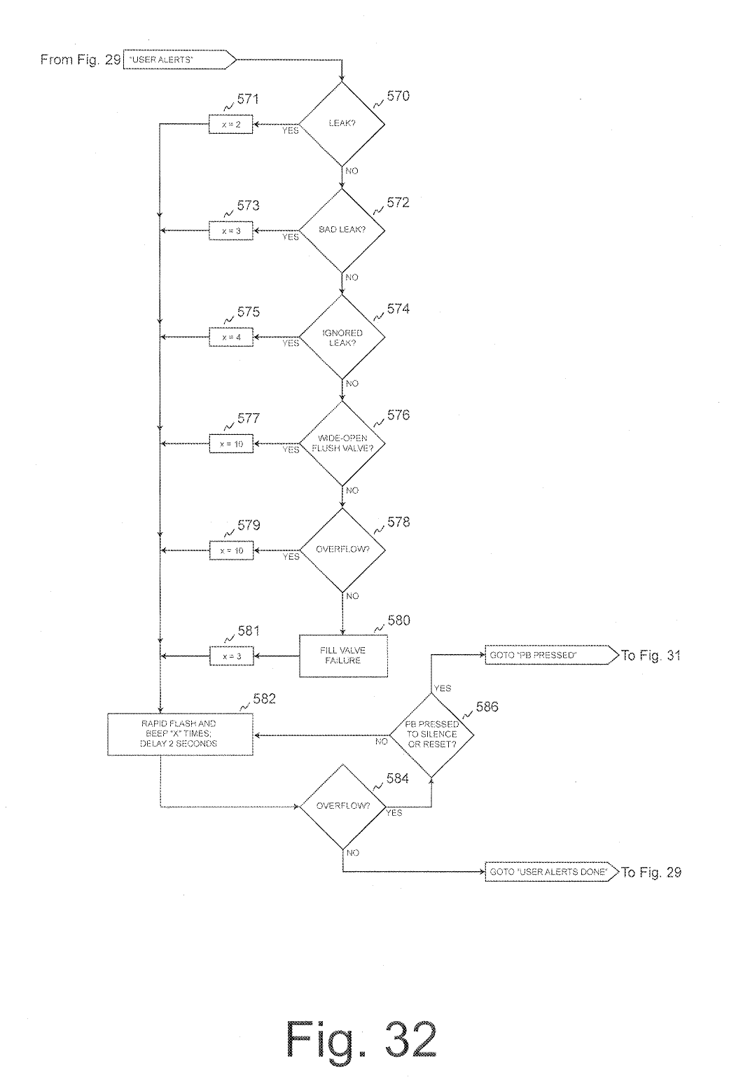

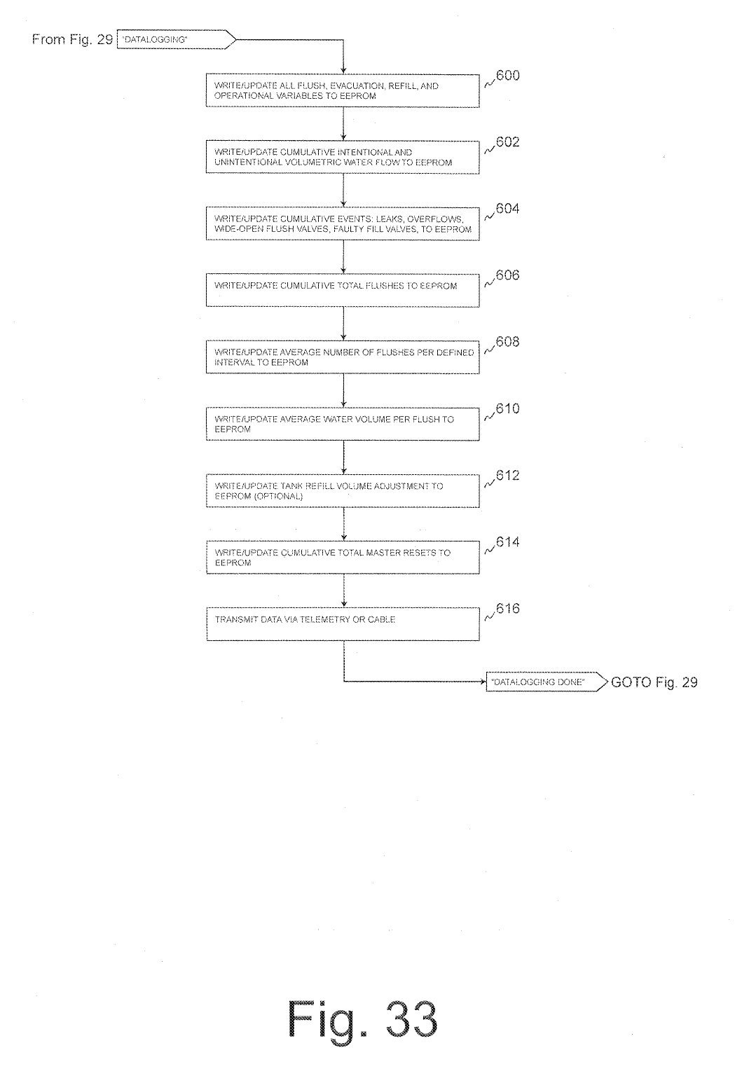

FIGS. 29-33 show example operations performed by microcontroller 644 of monitoring device 340. In the example shown, upon power up (block 450) the microcontroller 644 resets variables (block 452) and then sleeps for X seconds (block 454). The microcontroller wakes itself up after X seconds and samples the output of sensor 648 to determine whether the sensor is in the water (decision block 456). If the sensor is not in the water (no exit to decision block 456), the microcontroller 644 again sleeps for X seconds (block 454) and checks again. This operation will continue indefinitely until the microcontroller determines that the sensor 648 has been placed in water (“yes” to decision block 456).

Once the microcontroller 644 determines the sensor 648 is in the water, the microcontroller times a predetermined time delay (e.g., 30 minutes) to permit the environment to stabilize (block 458) and then begins executing a main loop (block 460). In this main loop, the microcontroller 644 first checks whether the button 810 has been pressed (decision block 462). If the button has not been pressed (no exit to decision block 462), the microcontroller may delay a predetermined delay (block 464) and then read the oscillator/divider pulse width (block 466). The microcontroller 644 then analyzes the acquired sensor measurement signal to determine whether a flush has occurred (block 468), whether a leak has been detected (block 470), whether the fill valve has failed to terminate water flow (block 472), and whether any other user alerts are required (block 474). Whether or not any of said conditions have occurred, the microcontroller 644 may also determine whether data logging is required (decision block 476). Each of decision blocks 462, 468, 470, 472, 474 and 476 can invoke additional conditional functions that are performed when the condition tested for has tested true. This main loop 460 is continually executed as long as the monitoring device 340 is in service.

In the example shown, decision block 470 detects a leak by tracking negative or cyclic water displacement during non-flush periods. See description above for more detail. Decision block 472 detects whether the fill valve has failed to terminate water flow and is bleeding into the tank by detecting positive water displacement.

FIG. 30 is a flow chart that shows an example function to be performed when a flush is detected by decision block 468. Upon detection of a flush, the microcontroller 644 begins cycling user alerts (block 530) and performs further tests based on historical data the microcontroller 644 previously collected and stored in local memory. For example, microcontroller 644 can determine whether the current flush is the first flush the monitoring device 340 has ever detected (i.e., it is newly installed) (block 532). If it is the first flush (yes exit to decision block 532), the microcontroller 644 monitors the flush profile to determine if any probe compensation is necessary (block 534). In one embodiment, this compensation includes detecting how long the probe is out of the water between the last time it sees decreasing water height and the first time it sees increasing water height—thus estimating the distance between the bottom of the probe and the bottom of the tank. This allows microcontroller 644 to later extrapolate falling and rising water levels to the gap between the bottom of the probe and the bottom of the tank.

If the microcontroller 644 detects that this is not the first flush (“no” exit to decision block 532), the microcontroller detects whether the water height or level is (still) decreasing (decision block 536). If the water height/level is (still) decreasing (yes exit to decision block 536), the microcontroller 644 determines whether the decrease in water level/height is due to a normal evacuation (decision block 538). Microcontroller 644 has determined that the evaluation profile is not normal, resulting in overflow detection in block 540 (see description above). If not due to a normal evacuation (no exit to decision block 538), microcontroller 644 declares that an overflow/blockage has been detected (block 540). Under this detection condition, in some embodiments, the monitoring device 340 can terminate water supply to the toilet by closing a valve automatically (block 546). Either way, the routine shown in FIG. 30 returns a flag or code to the main loop 460 (see “return” block 480 of FIG. 29), which will cause the microcontroller 644 to generate a user alert alerting the user to the problem (decision block 482).

Decision blocks 536, 538 provide a “do until” loop that enables the controller 644 to detect when the water level is no longer decreasing—meaning that the tank is drained. At this point, the flapper valve should close and the tank should begin to fill up again. If microcontroller 644 detects that the water height is no longer decreasing (no exit to decision block 536), it then determines whether the water height begins to increase (decision block 542). If the water height does not increase (no exit to decision block 542), microcontroller 644 determines whether to add in a compensation factor (block 544) that accounts for the sensor 308 potentially not being long enough to extend to the bottom of the tank (if the sensor is not long enough, then the tank could have begun to refill and the sensor will not yet “see” the refilling because it hasn't yet reached the level of the sensor). The process then loops back to decision block 542 to check again whether the water height is increasing.

If no compensation is to be added in (no exit to decision block 544) (e.g., based on a certain time period passing by which time the sensor should be detecting a water height increase or in cases when no compensation is needed) and the sensor still has not detected a water level increase (No exit to decision block 544), the microcontroller 644 declares a wide open flush valve has been detected and activates alerts (block 552). This is based on recognizing that (a) a flush has occurred, (b) the water level is no longer decreasing and (c) the water level is not increasing even after waiting a period of time that would allow the rising water level to reach the level of the sensor). The monitor device 340 then detects, by monitoring the sensor 648 output, whether the problem of the rising water has been corrected quickly—for example by a flapper valve falling into a seal position late (decision block 560). If so, control returns to continually monitor water height to detect the end of the flush cycle (decision block 542). If the problem is not corrected quickly (no exit to decision block 560), this means refill water is continuing to escape the tank through the flush valve and potentially wasting tremendous amounts of water. When this condition is detected, embodiments the microcontroller 644 can automatically close the water valve to terminate water flow into the toilet (block 558) and return an error code to the main loop for generating user alerts (FIG. 29, block 480, 482).

If the water height is neither (no longer) increasing nor decreasing and the current flush is not a first flush, then the microcontroller 644 looks at historical data (e.g., a flag or an event log) to determine whether the current flush is a second flush (block 550). In this context, “second flush” does not mean the second flush the device 340 has ever detected but rather a subsequent flush in a sequence of flushes in rapid succession during typical operation. Often, users will flush twice if they think or detect that something is wrong with the toilet. Microcontroller 644 in this context detects a second flush by detecting a flush cycle that occurs relatively close in time to a previous flush cycle. If the second flush (yes exit to decision block 550), the microcontroller 644 data logs an event set flag (block 544) and optionally may evaluate flush events to adjust tank refill volume accordingly (block 547).

If the current flush is not a second flush (no exit to decision block 550), the microcontroller 644 detects that a flush operation is complete, terminates all alerts and data logs events (block 556) and then optionally may evaluate flush events and adjust tank refill volume based on measured volume of water flow during the flush cycle (block 557).

FIG. 31 shows an example flow chart for a routine microcontroller 644 performs in response to user manual depression of push button 810 (see FIG. 29 decision block 462). Upon depression of push button 810, microcontroller 644 introduces a one second delay (block 500) and then detects whether the push bottom has been released (decision block 502). If the microcontroller 644 detects a push button depression with a duration of less than one second (yes exit to decision block 502), it invokes a master reset by sending a master reset code back to the FIG. 29 routine which then causes the microcontroller to reset (see FIG. 29, block 478). If, on the other hand, the push button remains depressed after one second (no exit to decision block 502), the microcontroller 644 detects whether the push button is released before another one second delay (block 504) has passed (decision block 506). If the user has depressed the push button for more than one second but less than two seconds (yes exit to decision block 506), the microcontroller 644 enters a test mode (block 512) in which it times a one second delay (block 514) and then detects whether the water height is increasing (decision block 516) or decreasing (decision block 520). If the water height is detected as increasing (decision block 516 yes exit), the microcontroller 644 will flash a green light either way (block 518). If the microcontroller 644 detects that the water height is decreasing (yes exit to decision block 520), the microcontroller 644 will flash a red LED (block 522). This tells the user the device is working. If the microcontroller 644 detects that the water height is neither increasing nor decreasing (no exit to decision block 520), the microcontroller 644 will flash both the red and green LED (block 524). In the example non-limiting embodiment, the microcontroller 644 continues this test mode operation for ten minutes (decision block 526) and then automatically reverts to normal operation (yes exit to decision block 526). In some embodiments, an additional button pressed at this time could be detected for to release the unit from the test mode.

If the decision block 506 detects that the push button was pressed for more than two seconds (“no” exit to decision block 506), the microcontroller 644 may interpret that button press as a request to test all user interface devices by flashing indicators 808, providing an audible alert on annunciator 809 and/or transmitting data and/or data logging of all data (block 510).

FIG. 32 shows an example non-limiting flow chart of function that microcontroller 644 may perform in order to generate a user alert (see decision block 474 of FIG. 29), e.g., based upon error codes returned by the various other test routines. In this particular example, the microcontroller 644 encodes the error condition for the number of LED light flashes that indicators 808 flash. Thus, if a leak has been detected (decision block 570), the variable X is set to 2. If a bad leak has been detected (decision block 572), the variable X is set to 3. If a leak has been ignored (decision block 574), the variable X is set to 4. If a wide open flush valve has been detected (decision block 576), X is set to 10. If an overflow has been detected (decision block 578), X may also be set to 10. If a fill valve failure has been detected (block 580), then X may be set to 3. Microcontroller 644 then flashes the LEDs X number of times as well as activates the audio annunciator 809 that same number of X times (block 582). Microcontroller 644 may then delay two seconds (block 582) and detect whether an overflow condition exists (decision block 584). If the overflow condition does not exist (no exit to decision block 584), the FIG. 32 routine may return to the main loop shown in FIG. 29. However, if an overflow condition does exist (block 584 yes exit), the monitoring device 340 may continue to generate an alert unless/until the user presses the push button 810 to silence or reset the alert (decision block 586).

FIG. 33 shows an example data logging function which allows, in some embodiments, monitor device 340 to harvest and transmit toilet operating data for further analysis such water usage analysis. In these embodiments, the microcontroller 644:
writes/updates all flush, evacuation, refill, and operational variables to internal memory as they occur (block 600)
writes/updates all cumulative intentional and unintentional volumetric water flow to the internal memory (block 602)
writes/updates cumulative events such as leaks, overflows, wide open flush valves, faulty fill valves and the like to internal memory (604)
writes/updates cumulative total number of flushes to keep track of the number of flushes that the toilet has experienced (block 606)
writes/updates average number of flushes per defined interval (block 608). writes/updates average water volume per flush to the memory, as well as tank refill volume adjustments (block 610, 612)
writes/updates cumulative total number of master resets (block 614)
transmits all of this data on demand of periodically via telemetry, cable or other communications means of any sort for external analysis (block 616).
   The invention is not to be limited to the above disclosed embodiments, but rather is intended to cover variations and equivalents with the spirit and scope of the claims.

We claim:

1. A toilet monitor characterized by
a toilet tank water level sensor producing a toilet tank water level measurement signal;
the toilet monitor further comprising
a processor connected to receive the measurement signal, the processor being configured to detect the rate of change of the measurement signal and conditionally produce a responsive actuation signal in response to the detected rate of change; and
a transducer connected to receive the actuation signal.

2. The toilet monitor of claim 1 wherein the processor is further configured to evaluate a sequence of rates of change to detect toilet operation abnormalities.

3. The toilet monitor of claim 1 wherein the processor is further configured to detect predetermined sequences of rates of change.

4. The toilet monitor of claim 1 wherein the processor is further configured to detect rate of change using a rolling block interval analysis.

5. The toilet monitor of claim 1 wherein the processor is further configured to use a linear equation to analyze the rate of change measurement signal.

6. The toilet monitor of claim 1 wherein the processor is further configured to determine an anomaly in water flow within the toilet bowl based on the rate of change of the toilet tank water level measurement signal.

7. The toilet monitor of claim 1 wherein the processor is further configured to determine the toilet is leaking in response to the rate of change.

8. The toilet monitor of claim 1 wherein the processor is further configured to determine the toilet is leaking by tracking the direction and/or the cycles of the rate of change.

9. The toilet monitor of claim 1 wherein the processor is further configured to determine the toilet fill valve is defective in response to the rate of change.

10. The toilet monitor of claim 1 wherein the processor is further configured to determine the toilet fill valve is defective by tracking the direction of the rate of change followed by the absence of rate change.

11. The toilet monitor of claim 1 wherein the processor is further configured to determine the toilet flush valve is open in response to the rate of change.

12. The toilet monitor of claim 1 wherein the processor is further configured to determine the toilet flush valve is open by tracking the absence of the rate of change.

13. The toilet monitor of claim 1 wherein 1 the processor is further configured to determine current and/or imminent toilet overflow in response to the rate of change.

14. The toilet monitor of claim 1 wherein the processor is further configured to detect the prolonged absence of double flushes.

15. A method of controlling a flush toilet comprising:
producing a toilet tank water level measurement signal;
detecting the presence or absence of plural successive flushes within a predetermined time period based on the measurement signal and generating an actuation signal to affect toilet tank flush volume; and
increasing or decreasing toilet tank flush volume in response to the actuation signal.

16. The method of claim 15 further including evaluating a sequence of rates of change of the measurement signal to detect toilet operation abnormalities.

17. The method of claim 15 further including tracking the direction of rate of change of the measurement signal.

18. A toilet monitor comprising
a housing containing electronics; and
a water level sensing probe extending from the housing, the probe comprising at least one conductor; wherein the monitor is further comprising a portion of the at least one conductor being bent or bendable to hang over the lip of a toilet tank to suspend and support the housing on the tank lip, the at least one conductor having a length such that an additional portion of the at least one conductor extends from the bent/bendable portion into immersion contact with water in the tank.

19. The toilet monitor of claim 18 further comprising a processor connected to receive a measurement signal provided by the water level sensing probe, the processor being configured to detect the rate of change of the measurement signal and conditionally produce a responsive actuation signal in response to the detected rate of change.

20. The toilet monitor of claim 19 wherein the processor is further configured to detect the prolonged absence of double flushes.
